(19) United States
(12) Patent Application Publication
(10) Pub. No.: US 2022/0404494 A1
(43) Pub. Date: Dec. 22, 2022

(54) DAYLIGHT VISIBLE & MULTI-SPECTRAL LASER RANGEFINDERS AND ASSOCIATED SYSTEMS AND METHODS AND UTILITY LOCATOR DEVICES

(71) Applicant: SeeScan, Inc., San Diego, CA (US)

(72) Inventors: Casey P. Walsh, Carlsbad, CA (US); Mark S. Olsson, La Jolla, CA (US); Adam Mullett, San Diego, CA (US)

(21) Appl. No.: 17/845,290

(22) Filed: Jun. 21, 2022

Related U.S. Application Data
(60) Provisional application No. 63/212,713, filed on Jun. 20, 2021.

(51) Int. Cl. G01S 17/36; G01S 17/89; G01S 7/481; G01S 7/4913; G01S 7/4912; G01S 7/497

(52) U.S. Cl. CPC G01S 17/36; G01S 17/89; G01S 7/4815; G01S 7/4813; G01S 7/4913; G01S 7/4918; G01S 7/497

(57) ABSTRACT

Daylight visible laser rangefinders and multi-spectral laser rangefinders that emit one or more continuous wave lasers for the purposes of generating a distance measurement are disclosed, along with methods, systems, and devices including laser rangefinders in utility locating and mapping systems and underwater systems.

### CROSS-REFERENCE TO RELATED APPLICATIONS

This application claims priority under 35 U.S.C. § 119(e) to co-pending U.S. Provisional Patent Application Ser. No. 63/212,713, entitled DAYLIGHT VISIBLE & MULTI-SPECTRAL LASER RANGEFINDERS AND ASSOCIATED METHODS AND UTILITY LOCATOR DEVICES, filed on Jun. 20, 2021, the content of which is hereby incorporated by reference herein in its entirety for all purpose.

### FIELD

This disclosure relates generally to laser rangefinders. More specifically, but not exclusively, the disclosure relates to daylight visible laser rangefinders, multi-spectral laser rangefinders, underwater range finding devices, utility locator devices employing laser rangefinders, and associated apparatus, systems, and methods.

### BACKGROUND

There are many situations where it may be necessary or advantageous to measure the distance to a target. In such situations, a rangefinder may be employed in finding such distance measurements. Though a multitude of different types of rangefinders are known in the art (e.g., RADAR, SONAR or other acoustic rangefinders, microwave rangefinders, optical rangefinders, altimeters, ultrasonic rangefinders, or other types of rangefinders), laser-based rangefinders (referred to herein as laser rangefinders) may be the most common due to cost, physical package size, accuracy, and/or the need for a highly focused beam to direct at targets.

Known laser rangefinders may either use a pulsed or, most commonly, a continuous wave laser to calculate a distance measurement. Pulsed laser rangefinders may determine distances by emitting a laser beam aimed at a target and calculate the time of flight from light reflected from the target. Pulsed laser rangefinders are often very limited in range thus most rangefinders configured for accurate and longer distance measurements favor the use of continuous wave lasers. Known continuous wave lasers may instead emit a modulated continuous wave laser beam at known frequencies that may reflect light off a target. Upon receiving the reflected light the continuous wave rangefinder may use phase shift measurements in order to determine distances. Such continuous wave rangefinders, generally operating at near-infrared wavelengths, require that the gain of the emitted laser be adjusted in order to produce reflected light having useable amplitudes at a corresponding photodetector, generally a PIN photodiode. As known continuous wave laser rangefinders generally operate at wavelengths difficult to see in some common environments, such as in daylight, they may often be paired with a viewfinder allowing the rangefinder to be aimed at a target. In many applications, the reliance on aiming via a viewfinder may be impractical or unduly cumbersome.

There are very few laser rangefinders known in the art that attempt to resolve the need to rely upon a viewfinder by using a green or other daylight visible laser to quickly and easily select and aim at a target. Whereas this often solves the need to quickly and easily select and aim at a target, the use of daylight visible wavelength introduces a number of other complications that known daylight visible laser rangefinders fail to address. For instance, the output strength of the emitted laser may generally be limited to 5 mW for human safety concerns. Further, the efficiency of commonly used PIN photodiodes or similar photodetectors are greatly reduced in the visible light spectrum thus making the detecting of the reflected light difficult. Likewise, the power of emitted lasers may not be adjusted to keep the amplitude of the reflected light in a range useable by the photodetector due to the complication of ensuring the emitted laser remains safely in the visible light spectrum. As known daylight visible laser rangefinders fail to address the above, such known daylight visible laser rangefinders further fail to efficiently and/or accurately measure distances and/or have a very slow response time in generating measurements.

Accordingly, there is a need to address the above described as well as other problems in the art.

### SUMMARY

This disclosure relates generally to laser rangefinders. More specifically, but not exclusively, the disclosure relates to daylight visible laser rangefinders, multi-spectral laser rangefinders, underwater range finding devices, utility locator devices employing laser rangefinders, and associated methods.

In one aspect, the disclosure relates to a daylight visible laser rangefinder. The daylight visible laser rangefinder may include a laser element emitting a daylight visible continuous wave laser modulated at a known frequency or frequencies. As used herein, the term “daylight visible” as in “daylight visible laser” may refer to light, generally as a laser, at wavelengths that may be readily detectable by the human eye in daylight conditions (e.g., at wavelengths perceptible at photopic lighting conditions as understood via the luminous efficiency function describing the average spectral sensitivity of human visual perception of brightness of light at different wavelengths). The daylight visible laser rangefinder may further include a receiver element to receive reflected light, referred to herein as “reflected light input,” generated by reflection of the emitted laser off a target. Such a receiver element may include a sensing element having one or more avalanche photodiodes, avalanche photodiode arrays, silicon photomultipliers (SiPM), and/or like photodetector sensors for receiving the reflected light input and generating a corresponding electrical input signal. The receiver element may further include a gain control element to vary the gain of the sensing element. The daylight visible laser rangefinder may further include a phase detector to measure the phase of emitted lasers and input signals. A processing element may be included having one or more processors to calculate phase differences between the emitted laser and input signals in determining distance measurements. Such distance measurements, as well as instructions relating to generating such distance measurements, may be stored in a memory element having one or more non-transitory memories. The daylight visible laser rangefinder may further include a housing element to encapsulate or partially encapsulate the various laser rangefinder elements, isolate the receiver element from light sources other than the reflected light input to the extent possible, and further have one or more windows or other openings such that the emitted laser and reflected light input may travel between rangefinder laser element/receiver element and the external environment. In some embodiments, the housing may be waterproof wherein the daylight visible laser rangefinder may be used in an underwater environment. A power element may further be included for portioning of electrical power to the various powered elements of the daylight visible laser rangefinder.

In another aspect, the disclosure relates to a multi-spectral continuous wave laser rangefinder. The multi-spectral laser rangefinder may include a plurality of laser elements each emitting a continuous wave laser modulated at a known frequency or frequencies and operating at different wavelengths. One such laser element may generate an emitted laser at a daylight visible frequency. The multi-spectral laser rangefinder may further include a plurality of receiver elements such that one receiver element corresponds to one laser element. Each receiver element may receive reflected light input generated by reflection of the emitted laser from its corresponding laser element off a target. It should be noted that the term “target,” in such multi-laser embodiments, may refer to a small aimed-at area wherein the surface contact point of multiple lasers are slightly spaced apart. Each receiver element may include a sensing element having one or more avalanche photodiodes, avalanche photodiode arrays, silicon photomultipliers (SiPM), and/or like photodetector sensors for receiving the reflected light input of the corresponding laser element and generating corresponding electrical input signals. The receiver element may further include a gain control element to vary the gain of the sensing element. A phase detector may measure the phase of each emitted laser and each of the corresponding input signal. A processing element may be included having one or more processors to calculate phase differences between the emitted lasers and input signals received in determining distance measurements. Such distance measurements, as well as instructions relating to generating such distance measurement, may be stored in a memory element having one or more non-transitory memories. The multi-spectral laser rangefinder may further include a housing element to encapsulate or partially encapsulate the various multi-spectral laser rangefinder elements, isolate the receiver element from light sources other than the reflected light input to the extent possible, and further have one or more windows or other openings such that the emitted laser and reflected light input may travel between rangefinder laser elements/receiver elements and the external environment. In some embodiments, the housing may be waterproof wherein the multi-spectral laser rangefinder may be used in an underwater environment. A power element may further be included for portioning of electrical power to the various powered elements of multi-spectral laser rangefinder.

In another aspect, the present disclosure relates to a utility locator device including a laser rangefinder (also referred to herein as “range finding utility locator device” or simply “utility locator device”) of the present invention which may be one of the daylight visible laser rangefinders or multi-spectral laser rangefinders described herein. The range finding utility locator device may include a locator subsystem having one or more antennas and associated receiver circuitry to receive magnetic signals emitted by utility lines which may be buried in the ground. A user interface and input element may receive input commands from a user and further communicate data relating to distance measurements, utility line positions, and mapping information to a user. The range finding utility locator device may include a laser rangefinder of the present invention (e.g., the daylight visible laser rangefinders or multi-spectral laser rangefinders described herein). A processing element may be included having one or more processors to carry out methods associated with determining positions of utility lines based on the magnetic signals and to further calculate phase differences between the emitted lasers and corresponding ones of the reflected light input in determining distance measurements. A memory element may be included in a range finding utility locator device having one or more non-transitory memories to store instructions relating to determining utility line positions and resulting positions as well as for storing instructions relating to calculating of distance measurements and the resulting calculated distance measurements. A housing element may be included to house electronics and other components associated with utility locator device elements and included laser rangefinder. A power element may further be included for portioning of electrical power to the various powered elements of range finding utility locator device.

In another aspect, the present disclosure includes a method as described correlating data of range finding utility locator devices of the present disclosure. The method may include, a range finding utility locator device determining positions/orientation of utility line(s) relative to range finding utility locator device and determining geolocation/orientation/pose data for the range finding utility locator device. The method may further include the laser rangefinder of the range finding utility locator device determining distance measurement to a target. Positions/orientations of utility line(s) relative to utility locator device, the geolocation/orientation/pose data for the utility locator device, and distance measurement to a target may be correlated to resolve positions of each in the world frame. Correlated data may be stored in a memory element having one or more non-transitory memories.

In another aspect, the present disclosure relates to a method for determining distance measurements via a laser rangefinder of the present invention. The method may include emitting one or more continuous wave lasers modulated at a known frequency or frequencies. One emitted laser may be a daylight visible laser. The emitted laser(s) may contact a target and reflect light generating “reflected light input(s).” In another step, reflected light input(s) may be received at sensing element(s) in the receiver element(s) that may include one or more avalanche photodiodes, avalanche photodiode arrays, silicon photomultipliers (SiPM), and/or like photodetector sensors to appropriate levels. In another step, the gain of a sensing element may be adjusted to achieve appropriate amplitude levels. In another step, electrical input signal(s) corresponding to the reflected light input(s) may be generated by the sensing element. In another step, the phase(s) of emitted laser(s) and input signal(s) may be measured. In another step, the measured phases of each emitted laser and corresponding input signal may be compared. In another step, distance measurement(s) may be calculated based on differences in measured phases of each emitted laser and corresponding input signal. In another step, distance measurement(s) and/or associated information may be stored in a memory element having one or more non-transitory memories. In another step, distance measurement(s) and/or associated information may be communicated to a user/other device.

In another aspect, the present disclosure includes a method for evaluating multiple distance measurements. The method may include generating multiple distance measurements and sorting measurements based on whether they meet a variance threshold. As used herein, the term “variance threshold” may refer to a range of distance measurements wherein distance measurements that fall outside the acceptable range may indicate an invalid or incorrect distance measurement due to some error. The variance threshold may, for instance, be a percentage difference between distance measurements, a maximum or minimum in difference in total distance measurement, or other like metric. The distance measurements meeting the variance threshold may, in some embodiments, be used. For instance, distance measurements meeting the variance threshold may be averaged or have a weighted average applied thereto in the calculation of a singular distance measurement. In some embodiments, all distance measurements that meet the variance threshold may be used. Optionally, the valid distance measurement(s) and/or associated information may be displayed on a user interface. The valid distance measurement(s) and/or associated information may be stored on a memory element having one or more non-transitory memories. Distance measurements that do not meet the variance threshold may be invalid and may identify potential problems with distance measurements. Optionally, invalid distance measurements may be interpreted to identify additional information regarding the target (e.g., the presence of fluorescence in the target or the like). Optionally, the targets associated with invalid distance measurements may be electronically tagged (referring to a designation given to laser rangefinder targets that may have particular significance at the target geolocation). For instance, such an electronic tag may designate the target as having fluorescence or be associated with a distance measurement problem or the like. Optionally, the invalid distance measurements, interpreted information, associated tag, and/or other associated information may be displayed on a user interface device. In another optional step, the method may include storing invalid distance measurements, interpreted information, associated tag, and/or other associated information in a memory element having one or more non-transitory memories.

In another aspect, the present disclosure relates to a method for manufacturing optical windows. The method may include scoring square or other polygonal shapes into a sheet of optical window material, breaking each optical window defined by the scored window shape away from the sheet of optical window material, and applying adhesive to each optical window for securing in, on, or to a port or about some other opening.

In another aspect, the present disclosure may include a method for determining the depth of a utility line relative to the ground surface. The method may include determining positions/orientations of utility line(s) relative to a range finding utility locator device that includes a depth measurement of each utility line relative to the sense antennas in the range finding utility locator device, determining the geolocation and orientation/pose of the range finding utility locator device, and determining distance measurement(s) to a target via a laser rangefinder in the range finding utility locator device. The method may further include calculating the height of the laser rangefinder in the range finding utility locator device from the ground surface, determining the height of the laser rangefinder relative to the sense antennas in the range finding utility locator device, calculating the height of the sense antennas from the ground surface, and calculating the depth of the utility line(s) relative to the ground surface. The depth(s) relative to the ground surface at the geolocation and associated information may be stored in a memory element having one or more non-transitory memories. Optionally, the depth(s) of the utility line(s) relative to the ground surface and associated information may be displayed on a user interface.

In another aspect, the present disclosure may include a method for determining fluorescence in a target via a multi-spectral laser rangefinder. The method may include determining distance measurements to the same target via a multi-spectral laser rangefinder (e.g., a green laser) having one laser element emitting a substantially fluorescent excitation wavelength laser and another laser element emitting a substantially non-fluorescent excitation wavelength laser (e.g., a red laser), determining if the distance measurements agree to within a predetermined threshold, and detecting fluorescence wherein distance measurements do not agree to within the predetermined threshold and the fluorescent excitation wavelength laser is in error. The method may further include storing fluorescent designations for targets and/or associated information in a memory element having one or more non-transitory memory elements. Optionally, the fluorescent designation and associated information may be displayed on a user interface. In some embodiments, the fluorescent targets may be electronically tagged to notate significance of the fluorescent target at the corresponding geolocation.

In another aspect, the present disclosure may include a method for determining the color of a target via a multi-spectral laser rangefinder. The method may include emitting two or more lasers at different known wavelengths at a target via a multi-spectral laser rangefinder, receiving reflected light input from each laser contacting the target, adjusting the gain to a sensing element, determining a reflected values data set (e.g., including measures of phase, amplitudes of received reflected light input, gain levels, frequencies, or other attributes of the reflected light inputs) for each reflected light input that may include various attributes of the reflected light input, and determining the color of the target based on reflected values via statistical modeling correlating color to particular reflected values data sets or ratios of reflected value data sets between reflected light inputs. The method may further include storing the color and/or associated information in a memory element having one or more non-transitory memories. Optionally, the color and/or associated information may be displayed via a user interface.

In another aspect, the present disclosure may include a method for determining the surface material of an area scanned via a multi-spectral laser rangefinder. The method may include determining target colors and associated reflected value data sets for a plurality of targets via a multi-spectral laser rangefinder moved about an area, grouping targets based on the time in which target is sampled, positional relationships between targets, and/or similarity in reflected value data sets, determining average colors for each group, and determining the surface material from the average colors of the group. The method may further include storing surface materials and/or associated information in a memory element having one or more non-transitory memories. Optionally, the surface material and/or associated information may be displayed via a user interface.

In another aspect, the present disclosure includes a method for focusing cameras via a laser rangefinder of the present disclosure. The method may including a laser rangefinder of the present disclosure that further includes or couples to one or more cameras for generating images of a target to determine distance measurement(s) to the target, using the calculated distance measurement to focus the camera(s), generating one or more images that include the target, and storing the distance measurement(s), image(s), and/or associated information on a memory element having one or more non-transitory memories. Optionally, the method may further include displaying the distance measurement(s), image(s), and/or associated information on a user interface.

In another aspect, the present disclosure includes a method for navigating underwater environments using a laser rangefinder of the present disclosure. The method may include determining one or more distance measurements via a laser rangefinder of the present disclosure, determining whether the distance measurement(s) fall inside a predetermined threshold, and moving the underwater vehicle when the distance measurement(s) do not fall inside the predetermined threshold or detecting a potential impending collision wherein the distance measurement(s) do fall inside the predetermined threshold. Where a potential impending collision has been detected, an alert may notify a user/operator and/or the movement of the underwater vehicle may be halted or redirected. Optionally, the position information of the underwater vehicle may be updated via distance measurements. The distance measurement(s), position, and/or associated information may optionally be displayed in a user interface and/or stored on a memory element having one or more non-transitory memories.

In another aspect, the present disclosure may include a method for characterizing the seafloor using a multi-spectral underwater laser rangefinder of the present disclosure. The method may include emitting two or more lasers at a target using a multi-spectral underwater laser rangefinder, generating reflected light inputs from emitted lasers contacting and reflecting off the target, receiving reflected light inputs at the sensing element of corresponding receiver elements wherein the gain to the sensing element is controlled to compensate for attenuated amplitudes of the received reflected light inputs, and determining a reflected values data set for each reflected light input that may include various attributes of the reflected light inputs. The method may further include determining the color of the target based on reflected values via statistical modeling correlating color to particular reflected values data sets or ratios of reflected value data sets between reflected light inputs, storing the color and/or associated information in a memory element having one or more non-transitory memories, and repeating the aforementioned steps to determine the color and/or associated information for a plurality of targets. The method may further include grouping targets based on the time in which a target is sampled, positional relationships between targets, and/or similarities in reflected value data sets, determining the average color for each group, determining the characterization of the seafloor for each group based on average color, and storing the seafloor characterizations and/or associated information in a memory element having on or more non-transitory memories. Optionally, the method may further include displaying the seafloor characterizations and/or associated information on a user interface.

In another aspect, the present invention may include a method for detecting leaks in underwater pipes using an underwater laser rangefinder of the present disclosure. The method may include injecting or including dye in an underwater pipe, selecting a target, determining distance measurements along the underwater pipe using an underwater laser rangefinder, and determining, for each distance measurement, whether the distance varies outside a predetermined threshold. The method may further include detecting leaks when the distance measurement varies outside the predetermined threshold or no leak when the distance measurement does not vary outside the predetermined threshold and storing leak information associated with the target location along the pipe and/or distance measurements and/or other associated information in a memory element having one or more non-transitory memory elements. Optionally, the method may include displaying the leak information associated with the target location along the pipe and/or distance measurements and/or other associated information on a user interface.

In another aspect, the present disclosure may include a combined underwater scaling and range finding device. The combined underwater scaling and range finding device may include a laser scaling apparatus for determining the scale of underwater objects. It may further include at least two scaling lasers at a known distance apart for emitting lasers at a target, a camera for generating one or more images of the target and laser contact points, a processing element having one or more processors to determine a measurement of scale from the image(s) containing the laser contact points, and a memory element having one or more non-transitory memories to store the scale measurement and associated information. The combined underwater scaling and range finding device may further include a laser rangefinder of the present invention configured for underwater use to determine one or more distance measurements to the same target. The laser rangefinder may be a daylight visible laser rangefinder or multi-spectral laser rangefinder of the present disclosure. In some embodiments, the combined underwater scaling and range finding device may couple to or be included in an underwater vehicle or other host device.

In another aspect, the present disclosure may include a method for generating scale and distance measurements of a target via a combined underwater scaling and range finding device of the present disclosure. The method may include using a laser rangefinder to emit one or more lasers at a target and determining one or more distance measurements to the target from reflected light input(s). The method may further include using a laser scaling apparatus to emit lasers from a pair of parallel scaling lasers having a known distance apart at the same target, generating one or more images of the target area that include laser contacts from the camera of the laser scaling apparatus, and determining a scaling measurement from the image(s) of the target including the scaling lasers. Optionally, the scaling measurement may be refined using the determined distance measurement(s). The method may further include storing the scaling measurement, distance measurement(s), image(s), and/or associated information in a memory element having one or more non-transitory memories. Optionally, the method may include displaying the scaling measurement, distance measurement(s), image(s), and/or associated information on a user interface.

Various additional aspects, features, and functions are described below in conjunction with the appended Drawings.

### BRIEF DESCRIPTION OF THE DRAWINGS

The present application may be more fully appreciated in connection with the following detailed description taken in conjunction with the accompanying drawings, wherein:

FIG. 1A is an isometric view of a daylight visible laser rangefinder module.

FIG. 1B is a partially exploded isometric view of the daylight visible laser rangefinder module from FIG. 1A.

FIG. 1C is an exploded isometric view of a front housing subassembly from the daylight visible laser rangefinder module of FIG. 1A.

FIG. 1D is an exploded isometric view of a rangefinder subassembly from the daylight visible laser rangefinder module of FIG. 1A.

FIG. 1E is a diagram demonstrating wavelengths perceptible in photopic lighting conditions as understood via the luminous efficiency function relative to different laser color wavelengths.

FIG. 2 is a diagram of a daylight visible laser rangefinder embodiment.

FIG. 3 is a diagram of another daylight visible laser rangefinder embodiment.

FIG. 4A is an isometric view of a stand-alone daylight visible laser rangefinder.

FIG. 4B is a partially exploded isometric view of the stand-alone daylight visible laser rangefinder from FIG. A.

FIG. 4C is an illustration of the stand-alone daylight visible laser rangefinder in use.

FIG. 4D is another isometric view of a stand-alone daylight visible laser rangefinder showing a user interface and user input controls.

FIG. 5A is an isometric view of a multi-spectral laser rangefinder module.

FIG. 5B is a partially exploded isometric view of the multi-spectral laser rangefinder module from FIG. 5A.

FIG. 5C is an exploded isometric view of a front housing subassembly from the multi-spectral laser rangefinder module of FIG. 5A.

FIG. 5D is an exploded isometric view of a rangefinder subassembly from the multi-spectral laser rangefinder module of FIG. 5A.

FIG. 5E is an exploded isometric view of another rangefinder subassembly from a multi-spectral laser rangefinder module embodiment.

FIG. 6A is a diagram of a multi-spectral laser rangefinder embodiment.

FIG. 6B is a diagram of another multi-spectral laser rangefinder embodiment.

FIG. 7A is a diagram of another multi-spectral laser rangefinder embodiment.

FIG. 7B is a diagram of another multi-spectral laser rangefinder embodiment.

FIG. 8A is a diagram of a laser rangefinder having a plurality of laser elements and corresponding receiver elements.

FIG. 8B is a diagram of another multi-spectral laser rangefinder embodiment having a plurality of laser elements and corresponding receiver elements.

FIG. 9A is an isometric view of another stand-alone laser visible laser rangefinder.

FIG. 9B is a partially exploded isometric view of the stand-alone multi-spectral laser rangefinder from FIG. 9A.

FIG. 9C is an illustration of the stand-alone multi-spectral laser rangefinder in use.

FIG. 9D is another isometric view of a stand-alone multi-spectral laser rangefinder showing a user interface and user input controls.

FIG. 10 is a method for range finding using a laser rangefinder of the present disclosure.

FIG. 11A is a method for evaluating multiple distance measurements.

FIG. 11B is a method for determining fluorescence in a target.

FIG. 11C is a method for determining the color of a target.

FIG. 11D is a method for determining the surface material of an area scanned by a laser rangefinder.

FIG. 12A is an isometric view of a range finding utility locator device.

FIG. 12B is a partially exploded isometric view of the range finding utility locator device from FIG. 12A.

FIG. 12C is another isometric view of the range finding utility locator device from FIG. 12A.

FIG. 12D is a diagram of the range finding utility locator device from FIG. 12A.

FIG. 13 is a method for determining position data that includes a position and pose as well as a depth measurement of a received signal corresponding to a utility line.

FIG. 14 is an illustration of a range finding utility locator device, having a camera to generate an image of the laser rangefinder target, in use.

FIG. 15 is an illustration of another range finding utility locator device, having multiple cameras to generate overlapping images containing the laser rangefinder target, in use.

FIG. 16A is a method for correlating various data in a range finding utility locator device.

FIG. 16B is an illustration of a smart phone displaying an electronic map that may be generated via the method from FIG. 16A.

FIG. 16C is an illustration of a range finding utility locator device defining variables for FIG. 16D.

FIG. 16D is a method for calculating the depth of a utility line or lines relative to the ground surface.

FIG. 17A is an illustration demonstration a method for manufacturing optical windows.

FIG. 17B is another illustration demonstration a method for manufacturing optical windows.

FIG. 18 is a method for manufacturing optical windows.

FIG. 19A is an illustration of an underwater laser rangefinder.

FIG. 19B is a diagram of the underwater laser rangefinder from FIG. 19A.

FIG. 19C is a diagram of another multi-spectral laser rangefinder embodiment.

FIG. 20 is an underwater laser rangefinder in an ROV further having a camera.

FIG. 21A is a method for navigating underwater environments using a laser rangefinder.

FIG. 21B is a method for characterizing the seafloor via a laser rangefinder.

FIG. 22A is a diagram of an underwater laser rangefinder.

FIG. 22B is a diagram of another multi-spectral laser rangefinder embodiment.

FIG. 23 is a method for detecting leaks in underwater pipes via a laser rangefinder.

FIG. 24 is a method for focusing a camera via a laser rangefinder.

FIG. 25 is a diagram of a combined underwater scaling and range finding device.

FIG. 26 is a method for generating scaling and distance measurements via a combined underwater scaling and range finding device.

### DETAILED DESCRIPTION OF EMBODIMENTS

### Terminology

As used herein, the term “daylight visible” may refer to light at wavelengths that may be readily detectable by the human eye in daylight conditions. That is, “daylight visible” or “daylight visible lasers” herein may be at wavelengths perceptible at photopic lighting conditions as understood via the luminous efficiency function describing the average spectral sensitivity of human visual perception of brightness of light at different wavelengths. It should also be noted that though a green laser is provided as the example for a daylight visible laser, other wavelength lasers readily perceivable by the human eye under photopic lighting conditions may be considered daylight visible lasers. This may be in contrast to red lasers as commonly used in the art that generally range in the 650 to 700 nm wavelengths which largely fall outside the range of perceivable light in photopic lighting conditions.

As used herein, the term “position” refers to a location in space, typically in three-dimensional (X, Y, Z coordinates or their equivalent) space, as well as a “pose” of the source at that location relative to some other device or location. The pose may be the orientation at that particular location. For example, a range finding utility locator device embodiment may have a position that includes a geolocation in three dimensional space relative to the world frame (e.g., GNSS coordinates plus an altitude) as well as a pose or orientation describing the direction and degree of tilt of the range finding utility locator device with respect to the world frame.

As used herein, “target” may refer to the point or collection of nearby points at which a laser rangefinder device of the present invention may be aimed at such that an emitted laser or lasers may contact the target. It should be noted that the term “target,” in such multi-laser embodiments, may refer to a small aimed at area wherein the surface contact point of multiple lasers may be slightly spaced apart.

The term “emitted laser” may refer to the outgoing laser beam emitted by a laser rangefinder of the present invention. The emitted laser, upon contacting a target may reflect light referred to herein as the “reflected light input.” It should be noted that the reflected light input may include some ambient light. A receiver element may sense the reflected light input for purposes of calculating distance measurements. Reflected light input may further be converted to a corresponding electrical signal, referred to herein as the “input signal,” via the sensing element.

The term “laser rangefinder” may refer to any of the rangefinder embodiments including daylight visible, multi-spectral, underwater, and/or other rangefinders included in a host device. As used herein, the term “laser rangefinder” may be proceeded with the term “daylight visible” when referring to embodiments having at least one daylight visible laser elements and the term “laser rangefinder” may be proceeded with the term “multi-spectral” when referring to embodiments having two or more laser elements operating at different wavelengths wherein one or more may be daylight visible or other lasers. Likewise, the term “laser rangefinder” may be proceeded with the term “underwater” when referring to embodiments configured for use in underwater environments (e.g., having a waterproof housing and/or other modifications for use in underwater environments).

The term “substantially fluorescent excitation wavelength laser” may refer to any wavelength laser that substantially excites the fluorescence of a target (e.g., fluorescent paint markings or the like). For instance, a green laser is given herein as an example of a fluorescent excitation wavelength laser due to its proficiency at exciting the fluorescence of a target. The term “substantially non-fluorescent excitation wavelength laser” may refer to any wavelength laser that fails to or largely fails to excite the fluorescence of a target. For instance, a red laser is given herein as an example of a fluorescent excitation wavelength laser due to its substantial failure to excite the fluorescence of a target. It should be noted that though a red laser is provided as a “substantially non-fluorescent excitation wavelength laser,” in use a red laser may result in some fluorescence excitation though, in most applications, substantially less so than the exemplary fluorescent excitation wavelength green laser. The term “range finding utility locator device” may refer to a utility locator device configured to sense magnetic signals from utility lines which may be buried in the ground (e.g., utility lines with an inherent current or having an AC current coupled thereon or the like), determine and/or map positions/orientations of utility lines, and further include a laser rangefinder in keeping with the present invention. Additional details regarding utility locator devices may be found in the incorporated applications below.

As used herein, the term “variance threshold” may refer to a range of distance measurements wherein distance measurements that fall outside the acceptable range may indicate an invalid or incorrect distance measurement due to some error. The variance threshold may, for instance, be a percentage difference between distance measurements, a maximum or minimum in difference in total distance measurement, or other like metric.

The terms “electronically tag,” “electronically tagging,” “electronically tagged,” or simply “tag,” “tagging,” or “tagged” may refer to a designation given to laser rangefinder targets that may have particular significance. Such tags may generally include a geolocation or other position as well as user input and/or other data included in a data set associated with the tag. Such a tag and associated data set may be stored in a memory element having one or more non-transitory memories that is stored by the laser rangefinder and/or host device. For instance, in the range finding utility locator devices herein, some embodiments may tag certain laser rangefinder targets and associate a determined color, presence of fluorescence, user input (e.g., a user providing a typed or audio input note stating “manhole cover” or “transformer” or other notations regarding the tag and/or target and/or environment and/or other information that may pertain to utility locating), and/or other input data. In some embodiments, a user may initiate tagging a target through the press of a button or like input. In other embodiments, the initiation of tagging a target may be automated through image/pattern recognition, artificial intelligence or other algorithms.

The term “reflected values” or “reflected values data set” may refer to various attributes of reflected light inputs. For instance, in some embodiments, such reflected values may be or include measures of phase, amplitudes of received reflected light input, gain levels, frequencies, or other attributes of the reflected light inputs. In various embodiments, such reflected values data sets and/or ratios or other comparisons of reflected values data sets may be used to determine information regarding laser rangefinder targets and/or the target's environment.

### Overview

This disclosure relates generally to laser rangefinders. More specifically, but not exclusively, the disclosure relates to daylight visible laser rangefinders, multi-spectral laser rangefinders, underwater range finding devices, utility locator devices employing laser rangefinders, and associated methods.

The disclosures herein may be combined in various embodiments with the disclosures in co-assigned patents and patent applications including: U.S. Pat. No. 7,009,399, issued Mar. 7, 2006, entitled OMNIDIRECTIONAL SONDE AND LINE LOCATOR; U.S. Pat. No. 7,136,765, issued Nov. 14, 2006, entitled A BURIED OBJECT LOCATING AND TRACING METHOD AND SYSTEM EMPLOYING PRINCIPAL COMPONENTS ANALYSIS FOR BLIND SIGNAL DETECTION; U.S. Pat. No. 7,221,136, issued May 22, 2007, entitled SONDES FOR LOCATING UNDERGROUND PIPES AND CONDUITS; U.S. Pat. No. 7,276,910, issued Oct. 2, 2007, entitled A COMPACT SELF-TUNED ELECTRICAL RESONATOR FOR BURIED OBJECT LOCATOR APPLICATIONS; U.S. Pat. No. 7,288,929, issued Oct. 30, 2007, entitled INDUCTIVE CLAMP FOR APPLYING SIGNAL TO BURIED UTILITIES; U.S. Pat. No. 7,298,126, issued Nov. 20, 2007, entitled SONDES FOR LOCATING UNDERGROUND PIPES AND CONDUITS; U.S. Pat. No. 7,332,901, issued Feb. 19, 2008, entitled LOCATOR WITH APPARENT DEPTH INDICATION; U.S. Pat. No. 7,443,154, issued Oct. 28, 2008, entitled MULTI-SENSOR MAPPING OMNIDIRECTIONAL SONDE AND LINE LOCATOR; U.S. Pat. No. 7,498,797, issued Mar. 3, 2009, entitled LOCATOR WITH CURRENT-MEASURING CAPABILITY; U.S. Pat. No. 7,498,816, issued Mar. 3, 2009, entitled OMNIDIRECTIONAL SONDE AND LINE LOCATOR; U.S. Pat. No. 7,336,078, issued Feb. 26, 2008, entitled MULTI-SENSOR MAPPING OMNIDIRECTIONAL SONDE AND LINE LOCATORS; U.S. Pat. No. 7,518,374, issued Apr. 14, 2009, entitled RECONFIGURABLE PORTABLE LOCATOR EMPLOYING MULTIPLE SENSOR ARRAYS HAVING FLEXIBLE NESTED ORTHOGONAL ANTENNAS; U.S. Pat. No. 7,557,559, issued Jul. 7, 2009, entitled COMPACT LINE ILLUMINATOR FOR BURIED PIPES AND CABLES; U.S. Pat. No. 7,619,516, issued Nov. 17, 2009, entitled SINGLE AND MULTI-TRACE OMNIDIRECTIONAL SONDE AND LINE LOCATORS AND TRANSMITTER USED THEREWITH; U.S. Pat. No. 7,619,516, issued Nov. 17, 2009, entitled SINGLE AND MULTI-TRACE OMNIDIRECTIONAL SONDE AND LINE LOCATORS AND TRANSMITTER USED THEREWITH; U.S. Pat. No. 7,733,077, issued Jun. 8, 2010, entitled MULTI-SENSOR MAPPING OMNIDIRECTIONAL SONDE AND LINE LOCATORS AND TRANSMITTER USED THEREWITH; U.S. Pat. No. 7,741,848, issued Jun. 22, 2010, entitled ADAPTIVE MULTICHANNEL LOCATOR SYSTEM FOR MULTIPLE PROXIMITY DETECTION; U.S. Pat. No. 7,755,360, issued Jul. 13, 2010, entitled PORTABLE LOCATOR SYSTEM WITH JAMMING REDUCTION; U.S. Pat. No. 7,825,647, issued Nov. 2, 2010, entitled METHOD FOR LOCATING BURIED PIPES AND CABLES; U.S. Pat. No. 7,830,149, issued Nov. 9, 2010, entitled AN UNDERGROUND UTILITY LOCATOR WITH A TRANSMITTER, A PAIR OF UPWARDLY OPENING POCKET AND HELICAL COIL TYPE ELECTRICAL CORDS; U.S. Pat. No. 7,864,980, issued Jan. 4, 2011, entitled SONDES FOR LOCATING UNDERGROUND PIPES AND CONDUITS; U.S. Pat. No. 7,948,236, issued May 24, 2011, entitled ADAPTIVE MULTICHANNEL LOCATOR SYSTEM FOR MULTIPLE PROXIMITY DETECTION; U.S. Pat. No. 7,969,151, issued Jun. 28, 2011, entitled PRE-AMPLIFIER AND MIXER CIRCUITRY FOR A LOCATOR ANTENNA; U.S. Pat. No. 7,990,151, issued Aug. 2, 2011, entitled TRI-POD BURIED LOCATOR SYSTEM; U.S. Pat. No. 8,013,610, issued Sep. 6, 2011, entitled HIGH Q SELF-TUNING LOCATING TRANSMITTER; U.S. Pat. No. 8,035,390, issued Oct. 11, 2011, entitled OMNIDIRECTIONAL SONDE AND LINE LOCATOR; U.S. Pat. No. 8,106,660, issued Jan. 31, 2012, entitled SONDE ARRAY FOR USE WITH BURIED LINE LOCATOR; U.S. Pat. No. 8,203,343, issued Jun. 19, 2012, entitled RECONFIGURABLE PORTABLE LOCATOR EMPLOYING MULTIPLE SENSOR ARRAYS HAVING FLEXIBLE NESTED ORTHOGONAL ANTENNAS; U.S. Pat. No. 8,264,226, issued Sep. 11, 2012, entitled SYSTEM AND METHOD FOR LOCATING BURIED PIPES AND CABLES WITH A MAN PORTABLE LOCATOR AND A TRANSMITTER IN A MESH NETWORK; U.S. Pat. No. 8,248,056, issued Aug. 21, 2012, entitled A BURIED OBJECT LOCATOR SYSTEM EMPLOYING AUTOMATED VIRTUAL DEPTH EVENT DETECTION AND SIGNALING; U.S. patent application Ser. No. 13/769,202, filed Feb. 15, 2013, entitled SMART PAINT STICK DEVICES AND METHODS; U.S. patent application Ser. No. 13/793,168, filed Mar. 11, 2013, entitled BURIED OBJECT LOCATORS WITH CONDUCTIVE ANTENNA BOBBINS; U.S. Pat. No. 8,400,154, issued Mar. 19, 2013, entitled LOCATOR ANTENNA WITH CONDUCTIVE BOBBIN; U.S. patent application Ser. No. 14/027,027, filed Sep. 13, 2013, entitled SONDE DEVICES INCLUDING A SECTIONAL FERRITE CORE STRUCTURE; U.S. patent application Ser. No. 14/033,349, filed Sep. 20, 2013, entitled AN UNDERGROUND UTILITY LOCATOR WITH A TRANSMITTER, A PAIR OF UPWARDLY OPENING POCKET AND HELICAL COIL TYPE ELECTRICAL CORDS; U.S. Pat. No. 8,547,428, issued Oct. 1, 2013, entitled PIPE MAPPING SYSTEM; U.S. Pat. No. 8,564,295, issued Oct. 22, 2013, entitled METHOD FOR SIMULTANEOUSLY DETERMINING A PLURALITY OF DIFFERENT LOCATIONS OF THE BURIED OBJECTS AND SIMULTANEOUSLY INDICATING THE DIFFERENT LOCATIONS TO A USER; U.S. patent application Ser. No. 14/148,649, filed Jan. 6, 2014, entitled MAPPING LOCATING SYSTEMS & METHODS; U.S. Pat. No. 8,635,043, issued Jan. 21, 2014, entitled LOCATOR AND TRANSMITTER CALIBRATION SYSTEM; U.S. Pat. No. 8,717,028, issued May 6, 2014, entitled SPRING CLIPS FOR USE WITH LOCATING TRANSMITTERS; U.S. Pat. No. 8,773,133, issued Jul. 8, 2014, entitled ADAPTIVE MULTICHANNEL LOCATOR SYSTEM FOR MULTIPLE PROXIMITY DETECTION; U.S. Pat. No. 8,841,912, issued Sep. 23, 2014, entitled PRE-AMPLIFIER AND MIXER CIRCUITRY FOR A LOCATOR ANTENNA; U.S. Pat. No. 9,041,794, issued May 26, 2015, entitled PIPE MAPPING SYSTEMS AND METHODS; U.S. Pat. No. 9,057,754, issued Jun. 16, 2015, entitled ECONOMICAL MAGNETIC LOCATOR APPARATUS AND METHOD; U.S. Pat. No. 9,081,109, issued Jul. 14, 2015, entitled GROUND-TRACKING DEVICES FOR USE WITH A MAPPING LOCATOR; U.S. Pat. No. 9,082,269, issued Jul. 14, 2015, entitled HAPTIC DIRECTIONAL FEEDBACK HANDLES FOR LOCATION DEVICES; U.S. Pat. No. 9,085,007, issued Jul. 21, 2015, entitled MARKING PAINT APPLICATOR FOR PORTABLE LOCATOR; U.S. Pat. No. 9,207,350, issued Dec. 8, 2015, entitled BURIED OBJECT LOCATOR APPARATUS WITH SAFETY LIGHTING ARRAY; U.S. Pat. No. 9,341,740, issued May 17, 2016, entitled OPTICAL GROUND TRACKING APPARATUS, SYSTEMS, AND METHODS; U.S. Pat. No. 9,372,117, issued Jun. 21, 2016, entitled OPTICAL GROUND TRACKING APPARATUS, SYSTEMS, AND METHODS; U.S. patent application Ser. No. 15/187,785, filed Jun. 21, 2016, entitled BURIED UTILITY LOCATOR GROUND TRACKING APPARATUS, SYSTEMS, AND METHODS; U.S. Pat. No. 9,411,066, issued Aug. 9, 2016, entitled SONDES & METHODS FOR USE WITH BURIED LINE LOCATOR SYSTEMS; U.S. Pat. No. 9,411,067, issued Aug. 9, 2016, entitled GROUND-TRACKING SYSTEMS AND APPARATUS; U.S. Pat. No. 9,435,907, issued Sep. 6, 2016, entitled PHASE SYNCHRONIZED BURIED OBJECT LOCATOR APPARATUS, SYSTEMS, AND METHODS; U.S. Pat. No. 9,465,129, issued Oct. 11, 2016, entitled IMAGE-BASED MAPPING LOCATING SYSTEM; U.S. Pat. No. 9,488,747, issued Nov. 8, 2016, entitled GRADIENT ANTENNA COILS AND ARRAYS FOR USE IN LOCATING SYSTEM; U.S. Pat. No. 9,494,706, issued Nov. 15, 2016, entitled OMNI-INDUCER TRANSMITTING DEVICES AND METHODS; U.S. Pat. No. 9,523,788, issued Dec. 20, 2016, entitled MAGNETIC SENSING BURIED OBJECT LOCATOR INCLUDING A CAMERA; U.S. Pat. No. 9,571,326, issued Feb. 14, 2017, entitled METHOD AND APPARATUS FOR HIGH-SPEED DATA TRANSFER EMPLOYING SELF-SYNCHRONIZING QUADRATURE AMPLITUDE MODULATION (QAM); U.S. Pat. No. 9,599,449, issued Mar. 21, 2017, entitled SYSTEMS AND METHODS FOR LOCATING BURIED OR HIDDEN OBJECTS USING SHEET CURRENT FLOW MODELS; U.S. Pat. No. 9,599,740, issued Mar. 21, 2017, entitled USER INTERFACES FOR UTILITY LOCATORS; U.S. Pat. No. 9,625,602, issued Apr. 18, 2017, entitled SMART PERSONAL COMMUNICATION DEVICES AS USER INTERFACES; U.S. Pat. No. 9,632,202, issued Apr. 25, 2017, entitled ECONOMICAL MAGNETIC LOCATOR APPARATUS AND METHODS; U.S. Pat. No. 9,634,878, issued Apr. 25, 2017, entitled SYSTEMS AND METHODS FOR DATA TRANSFER USING SELF-SYNCHRONIZING QUADRATURE AMPLITUDE MODULATION (QAM); United States patent application, filed Apr. 25, 2017, entitled SYSTEMS AND METHODS FOR LOCATING AND/OR MAPPING BURIED UTILITIES USING VEHICLE-MOUNTED LOCATING DEVICES; U.S. Pat. No. 9,638,824, issued May 2, 2017, entitled QUAD-GRADIENT COILS FOR USE IN LOCATING SYSTEMS; United States patent application, filed May 9, 2017, entitled BORING INSPECTION SYSTEMS AND METHODS; U.S. Pat. No. 9,651,711, issued May 16, 2017, entitled HORIZONTAL BORING INSPECTION DEVICE AND METHODS; U.S. Pat. No. 9,684,090, issued Jun. 20, 2017, entitled NULLED-SIGNAL LOCATING DEVICES, SYSTEMS, AND METHODS; U.S. Pat. No. 9,696,447, issued Jul. 4, 2017, entitled BURIED OBJECT LOCATING METHODS AND APPARATUS USING MULTIPLE ELECTROMAGNETIC SIGNALS; U.S. Pat. No. 9,696,448, issued Jul. 4, 2017, entitled GROUND-TRACKING DEVICES AND METHODS FOR USE WITH A UTILITY LOCATOR; U.S. Pat. No. 9,703,002, issued Jun. 11, 2017, entitled UTILITY LOCATOR SYSTEMS & METHODS; U.S. patent application Ser. No. 15/670,845, filed Aug. 7, 2016, entitled HIGH FREQUENCY AC-POWERED DRAIN CLEANING AND INSPECTION APPARATUS & METHODS; U.S. patent application Ser. No. 15/681,250, filed Aug. 18, 2017, entitled ELECTRONIC MARKER DEVICES AND SYSTEMS; U.S. patent application Ser. No. 15/681,409, filed Aug. 20, 2017, entitled WIRELESS BURIED PIPE & CABLE LOCATING SYSTEMS; U.S. Pat. No. 9,746,572, issued Aug. 29, 2017, entitled ELECTRONIC MARKER DEVICES AND SYSTEMS; U.S. Pat. No. 9,746,573, issued Aug. 29, 2017, entitled WIRELESS BURIED PIPE AND CABLE LOCATING SYSTEMS; U.S. Pat. No. 9,784,837, issued Oct. 10, 2017, entitled OPTICAL GROUND TRACKING APPARATUS, SYSTEMS & METHODS; U.S. patent application Ser. No. 15/811,361, filed Nov. 13, 2017, entitled OPTICAL GROUND-TRACKING APPARATUS, SYSTEMS, AND METHODS; U.S. Pat. No. 9,841,503, issued Dec. 12, 2017, entitled OPTICAL GROUND-TRACKING APPARATUS, SYSTEMS, AND METHODS; U.S. patent application Ser. No. 15/846,102, filed Dec. 18, 2017, entitled SYSTEMS AND METHOD FOR ELECTRONICALLY MARKING, LOCATING AND VIRTUALLY DISPLAYING BURIED UTILITIES; U.S. patent application Ser. No. 15/866,360, filed Jan. 9, 2018, entitled TRACKED DISTANCE MEASURING DEVICES, SYSTEMS, AND METHODS; U.S. Pat. No. 9,891,337, issued Feb. 13, 2018, entitled UTILITY LOCATOR TRANSMITTER DEVICES, SYSTEMS, and METHODS WITH DOCKABLE APPARATUS; U.S. Pat. No. 9,914,157, issued Mar. 13, 2018, entitled METHODS AND APPARATUS FOR CLEARING OBSTRUCTIONS WITH A JETTER PUSH-CABLE APPARATUS; U.S. patent application Ser. No. 15/925,643, issued Mar. 19, 2018, entitled PHASE-SYNCHRONIZED BURIED OBJECT TRANSMITTER AND LOCATOR METHODS AND APPARATUS; U.S. patent application Ser. No. 15/925,671, issued Mar. 19, 2018, entitled MULTI-FREQUENCY LOCATING SYSTEMS AND METHODS; U.S. patent application Ser. No. 15/936,250, filed Mar. 26, 2018, entitled GROUND TRACKING APPARATUS, SYSTEMS, AND METHODS; U.S. Pat. No. 9,927,545, issued Mar. 27, 2018, entitled MULTI-FREQUENCY LOCATING SYSTEMS & METHODS; U.S. Pat. No. 9,928,613, issued Mar. 27, 2018, entitled GROUND TRACKING APPARATUS, SYSTEMS, AND METHODS; U.S. patent application Ser. No. 15/250,666, filed Mar. 27, 2018, entitled PHASE-SYNCHRONIZED BURIED OBJECT TRANSMITTER AND LOCATOR METHODS AND APPARATUS; U.S. Pat. No. 9,880,309, issued Mar. 28, 2018, entitled UTILITY LOCATOR TRANSMITTER APPARATUS & METHODS; U.S. patent application Ser. No. 15/954,486, filed Apr. 16, 2018, entitled UTILITY LOCATOR APPARATUS, SYSTEMS, AND METHODS; U.S. Pat. No. 9,945,976, issued Apr. 17, 2018, entitled UTILITY LOCATOR APPARATUS, SYSTEMS, AND METHODS; U.S. Pat. No. 9,989,662, issued Jun. 5, 2018, entitled BURIED OBJECT LOCATING DEVICE WITH A PLURALITY OF SPHERICAL SENSOR BALLS THAT INCLUDE A PLURALITY OF ORTHOGONAL ANTENNAE; U.S. patent application Ser. No. 16/036,713, issued Jul. 16, 2018, entitled UTILITY LOCATOR APPARATUS AND SYSTEMS; U.S. Pat. No. 10,024,994, issued Jul. 17, 2018, entitled WEARABLE MAGNETIC FIELD UTILITY LOCATOR SYSTEM WITH SOUND FIELD GENERATION; U.S. Pat. No. 10,031,253, issued Jul. 24, 2018, entitled GRADIENT ANTENNA COILS AND ARRAYS FOR USE IN LOCATING SYSTEMS; U.S. Pat. No. 10,042,072, issued Aug. 7, 2018, entitled OMNI-INDUCER TRANSMITTING DEVICES AND METHODS; U.S. Pat. No. 10,059,504, issued Aug. 28, 2018, entitled MARKING PAINT APPLICATOR FOR USE WITH PORTABLE UTILITY LOCATOR; U.S. patent application Ser. No. 16/049,699, filed Jul. 30, 2018, entitled OMNI-INDUCER TRANSMITTING DEVICES AND METHODS; U.S. Pat. No. 10,069,667, issued Sep. 4, 2018, entitled SYSTEMS AND METHODS FOR DATA TRANSFER USING SELF-SYNCHRONIZING QUADRATURE AMPLITUDE MODULATION (QAM); U.S. patent application Ser. No. 16/121,379, filed Sep. 4, 2018, entitled KEYED CURRENT SIGNAL UTILITY LOCATING SYSTEMS AND METHODS; U.S. patent application Ser. No. 16/125,768, filed Sep. 10, 2018, entitled BURIED OBJECT LOCATOR APPARATUS AND METHODS; U.S. Pat. No. 10,073,186, issued Sep. 11, 2018, entitled KEYED CURRENT SIGNAL UTILITY LOCATING SYSTEMS AND METHODS; U.S. patent application Ser. No. 16/133,642, issued Sep. 17, 2018, entitled MAGNETIC UTILITY LOCATOR DEVICES AND METHODS; U.S. Pat. No. 10,078,149, issued Sep. 18, 2018, entitled BURIED OBJECT LOCATORS WITH DODECAHEDRAL ANTENNA NODES; U.S. Pat. No. 10,082,591, issued Sep. 25, 2018, entitled MAGNETIC UTILITY LOCATOR DEVICES & METHODS; U.S. Pat. No. 10,082,599, issued Sep. 25, 2018, entitled MAGNETIC SENSING BURIED OBJECT LOCATOR INCLUDING A CAMERA; U.S. Pat. No. 10,090,498, issued Oct. 2, 2018, entitled MODULAR BATTERY PACK APPARATUS, SYSTEMS, AND METHODS INCLUDING VIRAL DATA AND/OR CODE TRANSFER; U.S. patent application Ser. No. 16/160,874, filed Oct. 15, 2018, entitled TRACKABLE DIPOLE DEVICES, METHODS, AND SYSTEMS FOR USE WITH MARKING PAINT STICKS; U.S. patent application Ser. No. 16/222,994, filed Dec. 17, 2018, entitled UTILITY LOCATORS WITH RETRACTABLE SUPPORT STRUCTURES AND APPLICATIONS THEREOF; U.S. Pat. No. 10,105,723, issued Oct. 23, 2018, entitled TRACKABLE DIPOLE DEVICES, METHODS, AND SYSTEMS FOR USE WITH MARKING PAINT STICKS; U.S. Pat. No. 10,162,074, issued Dec. 25, 2018, entitled UTILITY LOCATORS WITH RETRACTABLE SUPPORT STRUCTURES AND APPLICATIONS THEREOF; U.S. patent application Ser. No. 16/241,864, filed Jan. 7, 2019, entitled TRACKED DISTANCE MEASURING DEVICES, SYSTEMS, AND METHODS; U.S. patent application Ser. No. 16/255,524, filed Jan. 23, 2019, entitled RECHARGEABLE BATTERY PACK ONBOARD CHARGE STATE INDICATION METHODS AND APPARATUS; U.S. Pat. No. 10,247,845, issued Apr. 2, 2019, entitled UTILITY LOCATOR TRANSMITTER APPARATUS AND METHODS; U.S. patent application Ser. No. 16/382,136, filed Apr. 11, 2019, entitled GEOGRAPHIC MAP UPDATING METHODS AND SYSTEMS; U.S. Pat. No. 10,274,632, issued Apr. 20, 2019, entitled UTILITY LOCATING SYSTEMS WITH MOBILE BASE STATION; U.S. patent application Ser. No. 16/390,967, filed Apr. 22, 2019, entitled UTILITY LOCATING SYSTEMS WITH MOBILE BASE STATION; U.S. patent application Ser. No. 29/692,937, filed May 29, 2019, entitled BURIED OBJECT LOCATOR; U.S. patent application Ser. No. 16/436,903, filed Jun. 10, 2019, entitled OPTICAL GROUND TRACKING APPARATUS, SYSTEMS, AND METHODS FOR USE WITH BURIED UTILITY LOCATORS; U.S. Pat. No. 10,317,559, issued Jun. 11, 2019, entitled GROUND-TRACKING DEVICES AND METHODS FOR USE WITH A UTILITY LOCATOR; U.S. patent application Ser. No. 16/449,187, filed Jun. 21, 2019, entitled ELECTROMAGNETIC MARKER DEVICES FOR BURIED OR HIDDEN USE; U.S. patent application Ser. No. 16/455,491, filed Jun. 27, 2019, entitled SELF-STANDING MULTI-LEG ATTACHMENT DEVICES FOR USE WITH UTILITY LOCATORS; U.S. Pat. No. 10,353,103, issued Jul. 16, 2019, entitled SELF-STANDING MULTI-LEG ATTACHMENT DEVICES FOR USE WITH UTILITY LOCATORS; U.S. patent application Ser. No. 16/551,653, filed Aug. 26, 2019, entitled BURIED UTILITY MARKER DEVICES, SYSTEMS, AND METHODS; U.S. Pat. No. 10,401,526, issued Sep. 3, 2019, entitled BURIED UTILITY MARKER DEVICES, SYSTEMS, AND METHODS; U.S. Pat. No. 10,324,188, issued Oct. 9, 2019, entitled OPTICAL GROUND TRACKING APPARATUS, SYSTEMS, AND METHODS FOR USE WITH BURIED UTILITY LOCATORS; U.S. patent application Ser. No. 16/446,456, filed Jun. 19, 2019, entitled DOCKABLE TRIPODAL CAMERA CONTROL UNIT; U.S. patent application Ser. No. 16/520,248, filed Jul. 23, 2019, entitled MODULAR BATTERY PACK APPARATUS, SYSTEMS, AND METHODS; U.S. Pat. No. 10,371,305, issued Aug. 6, 2019, entitled DOCKABLE TRIPODAL CAMERA CONTROL UNIT; U.S. Pat. No. 10,490,908, issued Nov. 26, 2019, entitled DUAL ANTENNA SYSTEMS WITH VARIABLE POLARIZATION; U.S. patent application Ser. No. 16/701,085, filed Dec. 2, 2019, entitled MAP GENERATION BASED ON UTILITY LINE POSITION AND ORIENTATION ESTIMATES; U.S. Pat. No. 10,534,105, issued Jan. 14, 2020, entitled UTILITY LOCATING TRANSMITTER APPARATUS AND METHODS; U.S. patent application Ser. No. 16/773,952, filed Jan. 27, 2020, entitled MAGNETIC FIELD CANCELING AUDIO DEVICES; U.S. patent application Ser. No. 16/780,813, filed Feb. 3, 2020, entitled RESILIENTLY DEFORMABLE MAGNETIC FIELD CORE APPARATUS AND APPLICATIONS; U.S. Pat. No. 10,555,086, issued Feb. 4, 2020, entitled MAGNETIC FIELD CANCELING AUDIO SPEAKERS FOR USE WITH BURIED UTILITY LOCATORS OR OTHER DEVICES; U.S. patent application Ser. No. 16/786,935, filed Feb. 10, 2020, entitled SYSTEMS AND METHODS FOR UNIQUELY IDENTIFYING BURIED UTILITIES IN A MULTI-UTILITY ENVIRONMENT; U.S. Pat. No. 10,557,824, issued Feb. 11, 2020, entitled RESILIENTLY DEFORMABLE MAGNETIC FIELD TRANSMITTER CORES FOR USE WITH UTILITY LOCATING DEVICES AND SYSTEMS; U.S. patent application Ser. No. 16/791,979, issued Feb. 14, 2020, entitled MARKING PAINT APPLICATOR APPARATUS; U.S. patent application Ser. No. 16/792,047, filed Feb. 14, 2020, entitled SATELLITE AND MAGNETIC FIELD SONDE APPARATUS AND METHODS; U.S. Pat. No. 10,564,309, issued Feb. 18, 2020, entitled SYSTEMS AND METHODS FOR UNIQUELY IDENTIFYING BURIED UTILITIES IN A MULTI-UTILITY ENVIRONMENT; U.S. Pat. No. 10,571,594, issued Feb. 25, 2020, entitled UTILITY LOCATOR DEVICES, SYSTEMS, AND METHODS WITH SATELLITE AND MAGNETIC FIELD SONDE ANTENNA SYSTEMS; U.S. Pat. No. 10,569,952, issued Feb. 25, 2020, entitled MARKING PAINT APPLICATOR FOR USE WITH PORTABLE UTILITY LOCATOR; U.S. patent application Ser. No. 16/810,788, filed Mar. 5, 2019, entitled MAGNETICALLY RETAINED DEVICE HANDLES; U.S. patent application Ser. No. 16/827,672, filed Mar. 23, 2020, entitled DUAL ANTENNA SYSTEMS WITH VARIABLE POLARIZATION; U.S. patent application Ser. No. 16/833,426, filed Mar. 27, 2020, entitled LOW COST, HIGH PERFORMANCE SIGNAL PROCESSING IN A MAGNETIC-FIELD SENSING BURIED UTILITY LOCATOR SYSTEM; U.S. Pat. No. 10,608,348, issued Mar. 31, 2020, entitled DUAL ANTENNA SYSTEMS WITH VARIABLE POLARIZATION; U.S. patent application Ser. No. 16/837,923, filed Apr. 1, 2020, entitled MODULAR BATTERY PACK APPARATUS, SYSTEMS, AND METHODS INCLUDING VIRAL DATA AND/OR CODE TRANSFER; U.S. patent application Ser. No. 17/235,507, filed Apr. 20, 2021, entitled UTILITY LOCATING DEVICES EMPLOYING MULTIPLE SPACED APART GNSS ANTENNAS; U.S. Provisional Patent Application 63/015,692, filed Apr. 27, 2020, entitled SPATIALLY AND PROCESSING-BASED DIVERSE REDUNDANCY FOR RTK POSITIONING; U.S. patent application Ser. No. 16/872,362, filed May 11, 2020, entitled BURIED LOCATOR SYSTEMS AND METHODS; U.S. patent application Ser. No. 16/882,719, filed May 25, 2020, entitled UTILITY LOCATING SYSTEMS, DEVICES, AND METHODS USING RADIO BROADCAST SIGNALS; U.S. Pat. No. 10,670,766, issued Jun. 2, 2020, entitled UTILITY LOCATING SYSTEMS, DEVICES, AND METHODS USING RADIO BROADCAST SIGNALS; U.S. Pat. No. 10,677,820, issued Jun. 9, 2020, entitled BURIED LOCATOR SYSTEMS AND METHODS; U.S. patent application Ser. No. 16/902,245, filed Jun. 15, 2020, entitled LOCATING DEVICES, SYSTEMS, AND METHODS USING FREQUENCY SUITES FOR UTILITY DETECTION; U.S. patent application Ser. No. 16/902,249, filed Jun. 15, 2020, entitled USER INTERFACES FOR UTILITY LOCATORS; U.S. Pat. No. 10,690,795, issued Jun. 23, 2020, entitled LOCATING DEVICES, SYSTEMS, AND METHODS USING FREQUENCY SUITES FOR UTILITY DETECTION; U.S. patent application Ser. No. 16/908,625, filed Jun. 22, 2020, entitled ELECTROMAGNETIC MARKER DEVICES WITH SEPARATE RECEIVE AND TRANSMIT ANTENNA ELEMENTS; U.S. Pat. No. 10,690,796, issued Jun. 23, 2020, entitled USER INTERFACES FOR UTILITY LOCATORS; U.S. patent application Ser. No. 16/921,775, filed Jul. 6, 2020, entitled AUTO-TUNING CIRCUIT APPARATUS AND METHODS; U.S. Provisional Patent Application 63/055,278, filed Jul. 22, 2020, entitled VEHICLE-BASED UTILITY LOCATING USING PRINCIPAL COMPONENTS; U.S. patent application Ser. No. 16/995,801, filed Aug. 17, 2020, entitled UTILITY LOCATOR TRANSMITTER DEVICES, SYSTEMS, AND METHODS; U.S. patent application Ser. No. 17/001,200, filed Aug. 24, 2020, entitled MAGNETIC SENSING BURIED UTILITY LOCATOR INCLUDING A CAMERA; U.S. patent Ser. No. 16/995,793, filed Aug. 17, 2020, entitled UTILITY LOCATOR APPARATUS AND METHODS; U.S. Pat. No. 10,753,722, issued Aug. 25, 2020, entitled SYSTEMS AND METHODS FOR LOCATING BURIED OR HIDDEN OBJECTS USING SHEET CURRENT FLOW MODELS; U.S. Pat. No. 10,754,053, issued Aug. 25, 2020, entitled UTILITY LOCATOR TRANSMITTER DEVICES, SYSTEMS, AND METHODS WITH DOCKABLE APPARATUS; U.S. Pat. No. 10,761,233, issued Sep. 1, 2020, entitled SONDES AND METHODS FOR USE WITH BURIED LINE LOCATOR SYSTEMS; U.S. Pat. No. 10,761,239, issued Sep. 1, 2020, entitled MAGNETIC SENSING BURIED UTILITY LOCATOR INCLUDING A CAMERA; U.S. patent application Ser. No. 17/013,831, filed Sep. 7, 2020, entitled MULTIFUNCTION BURIED UTILITY LOCATING CLIPS; U.S. Pat. No. 10,777,919, issued Sep. 15, 2020, entitled MULTIFUNCTION BURIED UTILITY LOCATING CLIPS; U.S. patent application Ser. No. 17/020,487, filed Sep. 14, 2020, entitled ANTENNA SYSTEMS FOR CIRCULARLY POLARIZED RADIO SIGNALS; U.S. patent application Ser. No. 17/068,156, filed Oct. 12, 2020, entitled DUAL SENSED LOCATING SYSTEMS AND METHODS; U.S. Provisional Patent Application 63/091,67, filed Oct. 14, 2020, entitled ELECTRONIC MARKER-BASED NAVIGATION SYSTEMS AND METHODS FOR USE IN GNSS-DEPRIVED ENVIRONMENTS; U.S. Pat. No. 10,809,408, issued Oct. 20, 2020, entitled DUAL SENSED LOCATING SYSTEMS AND METHODS; U.S. Pat. No. 10,845,497, issued Nov. 24, 2020, entitled PHASE-SYNCHRONIZED BURIED OBJECT TRANSMITTER AND LOCATOR METHODS AND APPARATUS; U.S. Pat. No. 10,859,727, issued Dec. 8, 2020, entitled ELECTRONIC MARKER DEVICES AND SYSTEMS; U.S. Pat. No. 10,908,311, issued Feb. 2, 2021, entitled SELF-STANDING MULTI-LEG ATTACHMENT DEVICES FOR USE WITH UTILITY LOCATORS; U.S. Pat. No. 10,928,538, issued Feb. 23, 2021, entitled KEYED CURRENT SIGNAL LOCATING SYSTEMS AND METHODS; U.S. Pat. No. 10,935,686, issued Mar. 2, 2021, entitled UTILITY LOCATING SYSTEM WITH MOBILE BASE STATION; U.S. Pat. No. 10,955,583, issued Mar. 23, 2021, entitled BORING INSPECTION SYSTEMS AND METHODS; U.S. Pat. No. 10,983,239, issued Apr. 20, 2021, entitled MULTI-FREQUENCY LOCATING SYSTEMS AND METHODS; U.S. Pat. No. 10,983,240, issued Apr. 20, 2021, entitled MAGNETIC UTILITY LOCATOR DEVICE AND METHOD; U.S. Pat. No. 10,989,830, issued Apr. 27, 2021, entitled UTILITY LOCATOR APPARATUS AND SYSTEMS; U.S. Pat. No. 11,014,734, issued May 25, 2021, entitled MARKING PAINT APPLICATOR APPARATUS; U.S. Pat. No. 11,029,439, issued Jun. 8, 2021, entitled UTILITY LOCATOR APPARATUS, SYSTEMS, AND METHODS; U.S. Provisional Patent Application 63/212,713, filed Jun. 20, 2021, entitled DAYLIGHT VISIBLE AND MULTI-SPECTRAL LASER RANGEFINDERS AND ASSOCIATED METHODS AND UTILITY LOCATOR DEVICES; U.S. Pat. No. D922,885, issued Jun. 22, 2021, entitled BURIED UTILITY LOCATOR; U.S. patent application Ser. No. 17/379,867, filed Jul. 19, 2021, entitled LOCATING DEVICES, SYSTEMS, AND METHODS USING FREQUENCY SUITES FOR UTILITY DETECTION; U.S. patent application Ser. No. 17/382,040, filed Jul. 21, 2021, entitled VEHICLE-BASED UTILITY LOCATING USING PRINCIPAL COMPONENTS; U.S. Pat. No. 11,073,632, issued Jul. 27, 2021, entitled LOCATING DEVICES, SYSTEMS, AND METHODS USING FREQUENCY SUITES FOR UTILITY DETECTION; U.S. Pat. No. 11,092,712, issued Aug. 17, 2021, entitled UTILITY LOCATING SYSTEMS, DEVICES, AND METHODS USING RADIO BROADCAST SIGNALS; U.S. patent application Ser. No. 17/461,833, filed Aug. 30, 2021, entitled COMBINED SATELLITE NAVIGATION AND RADIO TRANSCEIVER ANTENNA DEVICES; U.S. patent application Ser. No. 17/467,435, filed Sep. 6, 2021, entitled TRACKABLE DIPOLE DEVICES, METHODS, AND SYSTEMS FOR USE WITH MARKING PAINT STICKS; U.S. patent application Ser. No. 17/467,438, filed Sep. 6, 2021, entitled SATELLITE AND MAGNETIC FIELD SONDE APPARATUS AND METHODS; U.S. Pat. No. 11,137,513, issued Oct. 5, 2021, entitled INDUCTIVE CLAMP DEVICES, SYSTEMS, AND METHODS; U.S. Pat. No. 11,146,892, issued Oct. 12, 2021, entitled MAGNETIC FIELD CANCELING AUDIO DEVICES; U.S. patent application Ser. No. 17/501,670, filed Oct. 14, 2021, entitled ELECTRONIC MARKER-BASED NAVIGATION SYSTEMS AND METHODS FOR USE IN GNSS-DEPRIVED ENVIRONMENTS; U.S. Pat. No. 11,156,737, issued Oct. 26, 2021, entitled BURIED OBJECT LOCATOR APPARATUS AND METHODS; U.S. Pat. No. 11,171,369, issued Nov. 9, 2021, entitled MODULAR BATTERY PACK APPARATUS, SYSTEMS, AND METHODS; U.S. patent application Ser. No. 17/522,857, filed Nov. 9, 2021, entitled WIRELESS BURIED PIPE AND CABLE LOCATING SYSTEMS; U.S. patent application Ser. No. 17/523,857, filed Nov. 10, 2021, entitled SONDE DEVICES INCLUDING A SECTIONAL FERRITE CORE STRUCTURE; U.S. Pat. No. 11,175,427, issued Nov. 16, 2021, entitled BURIED UTILITY LOCATING SYSTEMS WITH OPTIMIZED WIRELESS DATA COMMUNICATION; U.S. patent application Ser. No. 17/531,533, filed Nov. 19, 2021, entitled INPUT MULTIPLEXED SIGNAL PROCESSING APPARATUS AND METHODS; U.S. patent application Ser. No. 17/540,239, filed Dec. 1, 2021, entitled DUAL SENSED LOCATING SYSTEMS AND METHODS; U.S. patent application Ser. No. 17/541,057, filed Dec. 2, 2021, entitled COLOR-INDEPENDENT MARKER DEVICE APPARATUS, SYSTEMS, AND METHODS; U.S. patent application Ser. No. 17/540,231, filed Dec. 2, 2021, entitled AUTO-TUNING CIRCUIT APPARATUS AND METHODS; U.S. Pat. No. 11,193,767, issued Dec. 7, 2021, entitled SMART PAINT STICK DEVICES AND METHODS; U.S. Pat. No. 11,199,521, issued Dec. 14, 2021, entitled RESILIENTLY DEFORMABLE MAGNETIC FIELD CORE APPARATUS AND APPLICATIONS; U.S. Pat. No. 11,204,246, issued Dec. 21, 2021, entitled DUAL SENSED LOCATING SYSTEMS AND METHODS; U.S. Provisional Patent Application 63/293,828, filed Dec. 26, 2021, entitled MODULAR BATTERY SYSTEMS INCLUDING BATTERY INTERFACE APPARATUS; U.S. patent application Ser. No. 17/563,049, filed Dec. 28, 2021, entitled SONDE DEVICES WITH A SECTIONAL FERRITE CORE; U.S. Provisional Patent Application 63/306,088, filed Feb. 2, 2022, entitled UTILITY LOCATING SYSTEMS AND METHODS WITH FILTER TUNING FOR POWER GRID FLUCTUATIONS; U.S. patent application Ser. No. 17/687,538, filed Mar. 4, 2022, entitled ANTENNAS, MULTI-ANTENNA APPARATUS, AND ANTENNA HOUSINGS; U.S. patent application Ser. No. 17/694,640, filed Mar. 14, 2022, entitled UTILITY LOCATORS WITH RETRACTABLE SUPPORT STRUCTURES AND APPLICATIONS THEREOF; U.S. patent application Ser. No. 17/694,656, filed Mar. 14, 2022, entitled ELECTROMAGNETIC MARKER DEVICES FOR BURIED OR HIDDEN USE; U.S. Pat. No. 11,280,934, issued Mar. 22, 2022, entitled ELECTROMAGNETIC MARKER DEVICES FOR BURIED OR HIDDEN USE; U.S. Pat. No. 11,300,597, issued Apr. 12, 2022, entitled SYSTEMS AND METHODS FOR LOCATING AND/OR MAPPING BURIED UTILITIES USING VEHICLE-MOUNTED LOCATING DEVICES; U.S. Pat. No. 11,300,700, issued Apr. 12, 2022, entitled SYSTEMS AND METHODS OF USING A SONDE DEVICE WITH A SECTIONAL FERRITE CORE STRUCTURE; U.S. Pat. No. 11,300,701, issued Apr. 12, 2022, entitled UTILITY LOCATORS WITH RETRACTABLE SUPPORT STRUCTURES; U.S. patent application Ser. No. 17/728,949, filed Apr. 25, 2022, entitled BURIED UTILITY LOCATOR GROUND TRACKING APPARATUS, SYSTEMS, AND METHODS; U.S. patent application Ser. No. 17/731,579, filed Apr. 28, 2022, entitled BURIED UTILITY MARKER DEVICES, SYSTEMS, AND METHODS; and U.S. Pat. No. 11,333,786, issued May 17, 2022, entitled BURIED UTILITY MARKER DEVICES, SYSTEMS, AND METHODS. The content of each of the above-described patents and applications is incorporated by reference herein in its entirety. The above applications may be collectively denoted herein as the “co-assigned applications” or “incorporated applications.”

In one aspect, the disclosure relates to a daylight visible laser rangefinder. The daylight visible laser rangefinder may include a laser element emitting a daylight visible continuous wave laser modulated at a known frequency or frequencies. The daylight visible laser rangefinder may further include a receiver element to receive a reflected light input generated by reflection of the emitted laser off a target. Such a receiver element may include a sensing element having one or more avalanche photodiodes, avalanche photodiode arrays, silicon photomultipliers (SiPM), and/or like photodetector sensors for receiving the reflected light input and generating a corresponding electrical input signal. The SiPM may, in some embodiments, be or include the MICROFC-10010 SiPM publically available from ON Semiconductor®. The receiver element may further include a gain control element to vary the gain of the sensing element. The daylight visible laser rangefinder may further include a phase detector to measure the phase of emitted lasers and input signals. A processing element may be included having one or more processors to calculate phase differences between the emitted laser and input signals received by the receiver element in determining distance measurements. Such distance measurements, as well as instructions relating to generating such distance measurements, may be stored in a memory element having one or more non-transitory memories. The daylight visible laser rangefinder may further include a housing element to encapsulate or partially encapsulate the various laser rangefinder elements, isolate the receiver element from light sources other than the reflected light input to the extent possible, and further having one or more windows or other openings such that the emitted laser and reflected light input may travel between rangefinder laser element/receiver element and the external environment. In some embodiments, the housing may be waterproof wherein the daylight visible laser rangefinder may be used in an underwater environment. A power element may further be included for portioning of electrical power to the various powered elements of the daylight visible laser rangefinder.

In another aspect, the laser element of the daylight visible laser rangefinders of the present disclosure may include and emit multiple lasers. Such embodiments may include a plurality of receiver elements such that each laser may include a corresponding receiver element. In some such embodiments, the plurality of lasers may each operate at different wavelengths.

In another aspect, the disclosure relates to a multi-spectral laser rangefinder. The multi-spectral laser rangefinder may include a plurality of laser elements each emitting a continuous wave laser modulated at a known frequency or frequencies and operating at different wavelengths. At least one laser may be at a daylight visible wavelength. The multi-spectral laser rangefinder may further include a plurality of receiver elements such that one receiver element corresponds to one laser element. Each receiver element may receive reflected light input generated by reflection of the emitted laser from its corresponding laser element off a target. Each receiver element may include a sensing element having one or more avalanche photodiodes, avalanche photodiode arrays, silicon photomultipliers (SiPM), and/or like photodetector sensors for receiving the reflected light input of the corresponding laser element and generating corresponding electrical input signals. The SiPM may, in some embodiments, be or include the MICROFC-10010 SiPM publically available from ON Semiconductor®. The receiver element may further include a gain control element to vary the gain of the sensing element. A phase detector may measure the phase of each emitted laser and each of the corresponding input signal. A processing element may be included having one or more processors to calculate phase differences between the emitted lasers and input signals received in determining distance measurements. In some embodiments, temperature, ambient light levels, gain levels, waveform amplitude or shape may be factored into adjusting distance measurements. Such distance measurements, as well as instructions relating to generating such distance measurement, may be stored in a memory element having one or more non-transitory memories. The multi-spectral laser rangefinder may further include a housing element to encapsulate or partially encapsulate the various multi-spectral laser rangefinder elements, isolate the receiver element from light sources other than the reflected light input to the extent possible, and further having one or more windows or other openings such that the emitted laser and reflected light input may travel between rangefinder laser elements/receiver elements and the external environment. In some embodiments, the housing may be waterproof wherein the multi-spectral laser rangefinder may be used in an underwater environment. A power element may further be included for portioning of electrical power to the various powered elements of the multi-spectral laser rangefinder.

In another aspect the laser rangefinders of the present disclosure, which may be a daylight visible laser range finder or multi-spectral laser rangefinder as described herein, may further include one or more bandpass filters.

In another aspect the laser rangefinders of the present disclosure, which may be a daylight visible laser range finder or multi-spectral laser rangefinder as described herein, may include a housing element made of or including carbon-fiber filled injection moldable plastic. For instance, the housing element may be or include portions made from Ultem™ filaments publically available from SABIC Global Technologies or like materials for blocking ambient light from the receiver element to the extent possible and may have like low coefficient of thermal expansion.

In another aspect the laser rangefinders of the present disclosure, which may be a daylight visible laser range finder or multi-spectral laser rangefinder as described herein, may include square windows adhered or otherwise secured to the inside or outside of the housing elements. In some embodiments, the optical windows are or include alkali-aluminosilicate sheet glass. The windows may optionally be chemically strengthened.

In another aspect the laser rangefinders of the present disclosure, which may be a daylight visible laser range finder or multi-spectral laser rangefinder as described herein, wherein at least one laser element emits a green or other daylight visible laser.

In another aspect the laser rangefinders of the present disclosure, which may be a daylight visible laser range finder or multi-spectral laser rangefinder as described herein, may further be included in a utility locator device configured to determine and/or map utility line positions. In some such embodiments, the utility locator device may include one or more cameras to generate images of the ground surface or other distance measurement target of the laser rangefinder. The laser dot may optionally be visible in the camera image(s).

In another aspect, the laser rangefinders, which may be a daylight visible laser range finder or multi-spectral laser rangefinder as described herein, may further include one or more user input controls (e.g., buttons, touchscreen, or like user input ability). Likewise, the laser rangefinders of the present disclosure, including multi-spectral continuous wave laser rangefinders, may include a user interface to communicate distance measurements to a user (e.g., graphical user interface, audio speakers, or the like).

In another aspect, the laser rangefinders of the present disclosure, which may be a daylight visible laser range finder or multi-spectral laser rangefinder as described herein, may further include a temperature sensor to measure the ambient temperature of the environment, lasers, and/or associated circuitry. In such embodiments temperature measurements may factor in calculating distance measurements.

In another aspect, the laser rangefinders of the present disclosure, which may be a daylight visible laser range finder or multi-spectral laser rangefinder as described herein, may include a gain control element wherein the gain control element adjusts the bias voltage to the sensing element to control the gain of the sensing element. In yet other embodiments, the sensing element may include a signal amplifier (e.g., a transimpedance amplifier or the like) for amplifying input signals. In some such embodiments, the gain control element may vary the gain of the signal amplifier to control the gain of the sensing element. For example, the gain control element may be or include a programmable gain amplifier.

In another aspect, the present disclosure relates to a utility locator device including a laser rangefinder (also referred to herein as “range finding utility locator device” or simply “utility locator device”) of the present invention which may be one of the daylight visible laser rangefinders or multi-spectral laser rangefinders described herein. The range finding utility locator device may include a locator subsystem having one or more antennas and associated receiver circuitry to receive magnetic signals emitted by utility lines which may be buried in the ground. A user interface and input element may receive input commands from a user and further communicate data relating to utility line positions, distance measurements, mapping information, and information related to distance measurements, utility line positions, and mapping information to a user. The range finding utility locator device may include a laser rangefinder of the present invention (e.g., the daylight visible laser rangefinders or multi-spectral laser rangefinders described herein). A processing element may be included having one or more processors to carry out methods associated with determining positions of utility lines based on the magnetic signals and to further calculate phase differences between the emitted lasers and corresponding ones of the reflected light inputs in determining distance measurements. A memory element may be included in a range finding utility locator device having one or more non-transitory memories to store instructions relating to determining utility line positions and resulting positions as well as for storing instructions relating to calculating of distance measurements and the resulting calculated distance measurements. The range finding utility locator device may include a housing element to encase electronics and other components associated with utility locator device elements and included laser rangefinder. A power element may further be included for portioning of electrical power to the various powered elements of range finding utility locator device.

In another aspect, the range finding utility locator device embodiments of the present disclosure may further include one or more cameras for generating images of the ground surface or other distance measurement target of the laser rangefinder.

In another aspect, the range finding utility locator device embodiments of the present disclosure may further include one or more global navigation satellite systems (GNSS) and/or inertial navigation systems (INS) to resolve position, orientation, and pose for the range finding utility locator device.

In another aspect, the present disclosure includes a method as described correlating data of range finding utility locator devices of the present disclosure. The method may include a range finding utility locator device determining positions/orientation of utility line(s) relative to range finding utility locator device and determining geolocation/orientation/pose data for range finding utility locator device. The method may further include the laser rangefinder of the range finding utility locator device determining distance measurement to a target. The laser rangefinder target may optionally be electronically tagged. The tag may be a designation given to laser rangefinder targets that may have particular significance. Such a tag may generally include a geolocation or other position as well as user input and/or other data included in a data set associated with the tag. Such data sets and associated tags may be stored in a memory element having one or more non-transitory memories that is stored by the laser rangefinder and/or host device. Optionally, camera(s) of the range finding utility locator device may generate image(s) that include the laser rangefinder target. Position(s)/orientation(s) of utility line(s) relative to utility locator device, the geolocation/orientation/pose data for utility locator device, distance measurement to a target, and optional image(s) may be correlated to resolve positions of each in the world frame. The correlated data may further be correlated with an electronic map of the area. Correlated data may be stored in a memory element having one or more non-transitory memories. In an optional step, correlated data and/or maps may be displayed on an electronic display.

In another aspect, the present disclosure relates to a method for determining distance measurements via a laser rangefinder of the present invention. The method may include emitting one or more continuous wave lasers modulated at a known frequency or frequencies. One emitted laser may be a daylight visible laser. The emitted laser(s) may contact a target and reflect light generating “reflected light input(s).” In an optional step, out of band light may be filtered out at the receiver element. In another step, reflected light input(s) may be received at sensing element(s) in the receiver element(s) that may include one or more avalanche photodiodes, avalanche photodiode arrays, silicon photomultipliers (SiPM), and/or like photodetector sensors. The SiPM may, in some embodiments, be or include the MICROFC-10010 SiPM publically available from ON Semiconductor®. In another step, the gain of a sensing element may be adjusted to achieve appropriate amplitude levels. In another step, input signal(s) corresponding to the reflected light input(s) may be generated. In another step, the phase(s) of emitted laser(s) and input signal(s) may be measured. In another step, the measured phases of each emitted laser and corresponding input signal may be compared. In another step, distance measurement(s) may be calculated based on differences in measured phases of each emitted laser and corresponding input signal. In an optional step, calculated distance measurements may be adjusted based on ambient light level, signal noise, gain settings, waveform shape(s) and/or amplitude(s) of the input signal(s). In an optional step wherein multiple distance measurements are calculated, the multiple distance measurements may be evaluated to select or otherwise determine a single calculated distance measurement. For instance, in some embodiments an average or weighted average may be calculated. The weighted average may, for example, be based on potential error or another quality/confidence metric or based on other contributing information influencing the distance measurement. In some embodiments, a method may be used to evaluate distance measurements. In yet further embodiments, all distance measurements may be used. In another step, distance measurement(s) and/or associated information may be stored in a memory element having one or more non-transitory memories. In another step, distance measurement(s) and/or associated information may be communicated to a use and/or other device(s).

In another aspect, the present disclosure includes a method for evaluating multiple distance measurements. The method may include generating multiple distance measurements and sorting measurements based on whether they meet a variance threshold. As used herein, the term “variance threshold” may refer to a range of distance measurements wherein distance measurements that fall outside the acceptable range may indicate an invalid or incorrect distance measurement due to some error. The variance threshold may, for instance, be a percentage difference between distance measurements, a maximum or minimum in difference in total distance measurement, or other like metric. The distance measurements meeting the variance threshold may, in some embodiments, be used. For instance, distance measurements meeting the variance threshold may be averaged or have a weighted average applied thereto in the calculation of a singular distance measurement. In some embodiments, all distance measurements that meet the variance threshold may be used. Optionally, the valid distance measurement(s) and/or associated information may be displayed on a user interface. The valid distance measurement(s) and/or associated information may be stored on a memory element having one or more non-transitory memories. Distance measurements that do not meet the variance threshold may be invalid and may identify potential problems with distance measurements. Optionally, invalid distance measurements may be interpreted to identify additional information regarding the target (e.g., the presence of fluorescence in the target or the like). Optionally, the targets associated with invalid distance measurements may be electronically tagged (referring to a designation given to laser rangefinder targets that may have particular significance at the target geolocation). For instance, such an electronic tag may designate the target as having fluorescence or being associated with a distance measurement problem or the like. Optionally, the invalid distance measurements, interpreted information, associated tag, and/or other associated information may be displayed on a user interface device. In another optional step, the method may include storing invalid distance measurements, interpreted information, associated tag, and/or other associated information which may be stored in a memory element having one or more non-transitory memories.

In another aspect, the present disclosure relates to a method for manufacturing optical windows. The method may include scoring polygonal shapes into a sheet of optical window material, breaking each optical window defined by the scored window shape away from the scored sheet of optical window material, and applying adhesive to each optical window for securing to a port or other opening. In an optional step, the method may include deburring or otherwise smoothing the edges of the optical window prior to the application of the adhesive. Likewise, the method may include optional steps for applying bandpass filter coating and/or chemically strengthening the optical windows. In some embodiments, the optical window material may be or includes alkali-aluminosilicate sheet glass. Likewise, the adhesive may be 3M™ VHB™ tape or other very high or ultra-high bond tape. In some embodiments, the polygonal shapes scored into the sheet of optical window material may be squares.

In another aspect, the present disclosure may include a method for determining the depth of a utility line relative to the ground surface. The method may include determining positions/orientations of utility line(s) relative to a range finding utility locator device that includes a depth measurement of each utility line relative to the sense antennas in the range finding utility locator device, determining the geolocation and orientation/pose of the range finding utility locator device, and determining distance measurement(s) to a target via a laser rangefinder in the range finding utility locator device. The method may further include calculating the height of the laser rangefinder in the range finding utility locator device from the ground surface, determining the height of the laser rangefinder relative to the sense antennas in the range finding utility locator device, calculating the height of the sense antennas from the ground surface, and calculating the depth of the utility line(s) relative to the ground surface. The depth(s) relative to the ground surface at the geolocation and associated information may be stored in a memory element having one or more non-transitory memories. Optionally, the depth(s) of the utility line(s) relative to the ground surface and associated information may be displayed on a user interface.

In another aspect, the present disclosure may include a method for determining fluorescence in a target via a multi-spectral laser rangefinder. The method may include determining distance measurements to the same target via a multi-spectral laser rangefinder (e.g., a green laser) having one laser element emitting a substantially fluorescent excitation wavelength laser and another laser element emitting a substantially non-fluorescent excitation wavelength laser (e.g., a red laser), determining if the distance measurements agree to within a predetermined threshold, and detecting fluorescence wherein distance measurements do not agree to within the predetermined threshold and the fluorescent excitation wavelength laser is in error. The method may further include storing fluorescent designations for targets and/or associated information in a memory element having one or more non-transitory memory elements. Optionally, the fluorescent designation and associated information may be displayed on a user interface. In some embodiments, the fluorescent targets may be electronically tagged to notate significance of the fluorescent target at the corresponding geolocation. It should be noted that though a red laser is provided as a “non-fluorescent excitation wavelength laser,” in use a red laser may result in some fluorescent excitation though, in most applications, less so than the exemplary green laser.

In another aspect, the present disclosure may include a method for determining the color of a target via a multi-spectral laser rangefinder. The method may include emitting two or more lasers at different known wavelengths at a target via a multi-spectral laser rangefinder, receiving reflected light input from each laser contacting the target, adjusting the gain to a sensing element, determining a reflected values data set (e.g., including measures of phase, amplitudes of received reflected light input, gain levels, frequencies, or other attributes of the reflected light inputs) for each reflected light input that may include various attributes of the reflected light input, and determining the color of the target based on reflected values via statistical modeling correlating color to particular reflected values data sets or ratios of reflected value data sets between reflected light inputs. The method may further include storing the color and/or associated information in a memory element having one or more non-transitory memories. Optionally, the color and/or associated information may be displayed via a user interface.

In another aspect, the present disclosure may include a method for determining the surface material of an area scanned via a multi-spectral laser rangefinder. The method may include determining target colors and associated reflected value data sets (e.g., including measures of phase, amplitudes of received reflected light input, gain levels, frequencies, or other attributes of the reflected light inputs) for a plurality of targets via a multi-spectral laser rangefinder moved about an area, grouping targets based on the time in which target is sampled, positional relationships between targets, and/or similarities in reflected value data sets, determining average colors for each group, and determining the surface material from the average colors of the group. The method may further include storing surface materials and/or associated information in a memory element having one or more non-transitory memories. Optionally, the surface material and/or associated information may be displayed via a user interface.

In another aspect, the present disclosure includes a method for focusing cameras via a laser rangefinder of the present disclosure. The method may including a laser rangefinder of the present disclosure that further includes or couples to one or more cameras for generating images of a target to determine distance measurement(s) to the target, using the calculated distance measurement to focus the camera(s), generating one or more images that include the target, and storing the distance measurement(s), image(s), and/or associated information on a memory element having one or more non-transitory memories. Optionally, the method may further include displaying the distance measurement(s), image(s), and/or associated information on a user interface.

In another aspect, the present disclosure includes a method for navigating underwater environments using a laser rangefinder of the present disclosure. The method may include determining one or more distance measurements via a laser rangefinder of the present disclosure, determining whether the distance measurement(s) fall inside a predetermined threshold, and moving the underwater vehicle when the distance measurement(s) do not fall inside the predetermined threshold or detecting a potential impending collision when the distance measurement(s) do fall inside the predetermined threshold. Where a potential impending collision has been detected, an alert may notify a user/operator and/or the movement of the underwater vehicle may be halted or redirected. Optionally, the position information of the underwater vehicle may be updated via distance measurements. The distance measurement(s), position, and/or associated information may optionally be displayed in a user interface and/or stored on a memory element having one or more non-transitory memories.

In another aspect, the present disclosure may include a method for characterizing the seafloor using a multi-spectral underwater laser rangefinder of the present disclosure. The method may include emitting two or more lasers at a target using a multi-spectral underwater laser rangefinder, generating reflected light inputs from emitted lasers contacting and reflecting off the target, receiving reflected light inputs at the sensing element of corresponding receiver elements wherein the gain to the sensing element is controlled to compensate for attenuated amplitudes of the received reflected light inputs, and determining a reflected values data set for each reflected light input that may include various attributes of the reflected light inputs. The method may further include determining the color of the target based on reflected values via statistical modeling correlating color to particular reflected values data sets or ratios of reflected value data sets between reflected light inputs, storing the color and/or associated information in a memory element having one or more non-transitory memories, and repeating the aforementioned steps to determine the color and/or associated information for a plurality of targets. The method may further include grouping targets based on the time in which the target is sampled, positional relationships between targets, and/or similarities in reflected value data sets, determining the average color for each group, determining the characterization of the seafloor for each group based on average color, and storing the seafloor characterizations and/or associated information in a memory element having one or more non-transitory memories. Optionally, the method may further include displaying the seafloor characterizations and/or associated information on a user interface.

In another aspect, the present invention may include a method for detecting leaks in underwater pipes using an underwater laser rangefinder of the present disclosure. The method may include injecting or including dye in an underwater pipe, selecting a target and determining distance measurements along the underwater pipe using an underwater laser rangefinder, and determining, for each distance measurement, whether the distance varies outside a predetermined threshold. The method may further include detecting leaks wherein the distance measurement varies outside the predetermined threshold or no leak wherein the distance measurement does not vary outside the predetermined threshold and storing leak information associated with the target location along the pipe and/or distance measurements and/or other associated information in a memory element having one or more non-transitory memory elements. Optionally, the method may include displaying the leak information associated with the target location along the pipe and/or distance measurements and/or other associated information on a user interface.

In another aspect, the present disclosure may include a combined underwater scaling and range finding device. The combined underwater scaling and range finding device may include a laser scaling apparatus for determining the scale of underwater objects further including at least two scaling lasers at a known distance apart for emitting lasers at a target, a camera for generating one or more images of the target and laser contact points, a processing element having one or more processors to determine a measurement of scale from the image(s) containing the laser contact points, and a memory element having one or more non-transitory memories to store the scale measurement and associated information. The combined underwater scaling and range finding device may further include a laser rangefinder of the present invention configured for underwater use to determine one or more distance measurements to the same target. The laser rangefinder may be a daylight visible laser rangefinder or multi-spectral laser rangefinder of the present disclosure. In some embodiments, the combined underwater scaling and range finding device may couple to or be included in an underwater vehicle or other host device.

In another aspect, the present disclosure may include a method for generating scale and distance measurements of a target via a combined underwater scaling and range finding device of the present disclosure. The method may include using a laser rangefinder to emit one or more lasers at a target and determining one or more distance measurements to the target from reflected light input(s). The method may further include using a laser scaling apparatus to emit lasers from a pair of parallel scaling lasers having a known distance apart at the same target, generating one or more images of the target area that includes laser contacts from the camera of the laser scaling apparatus, and determining a scaling measurement from the image(s) of the target including the scaling lasers. Optionally, the scaling measurement may be refined using the determined distance measurement(s). The method may further include storing the scaling measurement, distance measurement(s), image(s), and/or associated information in a memory element having one or more non-transitory memories. Optionally, the method may include displaying the scaling measurement, distance measurement(s), image(s), and/or associated information on a user interface.

### EXAMPLE EMBODIMENTS

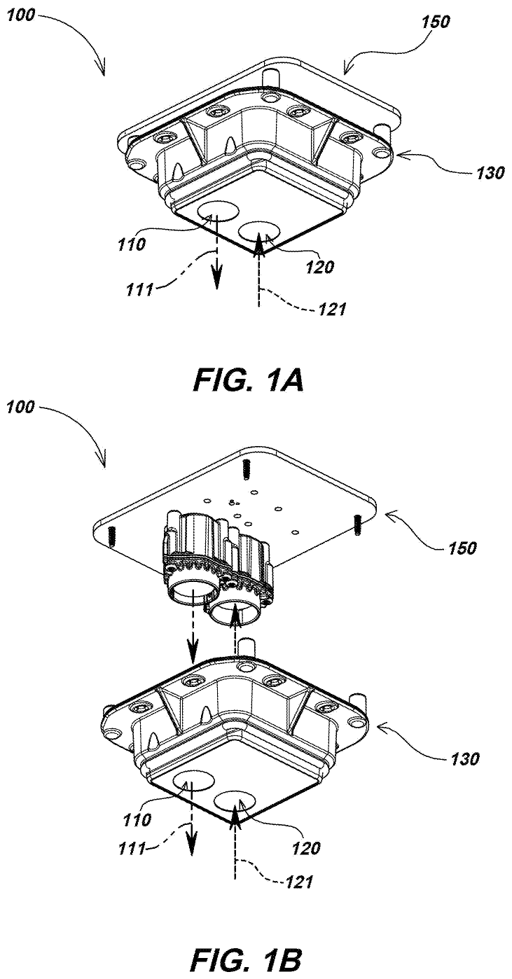

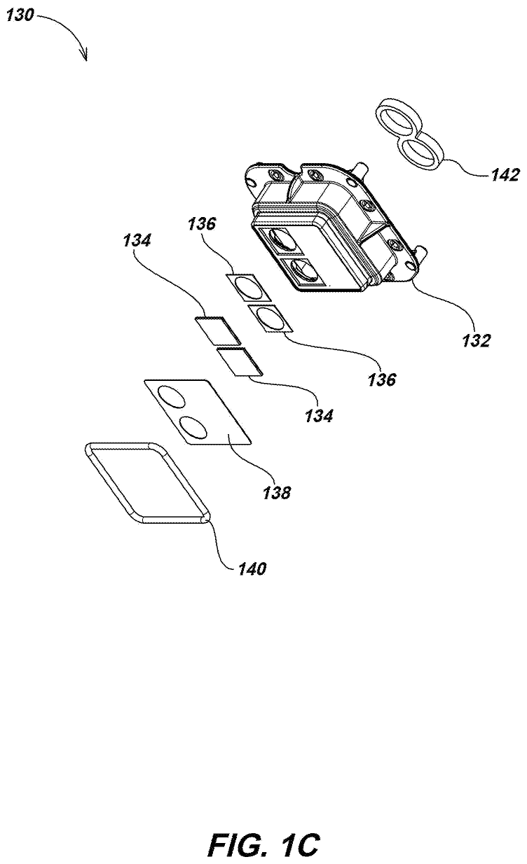

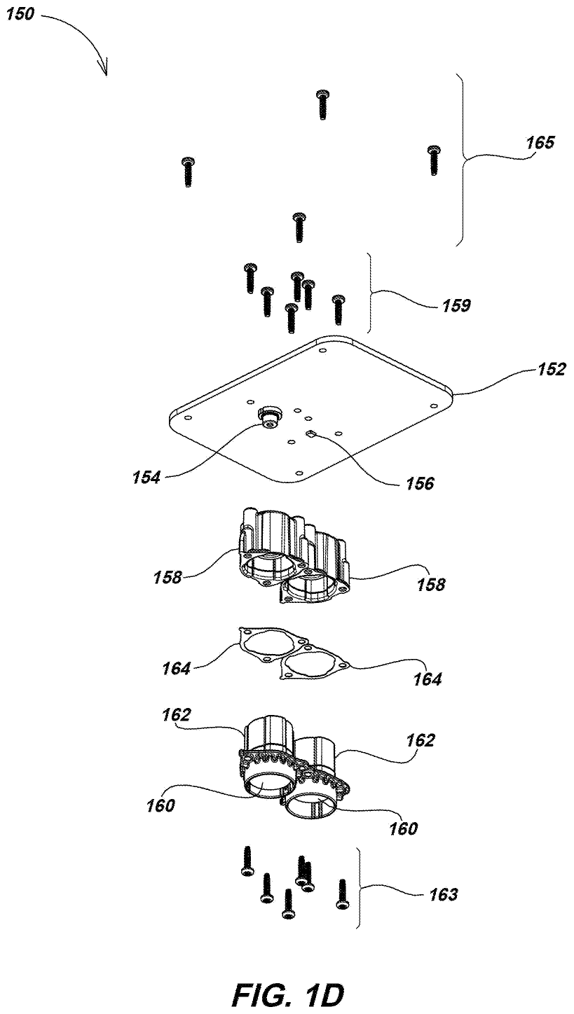

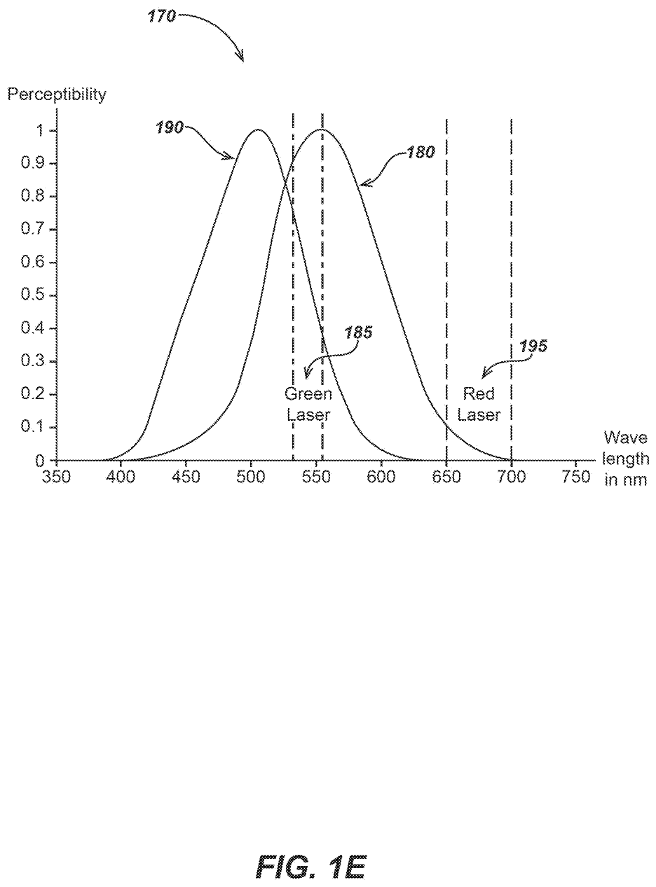

Various additional aspects, features, and functions are described below in conjunction with the embodiments shown in FIG. 1A through FIG. 26 of the appended Drawings.

It is noted that as used herein, the term, “exemplary” means “serving as an example, instance, or illustration.” Any aspect, detail, function, implementation, and/or embodiment described herein as “exemplary” is not necessarily to be construed as preferred or advantageous over other aspects and/or embodiments unless specifically described as such.

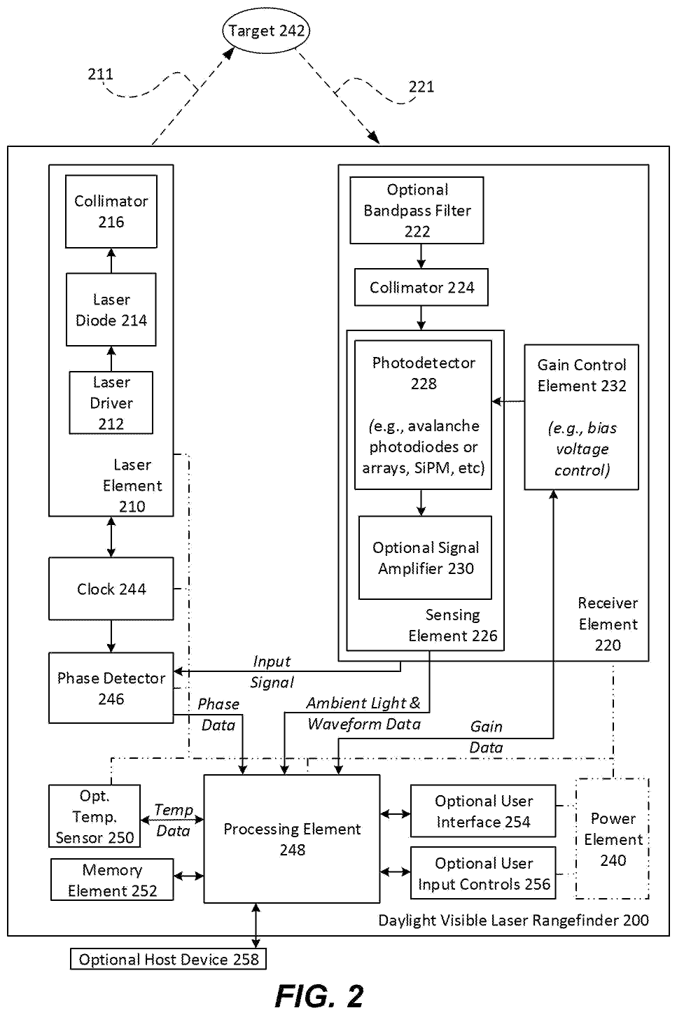

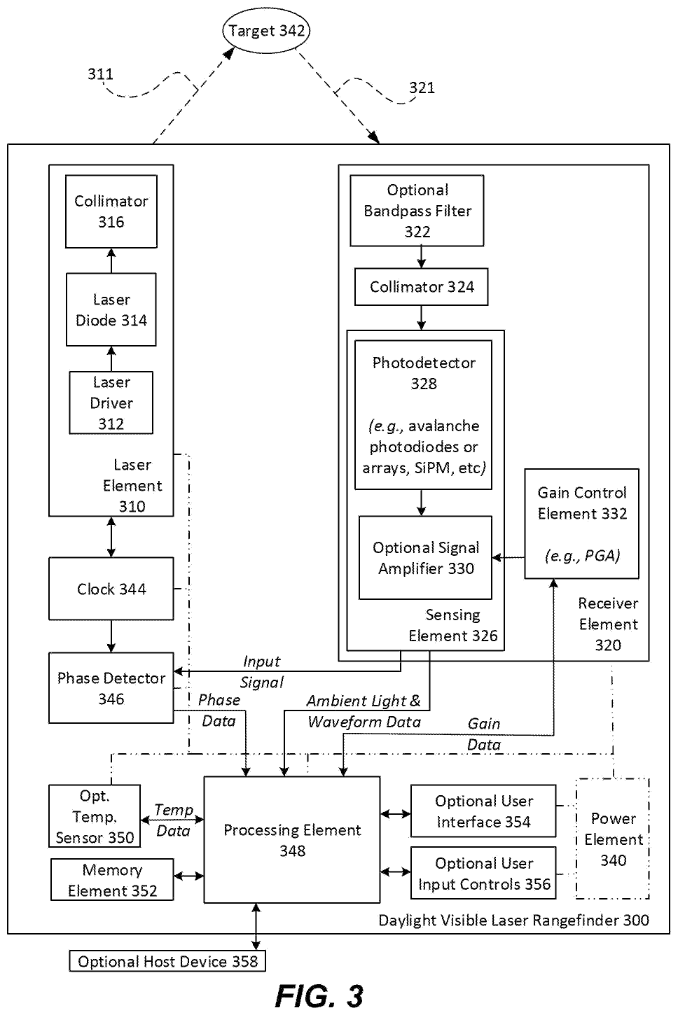

Turning to FIGS. 1A and 1B, a daylight visible laser rangefinder module 100 is illustrated having a laser element 110 that, in use, may emit a daylight visible continuous wave laser (the daylight visible continuous wave laser may be understood as operating at a “daylight visible” wavelength as defined herein and further described in conjunction with FIG. 1E), such as an emitted laser 111, modulated at one or more known frequencies. The daylight visible laser rangefinder module 100 may further include a receiver element 120 aligned to receive reflected light, referred to herein as “reflected light input,” such as a reflected light input 121 generated by reflection of the emitted laser 111 striking a target (e.g., target 242 of FIG. 2 or target 342 of FIG. 3) for the purpose of generating a distance measurement to that target. It should be noted that the reflected light input may generally include some measure of ambient light. In various embodiments herein the target may be the ground surface or other object by which a daylight visible laser rangefinder embodiment, such as the daylight visible laser rangefinder module 100, may be aimed at for purposes of measuring the distance between the daylight visible laser rangefinder embodiment and a target. As illustrated in FIG. 1A and FIG. 1B, the daylight visible laser rangefinder module 100 may include a front housing subassembly 130 that may couple to a rangefinder subassembly 150 (best illustrated in FIG. 1B) in assembly.

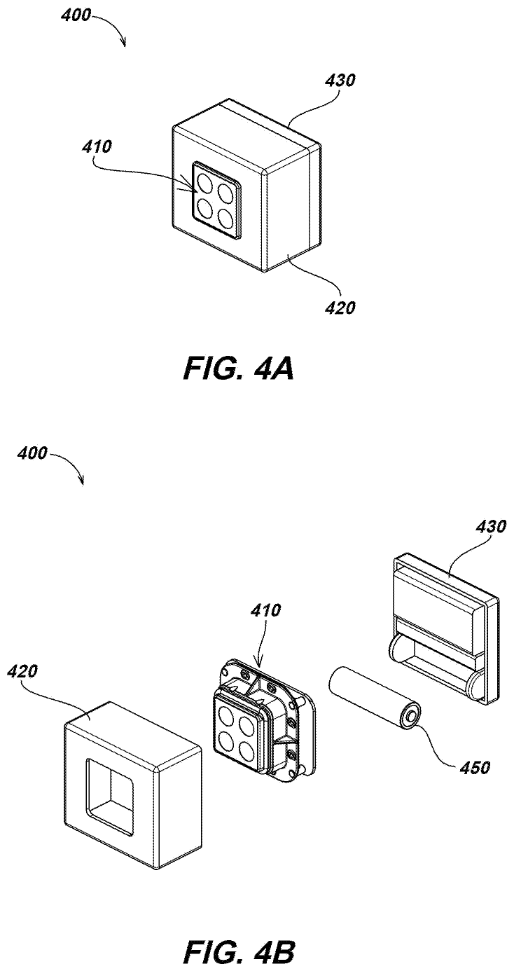

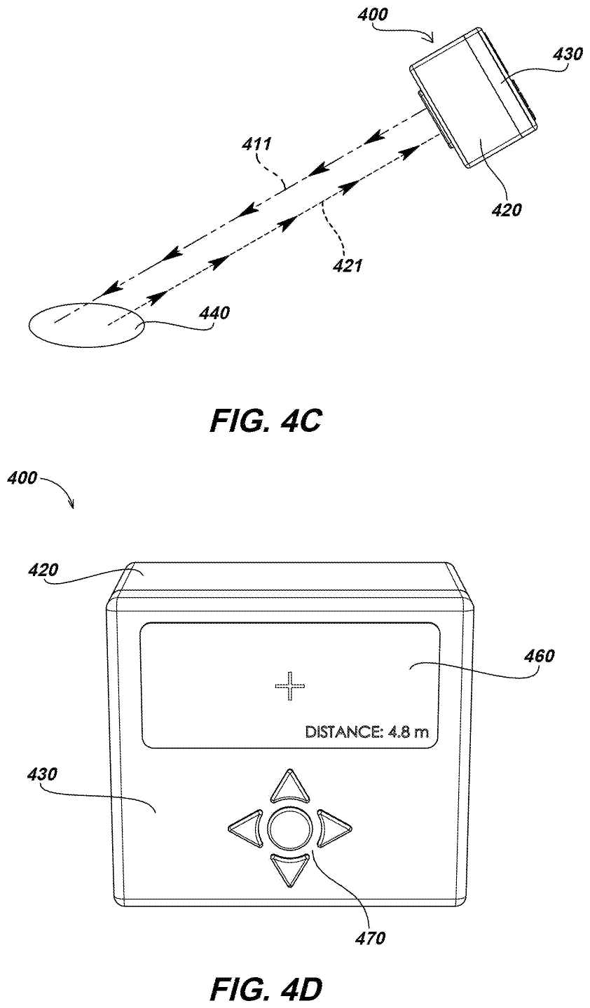

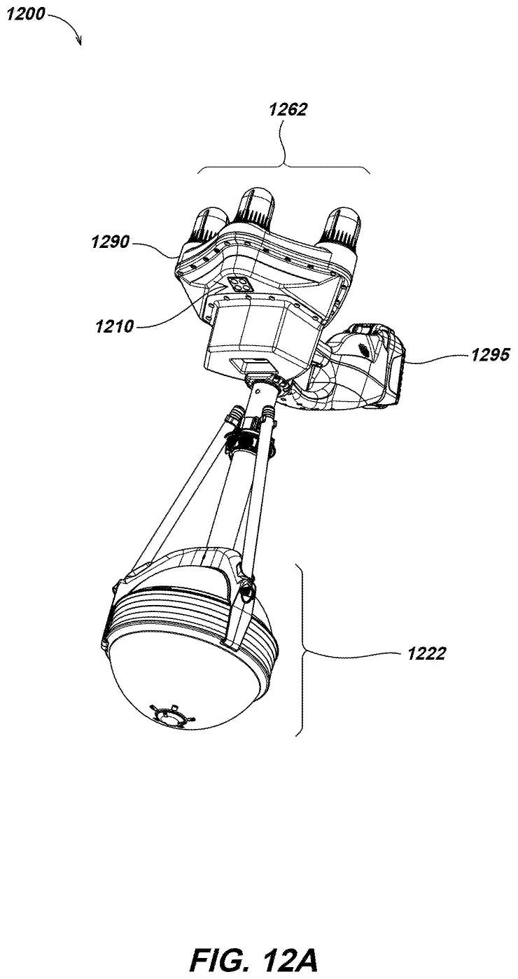

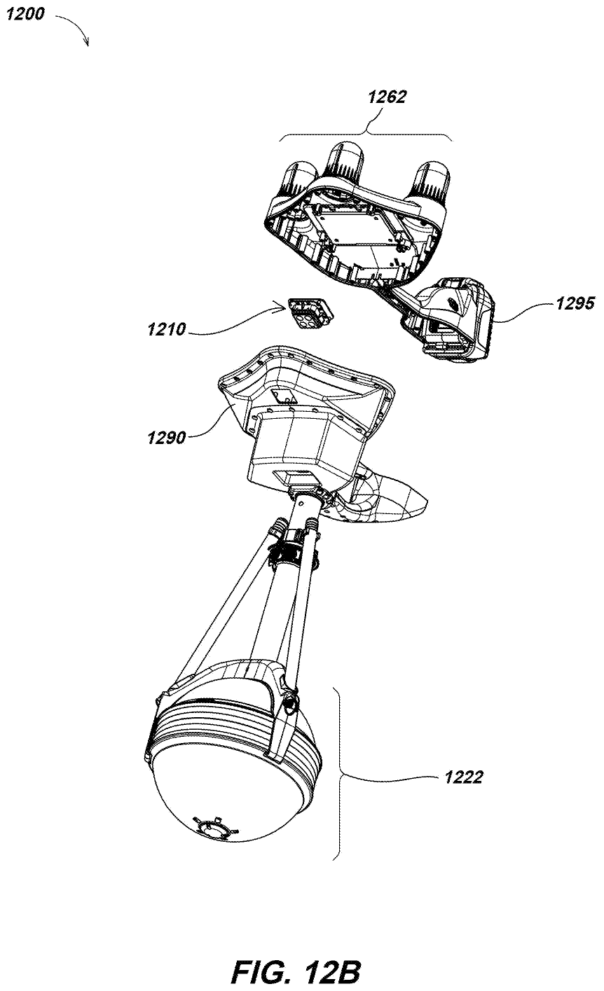

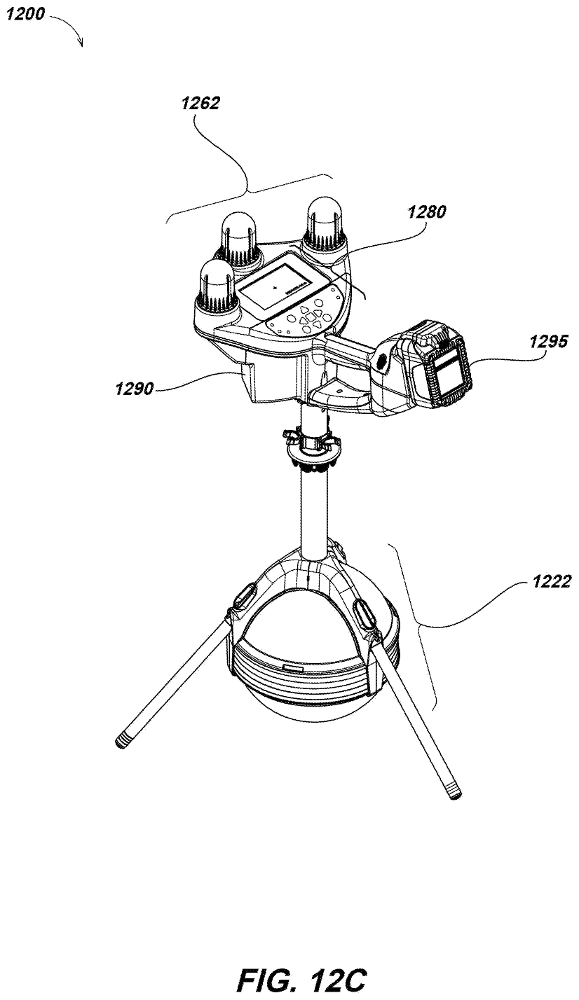

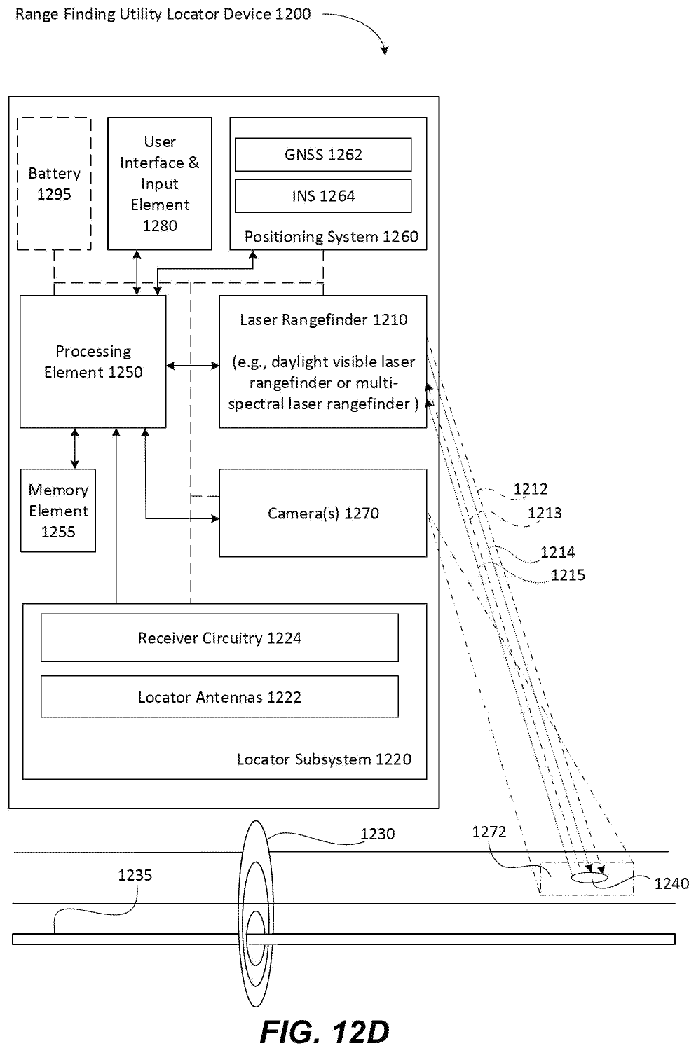

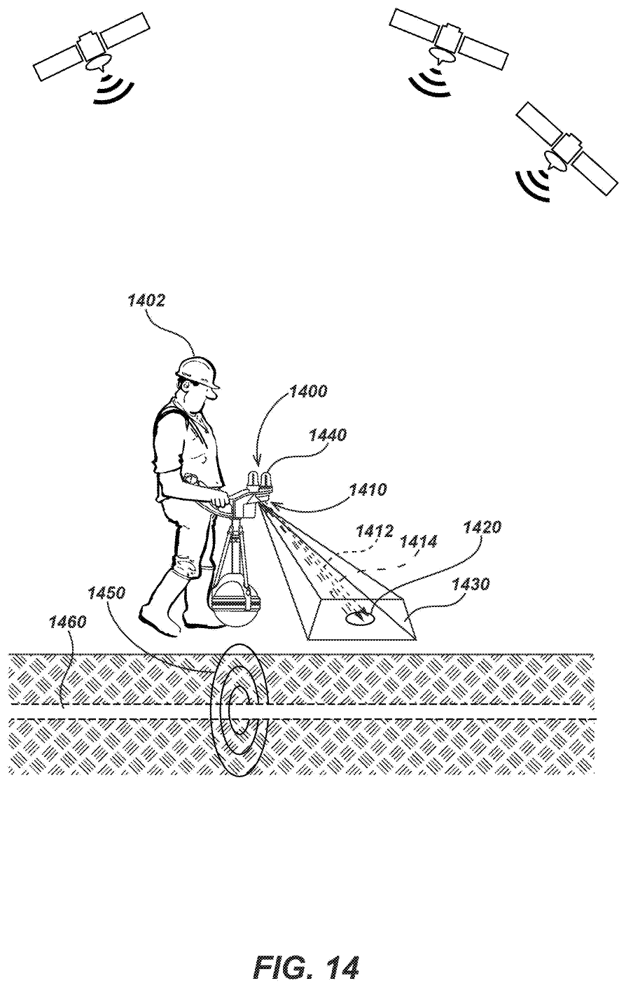

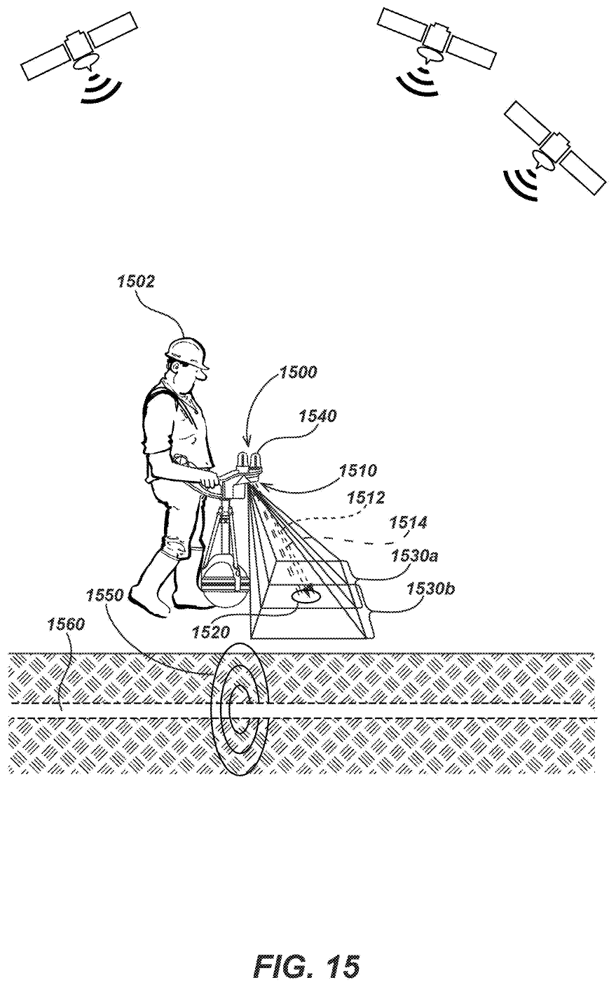

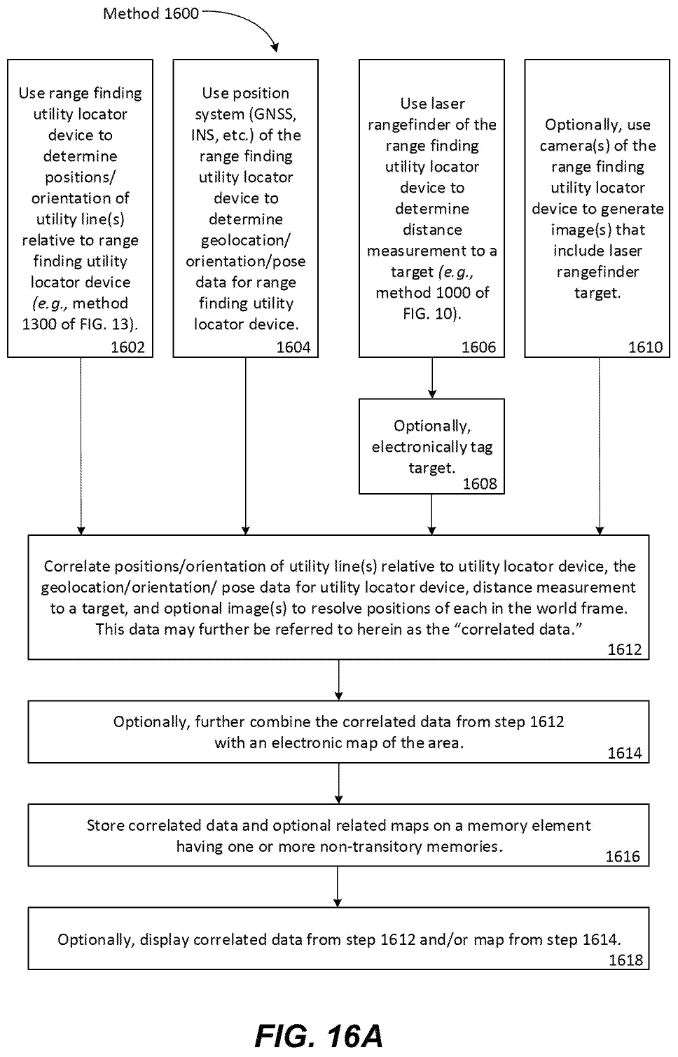

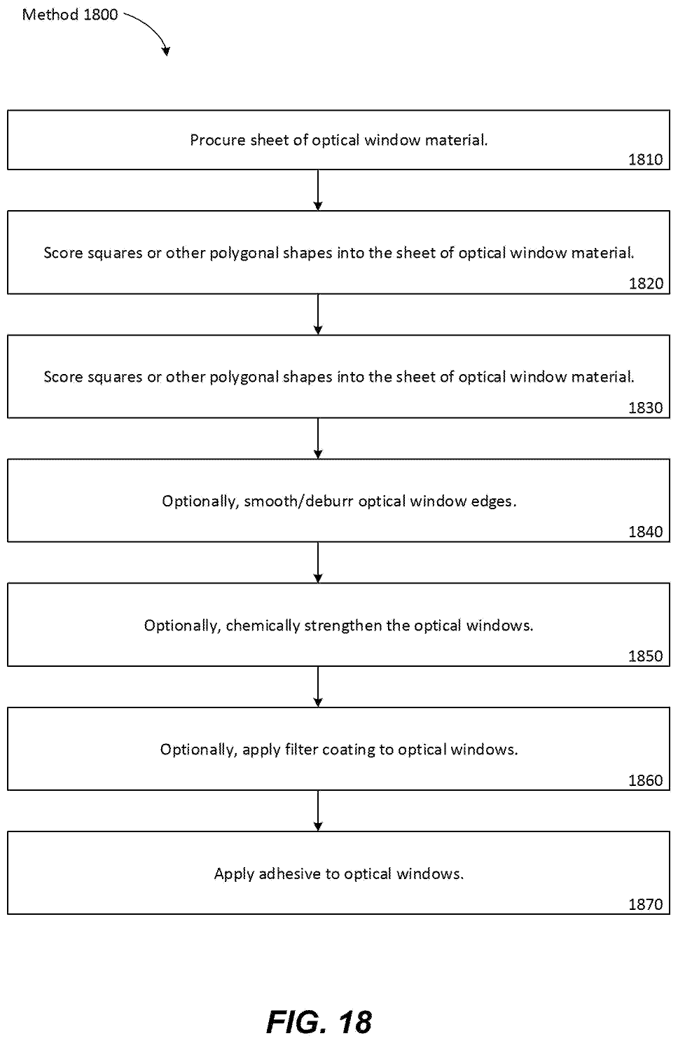

Turning to FIG. 1C, the front housing subassembly 130 may include a carrier 132 having ports or openings whereby the emitted laser 111 (FIGS. 1A and 1B) may pass through one port or opening and the reflected light input 120 (FIGS. 1A and 1B) may pass through the other. Windows 134 may mount onto the carrier 132 such that one window 134 may mount about each opening and secure thereto via adhesive 136. In some embodiments, the windows 132 may be or include alkali-aluminosilicate sheet glass such as the publically available Corning® Gorilla @ glass. It should also be noted that in other embodiments, other shapes of windows may be used. The square windows 134 (or alternatively other polygonal shaped windows) may be manufactured via the method 1800 described in FIG. 18. The adhesive 136 may be or include the publically available 3M™ VHB™ tape or other very high or ultra-high bond tape. A cover 138 may secure outside the windows 134 having openings that may align with the openings of carrier 132. An O-ring 140 may be positioned about the carrier 132 in some embodiments wherein the daylight visible laser rangefinder module 100 is further installed in additional housing elements (e.g., front housing 420 and back housing 430 encasing the stand-alone laser rangefinder 400 of FIGS. 4A-4D) or other host devices (e.g., range finding utility locator device 1200 of FIGS. 12A-12D, range finding utility locator device 1400 of FIG. 14, or range finding utility locator device 1500 of FIG. 15). In some embodiments, such housing may be waterproof wherein a daylight visible laser rangefinder may be used in an underwater environment. A pair of gaskets 142 may be positioned behind the carrier 132 further having openings aligning with openings of the carrier 132 such that when the daylight visible laser rangefinder module 100 is assembled the openings of the cover 138, carrier 132, and gaskets 142 align to laser element 110 (FIGS. 1A and 1B) and receive element 120 (FIGS. 1A and 1B) of the rangefinder subassembly 150. The gaskets 142 may be positioned between the carrier 132 and the rangefinder subassembly 150 to aid in preventing the ingress of light as well as other harmful elements into the laser element 110 (FIGS. 1A and 1B) and receive elements 120 (FIGS. 1A and 1B). It should be noted that the carrier 132, as well as other housing elements of the front housing subassembly 130, may be or include carbon-fiber filled injection moldable plastic such as Ultem™ filaments publically available from SABIC Global Technologies.

Turning to FIG. 1D, the rangefinder subassembly 150 may include a PCB 152 onto which electronic components responsible for generating lasers (e.g., emitted laser 111 of FIGS. 1A and 1B), receiving reflected light input (e.g., reflected light input 121 of FIGS. 1A and 1B), and processing associated data in generating distance measurements may be disposed. As illustrated, the PCB 152 may include a laser diode 154 and a photodetector 156 (e.g., avalanche photodiodes, avalanche photodiode arrays, silicon photomultipliers (SiPM), and/or like photodetector sensors for sensing the reflected light input) each positioned to align with an opening in a mounting barrel 158 which may each secure to PCB 152 via screws 159. The SiPM may, in some embodiments, be or include the MICROFC-10010 SiPM publically available from ON Semiconductor®. A collimator 160 may seat in a retainer 162 wherein one retainer 162 and collimator 160 may secure to each one of the mounting barrels 158 via screws 163 further securing one or more shims 164 and the collimator 160 between each mounting barrel 158 and retainer 162. In assembly, the laser diode 154 and photodetector 156 may align with openings in respective mounting barrels 158, one or more shims 164, and retainers 162 of the rangefinder subassembly 150 and further with openings of the cover 138, carrier 132, and gaskets 142 of the front housing subassembly 130 (FIG. 1C) for the passage of emitted laser 111 (FIGS. 1A and 1B) and reflected light input 121 (FIGS. 1A and 1B) to/from the external environment. The shims 164 may set the focus of the lenses of the collimators 160 and lens assembly 162 in assembly. It should be noted that the collimators 160 corresponding with the photodetectors 156a and 156b and the collimators 160 corresponding with the laser diodes 154a and 154b may seat at different depths in their respective one of the retainers 162, for instance, to accommodate a difference in focal distance. In some embodiments, one or more O-rings (not illustrated) may instead or in addition to shims 164 be included seated in the mounting barrels 158. Such O-rings may be used set the focus of the lenses of the collimators 560 and lens assembly 562 by adjusting the degree of screws 163 and/or screws 165 being tightened. Returning to FIG. 1D, it should be noted that the mounting barrels 158 and retainers 162, as well as other housing elements of the rangefinder subassembly 150, may be or include carbon-fiber filled injection moldable plastic such as Ultem™ filaments publically available from SABIC Global Technologies.

It should be noted that “daylight visible” as used herein may refer to light, generally in the form of lasers, at wavelengths that may be readily detectable by the human eye in daylight conditions. For instance, as shown in FIG. 1E, a diagram 170 demonstrates the luminous efficiency function describing the average spectral sensitivity of human visual perception of brightness or, in other words, the relative sensitivity to light at different wavelengths. The diagram 170 graphs the average perception at photopic lighting conditions 180, which may be brightly lit conditions (daylight or the like), as well as scotopic lighting conditions 190, which may be low lighting conditions. It should be understood that “daylight visible” may fall in the visible light spectrum (380 to 700 nm) and be readily detectable at photopic lighting conditions 180. As shown, a green laser spectrum 185, ranging in the 532 to 555 nm wavelengths, may be readily detectable at photopic lighting conditions 180. Likewise, the green laser spectrum 185 may be readily perceived by the human eye during scotopic lighting conditions 190. This green laser spectrum 185 may be in contrast to red lasers that are commonly used in known rangefinders. For instance, a red laser spectrum 195 ranging in the 650 to 700 nm wavelengths, falls outside the photopic lighting conditions 180 and may be substantially difficult to perceive by the human eye even at scotopic lighting conditions 190.

It should be noted that the daylight visible laser rangefinder module 100 of FIGS. 1A and 1B may be a complete device further including a power element (e.g. power element 240 of FIG. 2 or power element 340 of FIG. 3) for portioning of electrical power to various powered elements, a processing element (e.g. processing element 248 of FIG. 2 or processing element 348 of FIG. 3) for calculating distance measurements, a memory element (e.g., memory element 252 of FIG. 2 or memory element 352 of FIG. 3), and optionally user input controls (e.g., user input controls 256 of FIG. 2 or user input controls 356 of FIG. 3) and/or user interfaces (e.g., user interface 254 of FIG. 2 or user interface 354 of FIG. 3) for displaying distance measurements and/or other data.

In some embodiments, the daylight visible rangefinder module 100 of FIGS. 1A and 1B or other daylight visible laser rangefinder modules may further be included in a stand-alone daylight visible rangefinder wherein the daylight visible rangefinder module is further fitted into an enclosure (e.g., front housing 420 and back housing 430 of the daylight visible laser rangefinder 400 of FIGS. 4A-4D). Such embodiments may further have a power source (e.g., power element 240 of FIG. 2, power element 340 of FIG. 3, or battery 450 of FIG. 4B) as well as other user input controls (e.g., user input controls 256 of FIG. 2, user input controls 356 of FIG. 3, or user input controls 470 of FIG. 4D) and user interface (e.g., user interface 254 of FIG. 2, user interface 354 of FIG. 3, or user interface 460 of FIG. 4D) for displaying distance measurements and/or other data.

In yet other embodiments, a daylight visible laser rangefinder module, which may be the daylight visible laser rangefinder module 100 of FIGS. 1A and 1B, may be employed in a host device (e.g., range finding utility locator device 1200 of FIGS. 12A-12D, range finding utility locator device 1400 of FIG. 14, or range finding utility locator device 1500 of FIG. 15) via screws 165 (FIG. 1D) to add distance measuring capabilities thereto. In such embodiments, various resources may be shared between a host device and daylight visible laser rangefinder embodiment. For instance, some such shared resources may include, but should not be limited to, elements responsible for processing of data, storage of data and instructions for generating distance measurements and the related data, portioning of electrical power from a power element, as well as user input controls and/or user interfaces for displaying distance measurements and/or other data.

It should further be noted that in some daylight visible laser embodiments that include multiple laser elements, the different laser elements may operate at different wavelengths and at least one laser element may operate in daylight visible wavelengths.

Turning to FIG. 2, a diagram of a daylight visible laser rangefinder 200 is illustrated which may be or share aspects with the daylight visible laser rangefinder module 100 of FIGS. 1A and 1B. As shown, a laser element 210 may include a laser driver 212 for supplying current at specific wavelengths and power output to a laser diode 214 or other laser source in generating an emitted laser 211 modulated at one or more known frequencies. It should be noted that electrical power may be supplied to the laser driver 212 via a power element 240 (e.g., battery, grid-tied electrical power, or the like). A collimator 216 may be included for focusing light from the laser diode 214 in generating the narrow beam of the emitted laser 211. The emitted laser 211, which may be a green or other day-light visible laser, may be directed at a target 242 generating a reflected light input 221 directed back toward a receiver element 220.

A bandpass filter 222 included in the receiver element 220 may filter out noise influences at out of band frequencies but allow the in band reflected light input 221 through to a sensing element 226. The bandpass filter 222 may be calibrated to account for phase shifts. Further in the receiver element 220, a collimator 224 may focus the reflected light input 221 to include the sensing element 226. The sensing element 226 may receive the reflected light input 221 and convert the light to a corresponding electrical signal referred to herein as the “input signal.” The sensing element 226 may further be or include a photodetector 228 (e.g., one or more avalanche photodiodes, avalanche photodiode arrays, silicon photomultipliers (SiPM), and/or other like photodetector sensors for sensing the reflected light input 221). The SiPM may, in some embodiments, be or include the MICROFC-10010 SiPM publically available from ON Semiconductor®. In some embodiments, the sensing element 226 may likewise include a signal amplifier 230 (e.g., a transimpedance amplifier or the like) to amplify the input signals.

The receiver element 220 may further include a gain control element 232 for varying the gain of the sensing element 226 to appropriate levels for receiving reflected light input 221 and compensating for the change in amplitude due to the attenuation of light signals of the modulated emitted laser 211 and the resulting reflected light input 221. It should be noted that the varying of gain to the sensing element 226 may be achieved in different ways. In FIG. 2, the gain control element 232 may vary the gain to the sensing element 226 by controlling the bias voltage to the photodetector 228. For instance, wherein the photodetector 228 may be a silicon photomultiplier (SiPM) the operating voltage may have a range of 24-32 volts DC. The SiPM may, in some embodiments, be or include the MICROFC-10010 SiPM publically available from ON Semiconductor®. Adjusting the bias voltage may adjust the sensitivity of the SiPM (or other photodetector 228) and thereby compensate for attenuated amplitudes of the received reflected light input 221 and corresponding input signal. In other embodiments, such as the gain control element 332 of FIG. 3, the gain to the sensing element may be adjusted by the introduction of a programmable gain amplifier (PGA) coupled to a transimpedance amplifier or like signal amplifier.

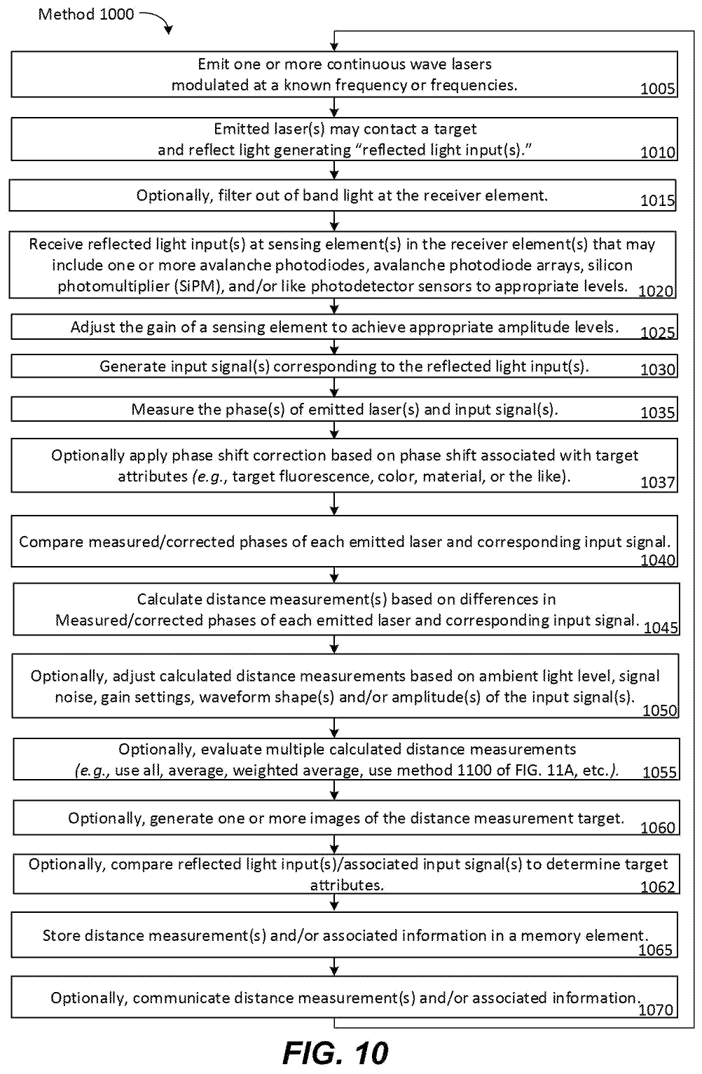

Referring to FIG. 2, a clock 244 may couple to the laser element 210 and a phase detector 246 such that timing of the detected phase corresponding to the emitted laser 211 may be known. Likewise, the input signals from the receiver element 220 may be communicated with the phase detector 246. Phase data corresponding to the emitted laser 211 and input signal may further be communicated with a processing element 248. The processing element 248, having one or more processors, may determine differences in phases and thereby calculate distance measurements (e.g., via method 1000 of FIG. 10).

Adjustments to the calculation of distance measurement may be made based on other available data. For instance, the ambient light data and waveform data (e.g., data relating to the waveform shape and amplitude of the input signal) from the sensing element 226 may be communicated to the processing element 248 and may be compensated for in the calculation of distance measurements. Likewise, a temperature sensor 250 may optionally be include to supply the processing element 248 with temperature data allowing for temperature (e.g., environment, lasers, and/or associated circuitry temperatures) to be compensated for in the calculation of distance measurements. In some embodiments, the gain levels may be considered in calculations of distance measurements.

Still referring to FIG. 2, the processing element 248 may connect to a memory element 252 having one or more non-transitory memories. The memory element 252 may store distance measurements as well as instructions relating to calculating such distance measurements.

Still referring to FIG. 2, the daylight visible laser rangefinder 200 may, in some embodiments, optionally include a user interface 254 (e.g., a graphical user interface, speakers for audio feedback, or the like) for communicating distance measurements and/or other data to a user. Likewise, the daylight visible laser rangefinder 200 may optionally include a set of user input controls 256 (e.g., buttons or like controls) providing the user the ability to control aspects of the daylight visible laser rangefinder 200. For instance, such user input controls 256 may allow input from a user to turn the daylight visible laser rangefinder 200 on or off, select from menus, or the like. The user interface 254 and user input controls 256 may, for instance, be included in a stand-alone laser rangefinder in keeping with the present disclosure such as the stand-alone daylight visible laser rangefinder 400 of FIGS. 4A-4D.

Still referring to FIG. 2, the daylight visible laser rangefinder 200 may, in other embodiments, optionally be included as a module in a host device 258. For instance, the daylight visible laser rangefinder 200 may be built into a utility locator device configured to determine and map utility line positions, which may be buried in the ground, from sensed magnetic fields. Additional information regarding utility locator devices may be found in the aforementioned incorporated applications as well as with the range finding utility locator device 1200 of FIGS. 12A-12D, range finding utility locator device 1400 of FIG. 14, or range finding utility locator device 1500 of FIG. 15. In some such embodiments, various resources may be shared between the host device and daylight visible laser rangefinder embodiment. For instance, some such shared resources may include, but should not be limited to, elements responsible for processing of data, storage of data and instructions for generating distance measurements and the related data, portioning of electrical power from a power element, as well as user input controls and/or user interfaces for displaying distance measurements and/or other data.

Turning to FIG. 3, a diagram of a daylight visible laser rangefinder 300 is illustrated which may be or share aspects with the daylight visible laser rangefinder module 100 of FIGS. 1A and 1B. As shown, a laser element 310 may include a laser driver 312 for supplying current at specific wavelengths and power output to a laser diode 314 or other laser source in generating an emitted laser 311 modulated at one or more known frequencies. It should be noted that electrical power may be supplied to the laser driver 312 via a power element 340 (e.g., battery, grid-tied electrical power, or the like). A collimator 316 may be included for focusing light from the laser diode 314 in generating the narrow beam of the emitted laser 311. The emitted laser 311, which may be a green or other day-light visible laser, may be directed at a target 342 generating a reflected light input 321 directed back toward a receiver element 320.

A bandpass filter 322 included in the receiver element 320 may filter out noise influences at out of band frequencies but allow in band reflected light input 321 through to a sensing element 326. The bandpass filter 322 may be calibrated to account for phase shifts. Further in the receiver element 320, a collimator 324 may focus the reflected light input 321 to include a sensing element 326. The sensing element 326 may receive the reflected light input 321 and convert the light to a corresponding electrical input signal. The sensing element 326 may further be or include a photodetector 328 (e.g., one or more avalanche photodiodes, avalanche photodiode arrays, silicon photomultipliers (SiPM), and/or other like photodetector sensors for sensing the reflected light input 321). The SiPM may, in some embodiments, be or include the MICROFC-10010 SiPM publically available from ON Semiconductor®. In some embodiments, the sensing element 320 may likewise include a signal amplifier 330 (e.g., a transimpedance amplifier or the like) to amplify the input signals.

The receiver element 320 may further include a gain control element 332 for varying the gain of the sensing element 326 to appropriate levels for receiving reflected light input 321 and compensating for the change in amplitude due to the attenuation of light signals of the modulated emitted laser 311 and the resulting reflected light input 321. It should be noted that the varying of gain to the sensing element 326 may be achieved in different ways. In FIG. 3, the gain control element 332 may be or include a programmable gain amplifier (PGA) coupled to the signal amplifier 330 for purposes of gain control. In other embodiments, such as the gain control element 232 of FIG. 2, the gain to the sensing element may be adjusted by changing the bias voltage to the photodetector (e.g., photodetector 228 of FIG. 2).

Referring to FIG. 3, a clock 344 may couple to the laser element 310 and a phase detector 346 such that timing of the detected phase corresponding to the emitted laser 311 may be known. Likewise, the input signals from the receiver element 320 may be communicated with the phase detector 346. Phase data corresponding to the emitted laser 311 and input signal may further be communicated with a processing element 348. The processing element 348, having one or more processors, may determine differences in phases and thereby calculate distance measurements (e.g., via method 1000 of FIG. 10).

Adjustments to the calculation of distance measurement may be made based on other available data as well. For instance, the ambient light data and waveform data (e.g., data relating to the waveform shape and amplitude of the input signal) from the sensing element 326 may be communicated to the processing element 348 and may be compensated for in the calculation of distance measurements. Likewise, a temperature sensor 350 may optionally be include to supply the processing element 348 with temperature data allowing for temperature (e.g., environment, lasers, and/or associated circuitry temperatures) to be compensated for in the calculation of distance measurements. In some embodiments, the gain levels may be considered in calculations of distance measurements.

Still referring to FIG. 3, the processing element 348 may connect to a memory element 352 having one or more non-transitory memories. The memory element 352 may store distance measurements as well as instructions relating to calculating such distance measurements.

Still referring to FIG. 3, the daylight visible laser rangefinder 300 may, in some embodiments, optionally include a user interface 354 (e.g., a graphical user interface, speakers for audio feedback, or the like) for communicating distance measurements and/or other data to a user. Likewise, the daylight visible laser rangefinder 300 may optionally include a set of user input controls 356 (e.g., buttons or like controls) providing the user the ability to control aspects of the daylight visible laser rangefinder 300. For instance, the user input controls 356 may allow input from a user to turn the daylight visible laser rangefinder 300 on or off, select from menus, or the like. The user interface 354 and user input controls 356 may, for instance, be included in a stand-alone laser rangefinder in keeping with the present disclosure such as the stand-alone daylight visible laser rangefinder 400 of FIGS. 4A-4B.

Still referring to FIG. 3, the daylight visible laser rangefinder 300 may, in other embodiments, optionally be included as a module in a host device 358. For instance, the daylight visible laser rangefinder 300 may be built into a utility locator device configured to determine and map utility line positions, which may be buried in the ground, from sensed magnetic fields. Additional information regarding utility locator devices may be found in the aforementioned incorporated applications as well as with the range finding utility locator device 1200 of FIGS. 12A-12D, range finding utility locator device 1400 of FIG. 14, or range finding utility locator device 1500 of FIG. 15. In some such embodiments, various resources may be shared between the host device and daylight visible laser rangefinder embodiment. For instance, some such shared resources may include, but should not be limited to, elements responsible for processing of data, storage of data and instructions for generating distance measurements and the related data, portioning of electrical power from a power element, as well as user input controls and/or user interfaces for displaying distance measurements and/or other data.

Turning to FIG. 4A-4D, a stand-alone daylight visible laser rangefinder 400 in keeping with the present disclosure is illustrated. The stand-alone daylight visible rangefinder 400 may include a daylight visible laser rangefinder module 410 which may be or share aspects with the daylight visible laser rangefinder module 100 of FIGS. 1A and 1B, the daylight visible laser rangefinder 200 of FIG. 2, and/or the daylight visible laser rangefinder 300 of FIG. 3. The stand-alone daylight visible laser rangefinder 400 may have a front housing 420 and back housing 430 that, in assembly, may secure together encasing the daylight visible laser rangefinder module 410 secured therein. The front housing 420 may have an opening through which emitted lasers (e.g., emitted laser 411 of FIG. 4C) and the reflected light inputs from a target (e.g., reflected light input 421 from target 440 of FIG. 4C) may travel to/from the outside environment.

Referring to FIG. 4B, the stand-alone daylight visible laser rangefinder 400 may include a battery 450 or other power source. The battery 450 (or other power source) may be included for portioning of electrical power to the various powered components of the stand-alone daylight visible laser rangefinder 400.

Turning to FIG. 4D, the stand-alone daylight visible laser rangefinder 400 may optionally include a user interface 460 (e.g., a graphical user interface or the like) for communicating distance measurements and/or other data to a user. Likewise, the stand-alone daylight visible laser rangefinder 400 may optionally include a set of user input controls 470 (e.g., buttons or like controls) providing the user the ability to control aspects of the stand-alone daylight visible laser rangefinder 400. For instance, the user input controls 470 may allow input from a user to turn the stand-alone daylight visible laser rangefinder 400 on or off, select from menus, or the like.

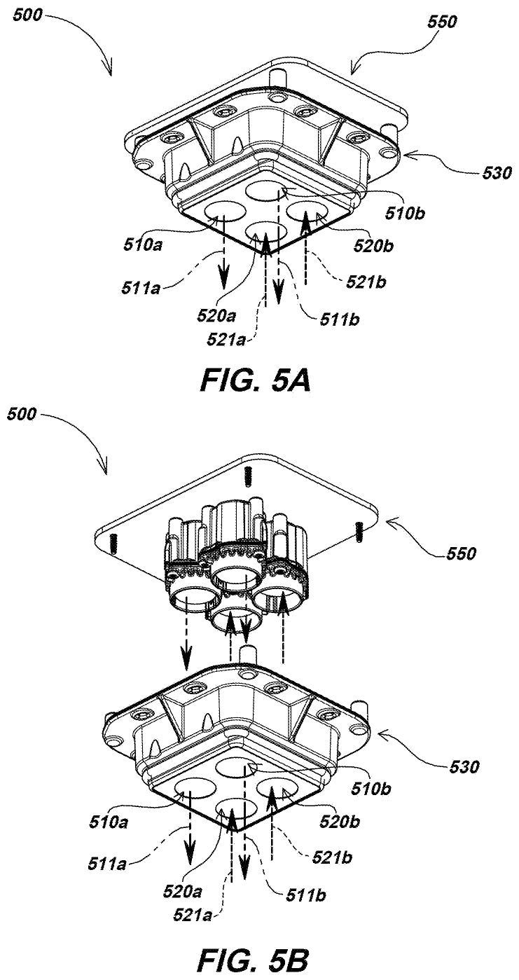

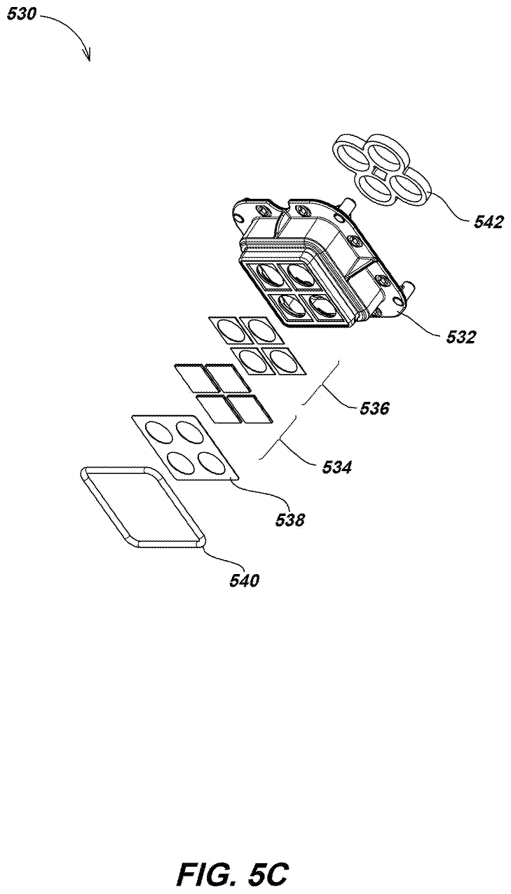

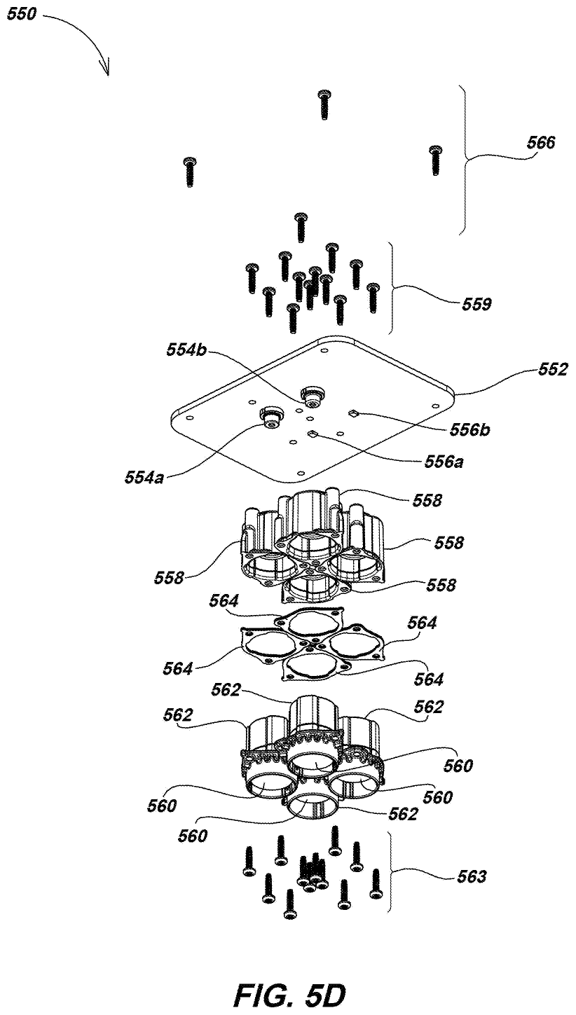

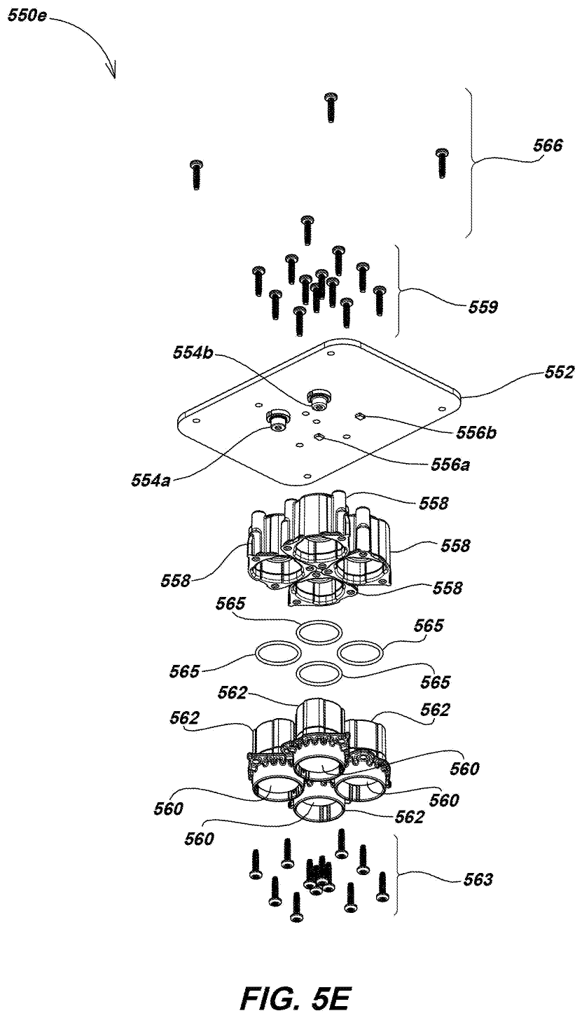

Turning to FIGS. 5A and 5B, a multi-spectral laser rangefinder module 500 is illustrated having multiple laser elements such as laser elements 510a and 510b that, in use, may each emit a continuous wave laser, such as an emitted laser 511a and emitted laser 511b, each modulated at one or more known but different frequencies. In some embodiments, one of the emitted lasers may be a green or other daylight visible laser. Likewise, the other laser elements may be infrared, near-infrared, or other wavelength lasers.

It should be noted that despite showing two lasers in the multi-spectral laser rangefinder module 500 of FIGS. 5A and 5B, other embodiments in keeping with the present disclosure may include other numbers of laser elements and corresponding receiver elements. The various multi-spectral laser rangefinder may operate at different wavelengths. As some wavelengths may provide more accurate results in certain rangefinder applications/environments (e.g., daylight versus indoor light uses or other light conditions, distances to targets, measuring off fluorescent targets or those with different reflectance characteristics, or the like) than others, having a mix of rangefinders functioning at different spectral wavelengths may provide accurate distance measurements in a wider array of use applications.

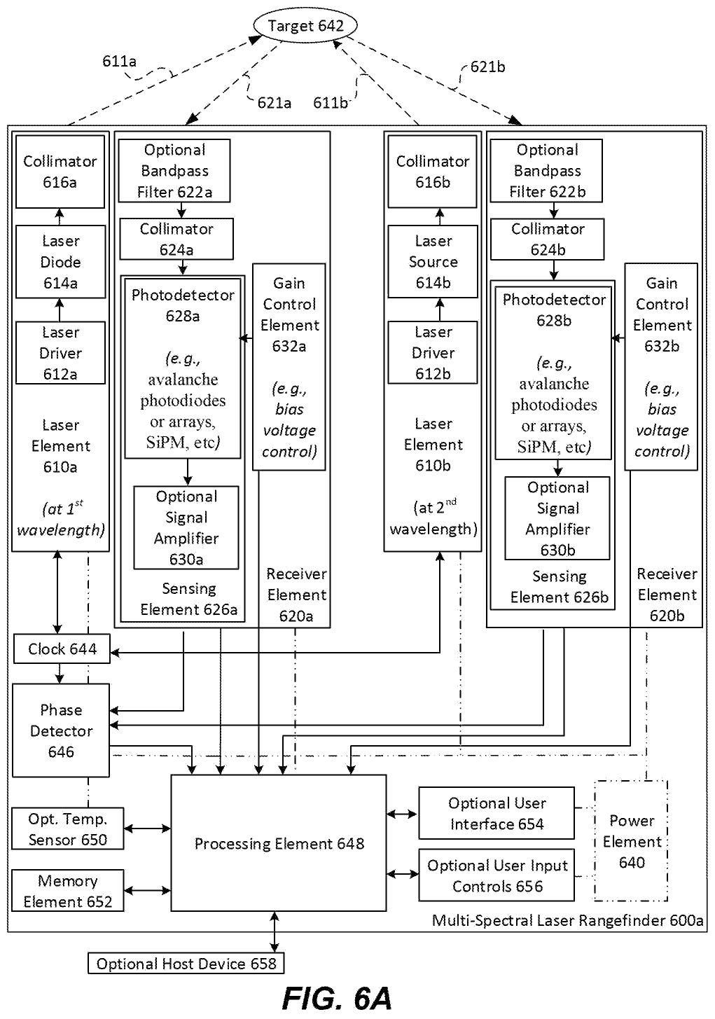

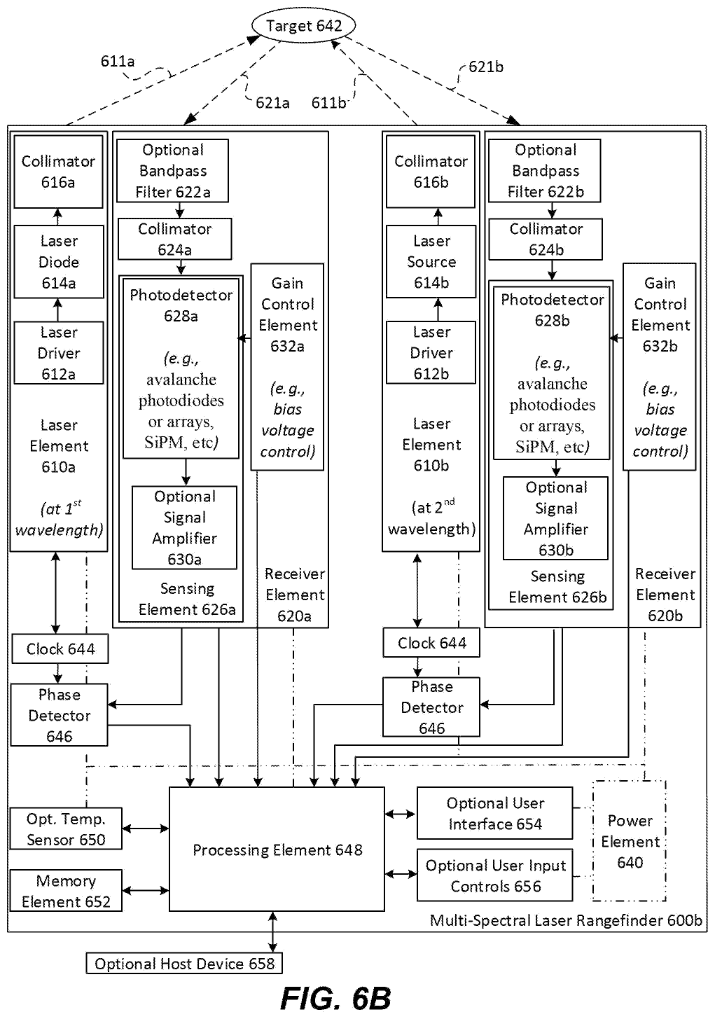

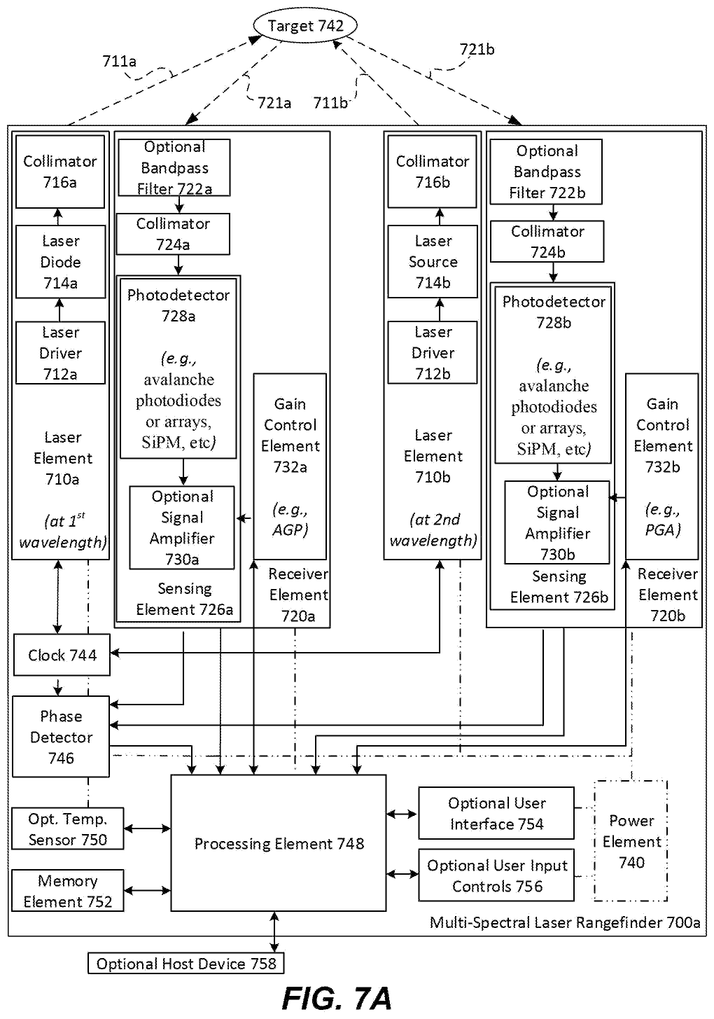

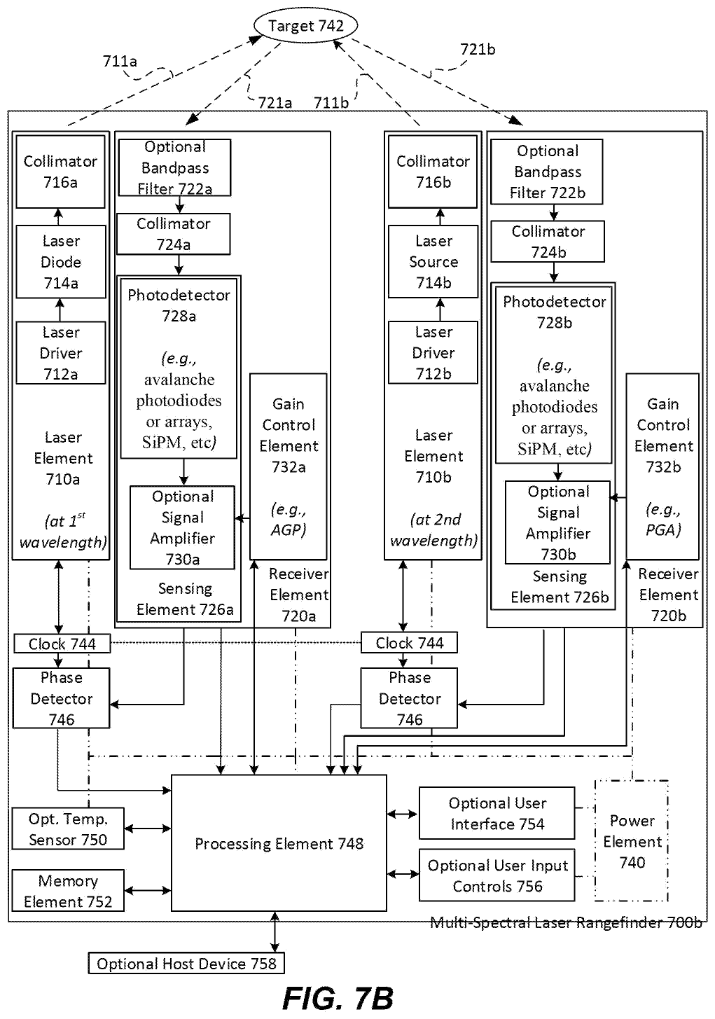

Still referring to FIGS. 5A and 5B, the multi-spectral laser rangefinder module 500 may further include a plurality of receiver elements, such as receiver element 520a and receiver element 520b, aligned to receive reflected light inputs 521a and 521b from reflection of the emitted lasers 511a and 511b striking a target (e.g., target 642 of FIGS. 6A and 6B or target 742 of FIGS. 7A and 7B) for the purpose of generating a distance measurement to that target. In various embodiments herein the target may be the ground surface or other object by which a multi-spectral laser rangefinder embodiment, such as the multi-spectral laser rangefinder module 500, may be aimed at for purposes of measuring the distance between the multi-spectral laser rangefinder embodiment and the target. The multi-spectral laser rangefinder module 500 may further include a front housing subassembly 530 that may couple to a rangefinder subassembly 550 (best illustrated in FIG. 5B) in assembly (or, in other embodiments, a rangefinder subassembly 550e illustrated in FIG. 5E).

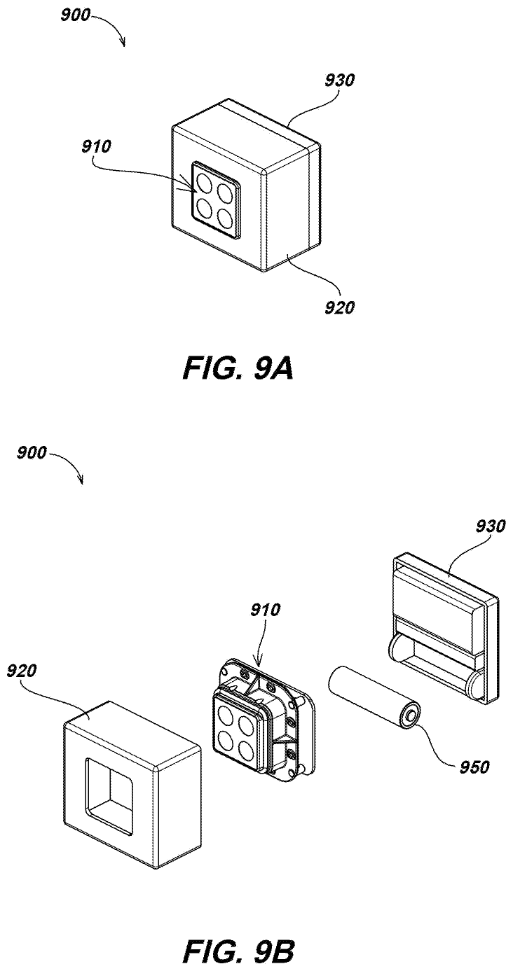

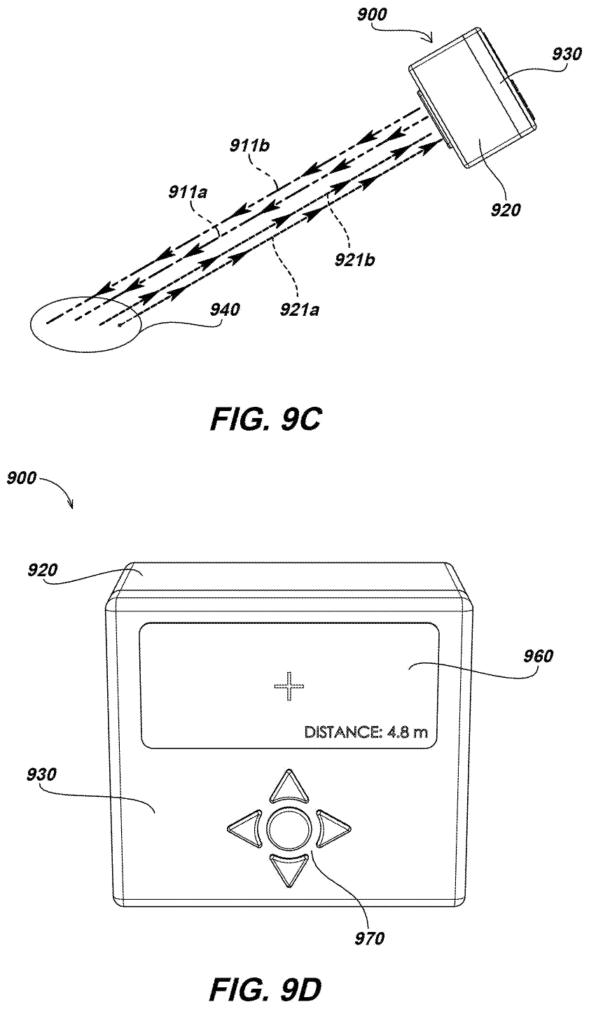

Turning to FIG. 5C, the front housing subassembly 530 as shown in greater detail may include a carrier 532 having ports or openings whereby the emitted lasers 511a and 511b (FIGS. 5A and 5B) may each pass through one opening and the reflected light inputs 521a and 521b (FIGS. 5A and 5B) may each pass through another opening. Windows 534 may mount onto the carrier 532 such that one window 534 may mount about each opening and secure thereto via adhesive 536. In some embodiments, the windows 534 may be or include alkali-aluminosilicate sheet glass such as the publically available Corning® Gorilla® glass. It should also be noted that in other embodiments other shapes of windows may be used. The square windows 534 (or alternatively other polygonal shaped windows) may be manufactured via the method 1800 described in FIG. 18. The adhesive 536 may be or include the publically available 3M™ VHB™ tape or other very high or ultra-high bond tape. A cover 538 may secure outside the windows 534 having openings that may align with the openings of carrier 532. An O-ring 540 may be positioned about the carrier 532 in some embodiments wherein the multi-spectral laser rangefinder module 500 may further be installed in additional housing elements (e.g., front housing 920 and back housing 930 encasing the stand-alone laser rangefinder 900 of FIGS. 9A-9D) or other host device (e.g., range finding utility locator device 1200 of FIGS. 12A-12D, range finding utility locator device 1400 of FIG. 14, or range finding utility locator device 1500 of FIG. 15). In some embodiments, such a housing may be waterproof wherein a multi-spectral laser rangefinder embodiment may be used in an underwater environment. A gasket 542 may be positioned behind each opening of the carrier 532 further having openings aligning with openings of the carrier 532 such that when the multi-spectral laser rangefinder module 500 is assembled the openings of the cover 538, carrier 532, and gaskets 542 align to laser elements 510a and 510b (FIGS. 5A and 5B) and receive elements 520a and 520b (FIGS. 5A and 5B) of the rangefinder subassembly 550 (or, in other embodiments, the rangefinder subassembly 550e illustrated in FIG. 5E). The gaskets 542 may be positioned between the carrier 532 and the rangefinder subassembly 550 (or, in other embodiments, the rangefinder subassembly 550e illustrated in FIG. 5E) to aid in preventing the ingress of light as well as other harmful element into laser elements 510a and 510b (FIGS. 5A and 5B) and receive elements 520a and 520b (FIGS. 5A and 5B). It should be noted that the carrier 532, as well as other housing elements of the front housing subassembly 530, may be or include carbon-fiber filled injection moldable plastic such as Ultem™ filaments publically available from SABIC Global Technologies.

Turning to FIG. 5D, the rangefinder subassembly 550 may include a PCB 552 which is responsible for generating lasers (e.g., emitted lasers 511a and 511b of FIGS. 5A and 5B), receiving reflected light input (e.g., reflected light inputs 521a and 521b of FIGS. 5A and 5B), and processing associated data in generating distance measurements. As illustrated, the PCB 552 may include a number of laser sources such as laser diodes 554a and 554b and corresponding photodetectors such photodetectors 556a and 556b (e.g., avalanche photodiodes, avalanche photodiode arrays, silicon photomultipliers (SiPM), and/or like photodetector sensors for sensing the reflected light inputs) each positioned to align with an opening in a mounting barrel 558. The SiPM may, in some embodiments, be or include the MICROFC-10010 SiPM publically available from ON Semiconductor®. Each mounting barrel 558 may secure to PCB 552 via a number of screws 559. A collimator 560 may seat onto a retainer 562 such that one retainer 562 and collimator 560 may secure to each one of the mounting barrels 558 via screws 563 further securing one or more shims 564 and one of the collimators 560 between each mounting barrel 558 and retainer 562. In assembly, the laser diodes 554a and 554b and corresponding photodetectors 556a and 556b may align with openings in respective mounting barrels 558, shims 564, and retainers 562 of the rangefinder subassembly 550 and further with openings of the cover 538, carrier 532, and gaskets 542 of the front housing subassembly 530 illustrated in FIG. 5C such that the emitted laser 511a and 511b (FIGS. 5A and 5B) and reflected light inputs 521a and 521b (FIGS. 5A and 5B) may travel to/from the external environment. The shims 564 may set the focus of the lenses of the collimators 560 and lens assembly 562 in assembly. It should be noted that the collimators 560 corresponding with the photodetectors 556a and 556b and the collimators 560 corresponding with the laser diodes 554a and 554b may seat at different depths in their respective one of the retainers 562, for instance, to accommodate a difference in focal distance. It should also be noted that the mounting barrels 558 and retainers 562, as well as other housing elements of the rangefinder subassembly 550, may be or include carbon-fiber filled injection moldable plastic such as Ultem™ filament publically available from SABIC Global Technologies.

Turning to FIG. 5E, another rangefinder subassembly 550e is illustrated which may be used in various multi-spectral laser rangefinder modules in keeping with the present disclosure in lieu of the rangefinder subassembly 550 best illustrated in FIG. 5D. The rangefinder subassembly 550e may include a PCB 552 which is responsible for generating lasers (e.g., emitted lasers 511a and 511b of FIGS. 5A and 5B), receiving reflected light input (e.g., reflected light inputs 521a and 521b of FIGS. 5A and 5B), and processing associated data in generating distance measurements. As illustrated, the PCB 552 may include a number of laser sources such as laser diodes 554a and 554b and corresponding photodetectors such photodetectors 556a and 556b (e.g., avalanche photodiodes, avalanche photodiode arrays, silicon photomultipliers (SiPM), and/or like photodetector sensors for sensing the reflected light inputs) each positioned to align with an opening in a mounting barrel 558. The SiPM may, in some embodiments, be or include the MICROFC-10010 SiPM publically available from ON Semiconductor®. Each mounting barrel 558 may secure to PCB 552 via a number of screws 559. A collimator 560 may seat onto a retainer 562 such that one retainer 562 and collimator 560 may secure to each one of the mounting barrels 558 via screws 563 further securing an O-ring 565 and one of the collimators 560 between each mounting barrel 558 and retainer 562. In assembly, the laser diodes 554a and 554b and corresponding photodetectors 556a and 556b may align with openings in respective mounting barrels 558, O-rings 565, and retainers 562 of the rangefinder subassembly 550e and further with openings of the cover 538, carrier 532, and gaskets 542 of the front housing subassembly 530 illustrated in FIG. 5C such that the emitted laser 511a and 511b (FIGS. 5A and 5B) and reflected light inputs 521a and 521b (FIGS. 5A and 5B) may travel to/from the external environment. The O-rings 565 may be used set the focus of the lenses of the collimators 560 and lens assembly 562 by adjusting the degree of screws 563 being tightened. Further, the O-rings 565 may aid in sealing against the external environment. It should be noted that the collimators 560 corresponding with the photodetectors 556a and 556b and the collimators 560 corresponding with the laser diodes 554a and 554b may seat at different depths in their respective one of the retainers 562, for instance, to accommodate a difference in focal distance. It should also be noted that the mounting barrels 558 and retainers 562, as well as other housing elements of the rangefinder subassembly 550e, may be or include carbon-fiber filled injection moldable plastic such as Ultem™ filament publically available from SABIC Global Technologies.

It should be noted that the multi-spectral laser rangefinder module 500 of FIGS. 5A and 5B may be a complete device, further including a power element (e.g. power element 640 of FIGS. 6A and 6B or power element 740 of FIGS. 7A and 7B) for portioning of electrical power to various powered elements, a processing element (e.g. processing element 648 of FIGS. 6A and 6B or processing element 748 of FIGS. 7A and 7B) for calculating distance measurements, a memory element (e.g., memory element 652 of FIGS. 6A and 6B or memory element 752 of FIGS. 7A and 7B), and optionally user input controls (e.g., user input controls 656 of FIGS. 6A and 6B or user input controls 756 of FIGS. 7A and 7B) and/or optional user interfaces (e.g., user interface 654 of FIGS. 6A and 6B or user interface 754 of FIGS. 7A and 7B) for displaying distance measurements and/or other data.

In some embodiments, the multi-spectral rangefinder module 500 of FIGS. 5A and 5B or other multi-spectral laser rangefinder module may further be included in a stand-alone multi-spectral rangefinder wherein the multi-spectral rangefinder module is further fitted into an enclosure (e.g., front housing 920 and back housing 930 of the multi-spectral laser rangefinder 900 of FIGS. 9A-9D). Such embodiments may further have a power source (e.g., power element 640 of FIGS. 6A and 6B, power element 740 of FIGS. 7A and 7B, or battery 950 of FIG. 9B) as well as other user input controls (e.g., user input controls 656 of FIGS. 6A and 6B, user input controls 756 of FIGS. 7A and 7B, or user input controls 970 of FIG. 9D) and user interface (e.g., user interface 654 of FIGS. 6A and 6B, user interface 754 of FIGS. 7A and 7B, or user interface 960 of FIG. 9D) for displaying distance measurements and/or other data.

In yet other embodiments, a multi-spectral laser rangefinder, which may be the multi-spectral laser rangefinder module 500 of FIGS. 5A and 5B, may be employed in a host device (e.g., range finding utility locator device 1200 of FIGS. 12A-12D, range finding utility locator device 1400 of FIG. 14, or range finding utility locator device 1500 of FIG. 15) via screws 566 to add distance measuring capabilities thereto. In such embodiments, various resources may be shared between the host device and multi-spectral laser rangefinder embodiment. For instance, some such shared resources may include, but should not be limited to, elements responsible for processing of data, storage of data and instructions for generating distance measurements and the related data, portioning of electrical power from a power element, as well as user input controls and/or user interfaces for displaying distance measurements and/or other data.

Turning to FIGS. 6A and 6B, diagrams of multi-spectral laser rangefinders are illustrated (e.g., a multi-spectral laser rangefinder 600a is illustrated in FIG. 6A and a multi-spectral laser rangefinder 600b is illustrated in FIG. 6B) which may be or share aspects with the multi-spectral laser rangefinder module 500 of FIGS. 5A and 5B. As shown, a plurality of laser elements, such as laser elements 610a and 610b, may each include a laser driver such as laser drivers 612a and 612b for supplying current at specific wavelengths and power output to a corresponding laser diode 614a or 614b or other laser source, each generating an emitted laser 611a or 611b modulated at different known frequencies. For instance, the emitted laser 611a may be a green or other daylight visible laser while the emitted laser 611b may be an infrared, near-infrared, or other wavelength laser. It should be noted that electrical power may be supplied to the laser drivers 612a and 612b via a power element 640 (e.g., battery, grid-tied electrical power, or the like). A collimator 616a or 616b may be included for focusing light from the laser diodes 614a or 614b respectively in generating narrow beams of the emitted lasers 611a and 611b. The emitted lasers 611a and 611b may be directed at a target 642 each generating a corresponding reflected light input 621a or 621b directed back toward a corresponding receiver element 620a or 620b.

A bandpass filter 622a and 622b included in each respective receiver element 620a and 620b may filter out noise influences at out of band frequencies but allow in band reflected light input 621a and 621b through to a corresponding sensing element 626a or 626b. The bandpass filter 622a and 622b may be calibrated to account for phase shifts. It should be noted that the bandpass filters 622a and 622b may be configured for the different wavelengths of reflected light inputs such as the reflected light inputs 621a and 621b. Further, in the receiver elements 620a and 620b, a collimator 624a or 624b may focus the reflected light input 621a or 621b to the corresponding sensing element 626a or 626b. The sensing elements 626a and 626b may receive the reflected light inputs 621a and 621b and convert the light to corresponding electrical input signals. The sensing elements 626a and 626b may each further be or include a photodetector 628a or 628b (e.g., one or more avalanche photodiodes, avalanche photodiode arrays, silicon photomultipliers (SiPM), and/or other like photodetector sensors for sensing the reflected light inputs 621a or 621b). The SiPM may, in some embodiments, be or include the MICROFC-10010 SiPM publically available from ON Semiconductor®. In some embodiments, the sensing elements 626a or 626b may likewise include a signal amplifier 630a or 630b (e.g., a transimpedance amplifier or the like) to amplify the input signals.

The receiver elements 620a and 620b may further include a gain control element 632a or 632b for varying the gain of the sensing element 626a or 626b to appropriate levels in receiving reflected light inputs 621a and 621b and compensating for the change in amplitude due to the attenuation of light signals of the modulated emitted lasers 611a and 611b and the resulting reflected light inputs 621a and 621b. It should be noted that the varying of gain to the sensing elements 626a and 626b may be achieved in different ways. In FIGS. 6A and 6B, the gain control elements 632a and 632b may vary the gain to the sensing elements 626a and 626b by controlling the bias voltage to the photodetectors 628a or 628b. For instance, wherein the photodetectors 628a and 628b may be silicon photomultipliers (SiPM) the operating voltage may have a range of 24-32 volts DC. The SiPM may, in some embodiments, be or include the MICROFC-10010 SiPM publically available from ON Semiconductor®. Adjusting the bias voltage may adjust the sensitivity of the SiPM 628a or 628b (or other photodetectors) and thereby compensate for attenuated amplitudes of the received corresponding reflected light inputs 621a and 621b and corresponding input signals. In other embodiments, such as the gain control elements 732a and 732b of FIGS. 7A and 7B, the gain to the sensing element may be adjusted by the introduction of a programmable gain amplifier (PGA) coupled to a transimpedance amplifier or like signal amplifier.

Referring to FIG. 6A, a clock 644 may couple to the laser elements 610a and 610b and a phase detector 646 such that timing of the detected phase corresponding to each emitted laser 611a and 611b may be known. Likewise, the input signals from the receiver elements 620a and 620b may be communicated with the phase detector 646. Phase data corresponding to the emitted lasers 611a and 611b and corresponding input signals may further be communicated with a processing element 648. The processing element 648, having one or more processors, may determine differences in phases and thereby calculate distance measurements (e.g., via method 1000 of FIG. 10).

In some embodiments, such as with the multi-spectral laser rangefinder 600b illustrated in FIG. 6B, a clock 644 may couple with each respective one of the laser elements 610a and 610b which may further couple with a phase detector 646. In such embodiments, the clocks 644 may be synchronous in determining the timing associated with the detected phase of each emitted laser 611a and 611b. The input signals from the receiver elements 620a and 620b may be communicated with the respective one of the phase detector 646 associated with the receiver element 620a or 620b. Phase data corresponding to the emitted lasers 611a and 611b and corresponding input signals may further be communicated with a processing element 648. The processing element 648, having one or more processors, may determine differences in phases and thereby calculate distance measurements (e.g., via method 1000 of FIG. 10).

Referring to FIGS. 6A and 6B, adjustments to the calculation of distance measurement may be made based on other available data. For instance, the ambient light data and waveform data (e.g., data relating to the waveform shape and amplitude of the input signal) from the sensing elements 626a and 626b may be communicated to the processing element 648 and may be compensated for in the calculation of distance measurements. Likewise, a temperature sensor 650 may optionally be include to supply the processing element 648 with temperature data allowing for temperature (e.g., environment, lasers, and/or associated circuitry temperatures) to be compensated for in the calculation of distance measurements. In some embodiments, the gain levels may be considered in calculations of distance measurements.

Referring to FIGS. 6A and 6B, the processing element 648 may connect to a memory element 652 having one or more non-transitory memories. The memory element 652 may store distance measurements as well as instructions relating to calculating such distance measurements.

Still referring to FIGS. 6A and 6B, the multi-spectral laser rangefinder 600a (FIG. 6A) and the multi-spectral laser rangefinder 600b (FIG. 6B) may, in some embodiments, optionally include a user interface 654 (e.g., a graphical user interface, speakers for audio feedback, or the like) for communicating distance measurements and/or other data to a user. Likewise, the multi-spectral laser rangefinder 600a (FIG. 6A) and the multi-spectral laser rangefinder 600b (FIG. 6B) may optionally include a set of user input controls 656 (e.g., buttons or like controls) providing the user the ability to control aspects of the multi-spectral laser rangefinder 600a (FIG. 6A) or the multi-spectral laser rangefinder 600b (FIG. 6B). For instance, the user input controls 656 may allow input from a user to turn the multi-spectral laser rangefinder 600 on or off, select from menus, or the like. The user interface 654 and user input controls 656 may, for instance, be included in a stand-alone laser rangefinder in keeping with the present disclosure such as the stand-alone multi-spectral laser rangefinder 900 of FIGS. 9A-9D.

Still referring to FIGS. 6A and 6B, the multi-spectral laser rangefinder 600a (FIG. 6A) or the multi-spectral laser rangefinder 600b (FIG. 6B) may, in other embodiments, optionally be included as a module in a host device 658. For instance, the multi-spectral laser rangefinder 600a (FIG. 6A) or the multi-spectral laser rangefinder 600b (FIG. 6B) may be built into a utility locator device configured to determine and map utility line positions, which may be buried in the ground, from sensed magnetic fields. Additional information regarding utility locator devices may be found in the aforementioned incorporated applications as well as with the range finding utility locator device 1200 of FIGS. 12A-12D, range finding utility locator device 1400 of FIG. 14, or range finding utility locator device 1500 of FIG. 15. In some such embodiments, various resources may be shared between the host device and multi-spectral laser rangefinder embodiment. For instance, some such shared resources may include, but should not be limited to, elements responsible for processing of data, storage of data and instructions for generating distance measurements and the related data, portioning of electrical power from a power element, as well as user input controls and/or user interfaces for displaying distance measurements and/or other data.

Turning to FIGS. 7A and 7B, diagrams of multi-spectral laser rangefinders are illustrated (e.g., a multi-spectral laser rangefinder 700a is illustrated in FIG. 7A and a multi-spectral laser rangefinder 700b is illustrated in FIG. 7B) which may be or share aspects with the multi-spectral laser rangefinder module 500 of FIGS. 5A and 5B. As shown, a plurality of laser elements, such as laser elements 710a and 710b, may each include a laser driver such as laser drivers 712a and 712b for supplying current at specific wavelengths and power output to a corresponding laser diode 714a or 714b or other laser source each generating an emitted laser 711a or 711b modulated at different known frequencies. For instance, the emitted laser 711a may be a green or other daylight visible laser while the emitted laser 711b may be infrared, near-infrared, or other wavelength laser. It should be noted that electrical power may be supplied to the laser drivers 712a and 712b via a power element 740 (e.g., battery, grid-tied electrical power, or the like). A collimator 716a or 716b may be included for focusing light from the laser diode 714a or 714b respectively in generating the narrow beam of the emitted lasers 711a and 711b. The emitted lasers 711a and 711b may be aimed at a target 742 each generating a corresponding reflected light input 721a or 721b directed back toward a corresponding receiver element 720a or 720b.

A bandpass filter 722a and 722b included in each respective receiver element 720a and 720b may filter out noise influences at out of band frequencies but allow in band reflected light inputs 721a and 721b through to a corresponding sensing element 726a and 726b. The bandpass filter 722a and 722b may be calibrated to account for phase shifts. It should be noted that the bandpass filters 722a and 722b may be configured for the different spectral frequencies of reflected light inputs such as the reflected light inputs 721a and 721b. Further in the receive elements 720a and 720b, a collimator 724a or 724b may focus the reflected light inputs 721a or 721b to the corresponding sensing element 726a or 726b. The sensing elements 726a and 726b may receive the reflected light inputs 721a and 721b and convert the light to corresponding electrical input signals. The sensing elements 726a and 726b may each further be or include a photodetector 728a or 728b (e.g., one or more avalanche photodiodes, avalanche photodiode arrays, silicon photomultipliers (SiPM), and/or other like photodetector sensors for sensing the reflected light inputs 721a or 721b). The SiPM may, in some embodiments, be or include the MICROFC-10010 SiPM publically available from ON Semiconductor®. In some embodiments, the sensing elements 726a or 726b may likewise include a signal amplifier 730a or 730b (e.g., a transimpedance amplifier or the like) to amplify the input signals.

The receiver elements 720a and 720b may further include a gain control element 732a or 732b for varying the gain of the sensing elements 726a and 726b to appropriate levels for receiving reflected light inputs 721a and 721b and compensating for the change in amplitudes due to the attenuation of light signals of the modulated emitted lasers 711a and 711b and the corresponding reflected light inputs 721a and 721b. It should be noted that the varying of gain to the sensing elements 726a and 726b may be achieved in different ways. In FIGS. 7A and 7B, the gain control elements 732a and 732b may be or include programmable gain amplifiers (PGA) coupled to the signal amplifiers 730a or 730b for purposes of gain control. In other embodiments, such as the gain control elements 632a and 632b of FIGS. 6A and 6B, the gain to the sensing elements may be adjusted by changing the bias voltage to the photodetector (e.g., photodetector 628a and 628b of FIGS. 6A and 6B).

Referring to FIG. 7A, a clock 744 may couple to the laser elements 710a and 710b and a phase detector 746 such that timing of the detected phase corresponding to the each emitted laser 711a and 711b may be known. Likewise, the input signals from the receiver elements 720a and 720b may be communicated with the phase detector 746. Phase data corresponding to the emitted lasers 711a and 711b and corresponding input signals may further be communicated with a processing element 748. The processing element 748, having one or more processors, may determine differences in phases and thereby calculate distance measurements (e.g., via method 1000 of FIG. 10).

In some embodiments, such as with the multi-spectral laser rangefinder 700b illustrated in FIG. 7B, a clock 744 may couple with each respective one of the laser elements 710a and 710b which may further couple with a phase detector 746. In such embodiments, the clocks 744 may be synchronous in determining the timing associated with the detected phase of each emitted laser 711a and 711b. The input signals from the receiver elements 720a and 720b may be communicated with the respective one of the phase detector 746 associated with the receiver element 720a or 720b. Phase data corresponding to the emitted lasers 711a and 711b and corresponding input signals may further be communicated with a processing element 748. The processing element 748, having one or more processors, may determine differences in phases and thereby calculate distance measurements (e.g., via method 1000 of FIG. 10).

Referring to FIGS. 7A and 7B, adjustments to the calculation of distance measurement may be made based on other available data. For instance, the ambient light data and waveform data (e.g., data relating to the waveform shape and amplitude of the input signal) from the sensing elements 726a and 726b may be communicated to the processing element 748 and may be compensated for in the calculation of distance measurements. Likewise, a temperature sensor 750 may optionally be include to supply the processing element 748 with temperature data allowing for temperature (e.g., environment, lasers, and/or associated circuitry temperatures) to be compensated for in the calculation of distance measurements. In some embodiments, the gain levels may be considered in calculations of distance measurements.

Still referring to FIGS. 7A and 7B, the processing element 748 may connect to a memory element 752 having one or more non-transitory memories. The memory element 752 may store distance measurements as well as instructions relating to calculating such distance measurements.

Still referring to FIGS. 7A and 7B, the multi-spectral laser rangefinder 700a (FIG. 7A) and the multi-spectral laser rangefinder 700b (FIG. 7B) may, in some embodiments, optionally include a user interface 754 (e.g., a graphical user interface, speakers for audio feedback, or the like) for communicating distance measurements and/or other data to a user. Likewise, the multi-spectral laser rangefinder 700a (FIG. 7A) and the multi-spectral laser rangefinder 700b (FIG. 7B) may optionally include a set of user input controls 756 (e.g., buttons or like controls) providing the user the ability to control aspects of the multi-spectral laser rangefinder 700a (FIG. 7A) or the multi-spectral laser rangefinder 700b (FIG. 7B). For instance, the user input controls 756 may allow input from a user to turn the multi-spectral laser rangefinder 700a (FIG. 7A) or the multi-spectral laser rangefinder 700b (FIG. 7B) on or off, select from menus, or the like. The user interface 754 and user input controls 756 may, for instance, be included in a stand-alone laser rangefinder in keeping with the present disclosure such as the stand-alone multi-spectral laser rangefinder 900 of FIGS. 9A-9D.

Still referring to FIGS. 7A and 7B, the multi-spectral laser rangefinder 700a (FIG. 7A) and the multi-spectral laser rangefinder 700b (FIG. 7B) may, in other embodiments, optionally be included as a module in a host device 758. For instance, the multi-spectral laser rangefinder 700a (FIG. 7A) or the multi-spectral laser rangefinder 700b (FIG. 7B) may be built into a utility locator device which, from sensed magnetic fields, may be configured to determine and map utility line positions which may be in the ground. Additional information regarding utility locator devices may be found in the aforementioned incorporated applications as well as with the range finding utility locator device 1200 of FIGS. 12A-12D, range finding utility locator device 1400 of FIG. 14, or range finding utility locator device 1500 of FIG. 15. In some such embodiments, various resources may be shared between the host device and multi-spectral laser rangefinder embodiment. For instance, some such shared resources may include, but should not be limited to, elements responsible for processing of data, storage of data and instructions for generating distance measurements and the related data, portioning of electrical power from a power element, as well as user input controls and/or user interfaces for displaying distance measurements and/or other data.

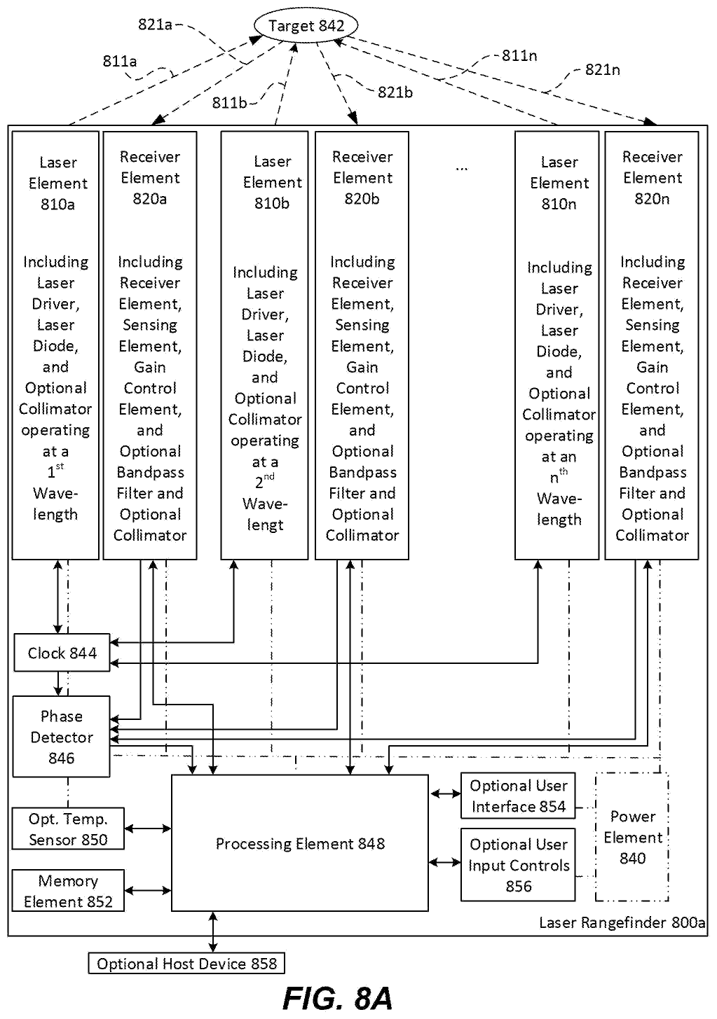

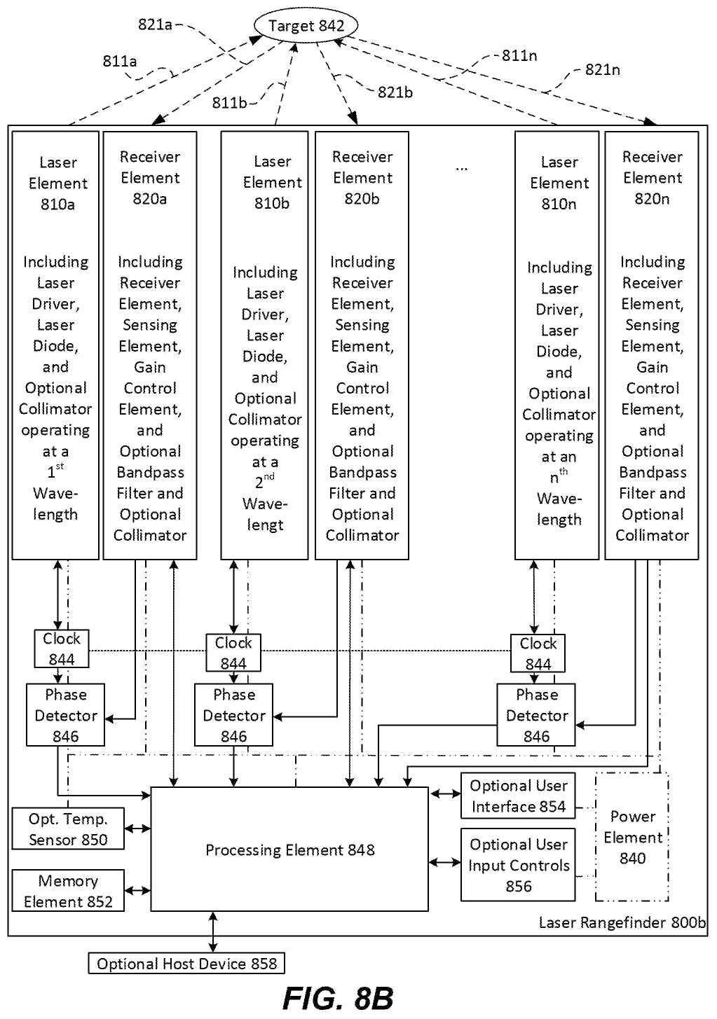

It should be noted that in daylight visible laser rangefinders and multi-spectral laser rangefinders of the present disclosure, the embodiments may include any number of laser element and corresponding receiver element pairings. Turning to FIGS. 8A and 8B, diagrams of multi-spectral laser rangefinders are illustrated (e.g., a multi-spectral laser rangefinder 800a is illustrated in FIG. 8A and a multi-spectral laser rangefinder 800b is illustrated in FIG. 8B) in keeping with the present disclosure. The multi-spectral laser rangefinder 800a of FIG. 8A and the multi-spectral laser rangefinder 800b of FIG. 8B are illustrated having a plurality of laser elements 810a, 810b, to 810n and a plurality of corresponding receiver elements 820a, 820b, to 820n. Each laser element 810a, 810b, to 810n may generate an emitted laser 811a, 811b, to 811n. In some embodiments, each emitted laser 811a, 811b, to 811n may emit a green or other daylight visible laser as described in conjunction with the emitted laser 211 of FIG. 2 or emitted laser 311 of FIG. 3. In other embodiments, the different emitted laser 811a, 811b, to 811n may each be at different wavelengths. In such multi-spectral laser rangefinder embodiments, one such emitted laser 811a, 811b, to 811n may be a daylight visible laser. Each laser element 810a, 810b, to 810n may include a laser driver (e.g., the laser driver 212 of FIG. 2, the laser driver 312 of FIG. 3, the laser drivers 612a and 612b of FIGS. 6A and 6B, or the laser drivers 712a and 712b of FIGS. 7A and 7B) for supplying current at specific wavelengths and power output to a corresponding laser diode (e.g., the laser diode 214 of FIG. 2, the laser diode 314 of FIG. 3, the laser diodes 614a and 614b of FIGS. 6A and 6B, or the laser diodes 714a and 714b of FIGS. 7A and 7B) or other laser source, further passing through a collimator (e.g., the collimator 216 of FIG. 2, the collimator 316 of FIG. 3, the collimators 616a and 616b of FIGS. 6A and 6B, or the collimators 716a and 716b of FIGS. 7A and 7B), each generating the emitted lasers 811a, 811b, to 811n modulated at different known frequencies. The emitted lasers 811a, 811b, to 811n may be aimed at a target 842 each generating a corresponding reflected light input 821a, 821b, to 821n directed back toward a corresponding receiver element 820a, 8201b, to 820n.

Each corresponding receiver element 820a, 820b, to 820n, receiving reflected light inputs 821a, 821b, to 821n, may include an optional bandpass filter (e.g., the bandpass filter 222 of FIG. 2, the bandpass filter 322 of FIG. 3, the bandpass filters 622a and 622b of FIGS. 6A and 6B, or the bandpass filters 722a and 722b of FIGS. 7A and 7B) and optional collimator (e.g., the collimator 224 of FIG. 2, the collimator 324 of FIG. 3, the collimators 624a and 624b of FIGS. 6A and 6B, or the collimators 724a and 724b of FIGS. 7A and 7B) for filtering and focusing reflected light inputs 821a, 821b, to 821n to sensing elements (e.g., the sensing element 220 of FIG. 2, the sensing element 320 of FIG. 3, the sensing elements 620a and 620b of FIGS. 6A and 6B, or the sensing elements 720a and 720b of FIGS. 7A and 7B). The gain to each sensing element may be adjusted by a gain control element (e.g., the gain control element 232 of FIG. 2, the gain control element 332 of FIG. 3, the gain control elements 632a and 632b of FIGS. 6A and 6B, or the gain control elements 732a and 732b of FIGS. 7A and 7B) to compensate for the attenuation of amplitudes of light signals of the modulated emitted lasers 811a, 811b, to 811n and the corresponding reflected light inputs 821a, 821b, to 821n. In some embodiments, the sensing element may be or include a SiPM (e.g., the MICROFC-10010 SiPM publically available from ON Semiconductor®), avalanche photodiode, an array of SiPMs or avalanche photodiodes, or other like photodiode which may generate input signals corresponding to the reflected light inputs 821a, 821b, to 821n.

Referring to FIG. 8A, a clock 844 may couple to the laser elements 810a, 810b, to 810n and a phase detector 846 such that timing of the detected phase corresponding to each emitted laser 811a, 811b, to 811n may be known. Likewise, the input signals from the receiver element 820a, 820b, to 820n may be communicated with the phase detector 846. Phase data corresponding to the emitted lasers 811a, 811b, to 811n and corresponding input signals may further be communicated with a processing element 848. The processing element 848, having one or more processors, may determine differences in phases and thereby calculate distance measurements (e.g., via method 1000 of FIG. 10).

In some embodiments, such as with the multi-spectral laser rangefinder 800b illustrated in FIG. 8B, a clock 744 may couple with each respective one of the laser elements 810a and 810b and other laser elements through to the laser element 810n which may each further couple with a phase detector 846. In such embodiments, the clocks 844 may be synchronous in determining the timing associated with the detected phase of each emitted laser 811a, 811b, and other emitted lasers through to the laser 811n. The input signals from the receiver elements 820a and 820b as well as from other receiver elements through to the receiver element 820n may be communicated with the respective ones of the phase detectors 746 associated with the receiver elements 820a, 820b, or other receiver elements through to the receiver element 820n. Phase data corresponding to the emitted lasers 811a, 811b, or other emitted laser through to the emitted laser 811n and corresponding input signals may further be communicated with a processing element 848. The processing element 848, having one or more processors, may determine differences in phases and thereby calculate distance measurements (e.g., via method 1000 of FIG. 10).

Referring to FIGS. 8A and 8B, adjustments to the calculation of distance measurement may be made based on other available data. For instance, the ambient light data and waveform data (e.g., data relating to the waveform shape and amplitude of the input signal) from the sensing elements may be communicated to the processing element 848 and may be compensated for in the calculation of distance measurements. Likewise, a temperature sensor 850 may optionally be included to supply the processing element 848 with temperature data allowing for temperature (e.g., environment, lasers, and/or associated circuitry temperatures) to be compensated for in the calculation of distance measurements. In some embodiments, the gain levels may be considered in calculations of distance measurements.

Still referring to FIGS. 8A and 8B, the processing element 848 may connect to a memory element 852 having one or more non-transitory memories. The memory element 852 may store distance measurements as well as instructions relating to calculating such distance measurements.

Still referring to FIGS. 8A and 8B, the laser rangefinder 800a (FIG. 8A) and the laser rangefinder 800b (FIG. 8B) may, in some embodiments, optionally include a user interface 854 (e.g., a graphical user interface, speakers for audio feedback, or the like) for communicating distance measurements and/or other data to a user. Likewise, the laser rangefinder 800a (FIG. 8A) and the laser rangefinder 800b (FIG. 8B) may optionally include a set of user input controls 856 (e.g., buttons or like controls) providing the user the ability to control aspects of the laser rangefinder 800a (FIG. 8A) or the laser rangefinder 800b (FIG. 8B). For instance, the user input controls 856 may allow input from a user to turn the laser rangefinder 800a of FIG. 8A or the laser rangefinder 800b of FIG. 8B on or off, select from menus, or the like. The user interface 854 and user input controls 856 may, for instance, be included in a stand-alone laser rangefinder in keeping with the present disclosure such as the stand-alone multi-spectral laser rangefinder 900 of FIGS. 9A-9D.

Still referring to FIGS. 8A and 8B, the laser rangefinder 800a or the laser rangefinder 800b may, in other embodiments, optionally be included as a module in a host device 858. For instance, the laser rangefinder 800a of FIG. 8A or the laser rangefinder 800b of FIG. 8B may be built into a utility locator device which may, from sensed magnetic fields, determine and map utility line positions which may be in the ground. Additional information regarding utility locator device may be found in the aforementioned incorporated applications as well as with the range finding utility locator device 1200 of FIGS. 12A-12D, range finding utility locator device 1400 of FIG. 14, or range finding utility locator device 1500 of FIG. 15. In some such embodiments, various resources may be shared between the host device and multi-spectral laser rangefinder embodiment. For instance, some such shared resources may include, but should not be limited to, elements responsible for processing of data, storage of data and instructions for generating distance measurements and the related data, portioning of electrical power from a power element, as well as user input controls and/or user interfaces for displaying distance measurements and/or other data.

Turning to FIGS. 9A-9D, a stand-alone multi-spectral laser rangefinder 900 in keeping with the present disclosure is illustrated. The stand-alone multi-spectral rangefinder 900 may include a multi-spectral laser rangefinder module 910 which may be or share aspects with the multi-spectral laser rangefinder module 500 of FIGS. 5A and 5B, the multi-spectral laser rangefinder 600a of FIG. 6A, the multi-spectral laser rangefinder 600b of FIG. 6B, the multi-spectral laser rangefinder 700a of FIG. 7A, and/or the multi-spectral laser rangefinder 700b of FIG. 7B. The stand-alone multi-spectral laser rangefinder 900 may have a front housing 920 and back housing 930 that, in assembly, may secure together encasing the multi-spectral laser rangefinder module 910 secured therein. The front housing 920 may have an opening through which emitted lasers (e.g., emitted lasers 911a and 911b of FIG. 9C) and the reflected light inputs from a target (e.g., reflected light inputs 921a and 921b from target 940 of FIG. 9C) may travel to/from the outside environment.

Referring to FIG. 9B, the stand-alone multi-spectral laser rangefinder 900 may include a battery 950 or other power source. The battery 950 (or other power source) may be included for portioning of electrical power to the various powered components of the stand-alone multi-spectral laser rangefinder 900.

Turning to FIG. 9D, the stand-alone multi-spectral laser rangefinder 900 may optionally include a user interface 960 (e.g., a graphical user interface or the like) for communicating distance measurements and/or other data to a user. Likewise, the stand-alone multi-spectral laser rangefinder 900 may optionally include a set of user input controls 970 (e.g., buttons or like controls) providing the user the ability to control aspects of the stand-alone multi-spectral laser rangefinder 900. For instance, the user input controls 970 may allow input from a user to turn the stand-alone multi-spectral laser rangefinder 900 on and off, select from menus, or the like.

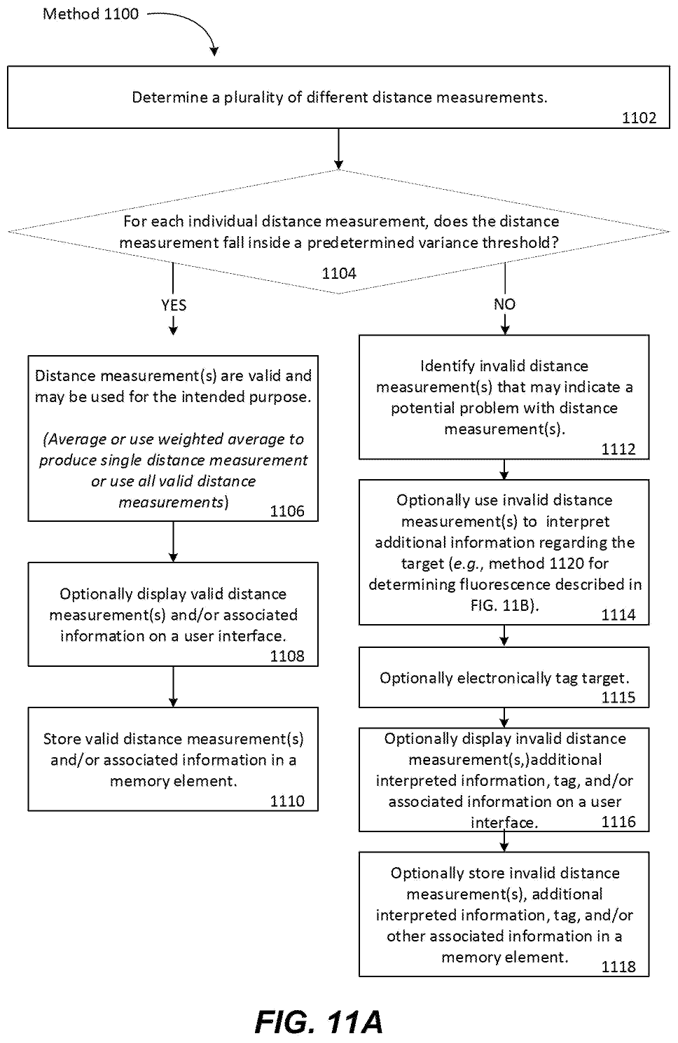

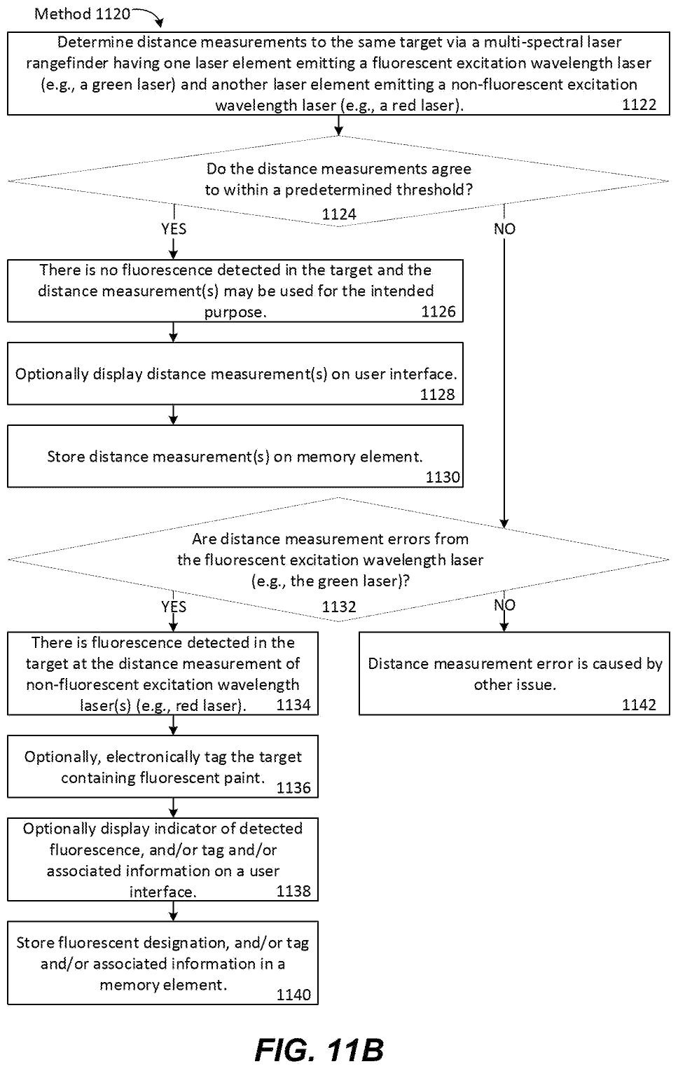

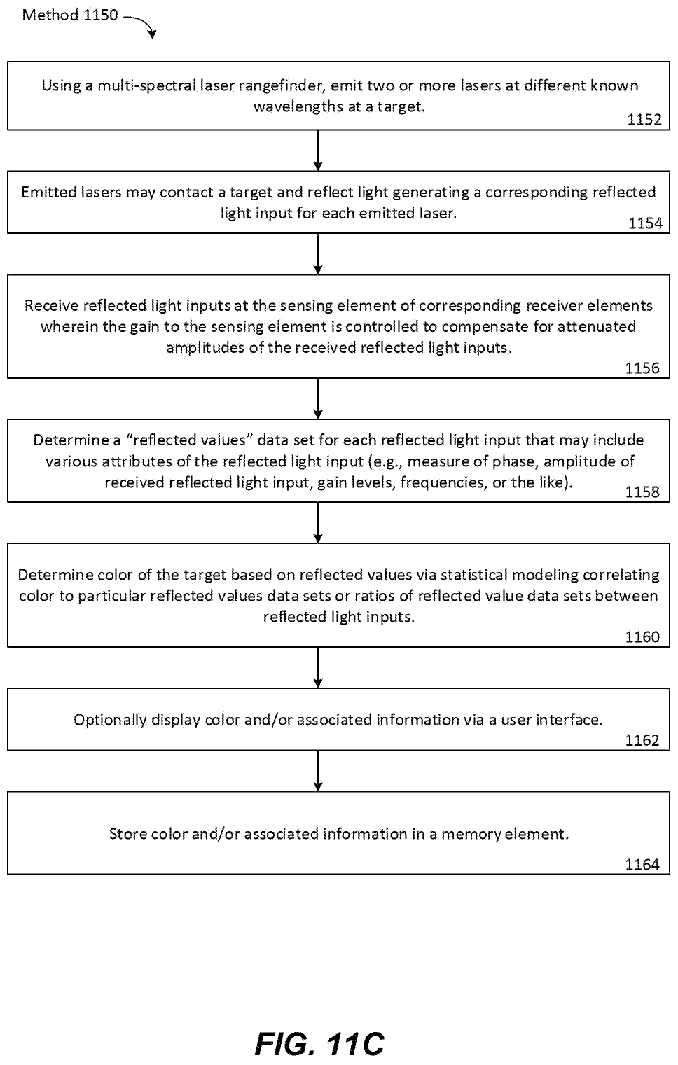

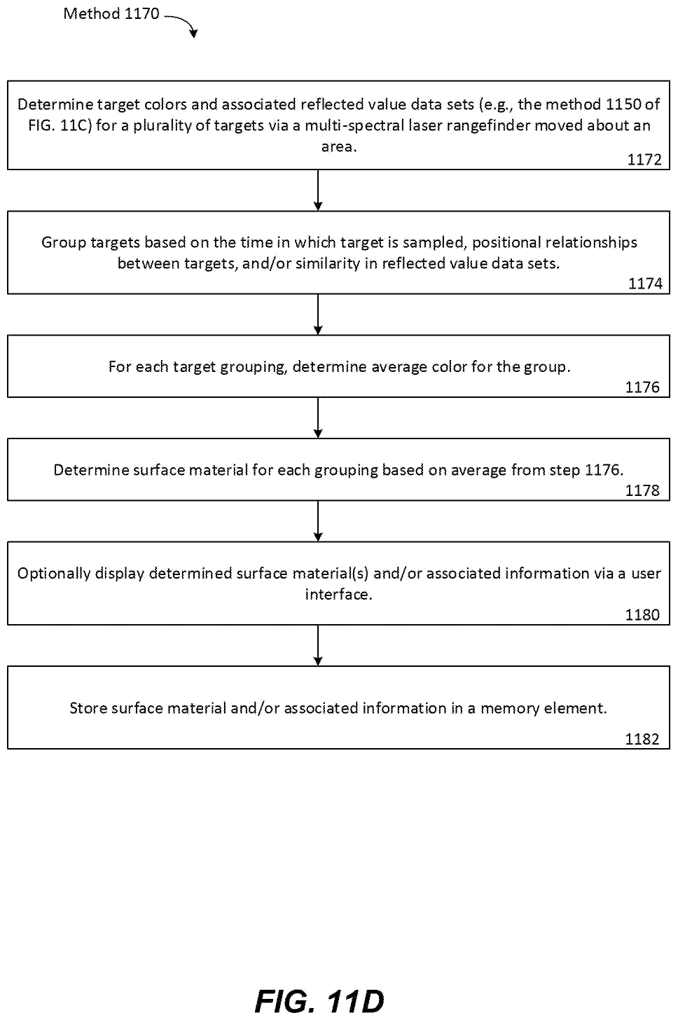

Turning to FIG. 10, a method 1000 is illustrated for range finding using a laser rangefinder of the present disclosure such as the daylight visible laser rangefinder module 100 of FIGS. 1A and 1B, the daylight visible laser rangefinder 200 of FIG. 2, the daylight visible laser rangefinder 300 of FIG. 3, the multi-spectral laser rangefinder module 500 of FIGS. 5A and 5B, the multi-spectral laser rangefinder 600a of FIG. 6A, the multi-spectral laser rangefinder 600b of FIG. 6B, the multi-spectral laser rangefinder 700a of FIG. 7A, the multi-spectral laser rangefinder 700b of FIG. 7B, the laser range finding utility locator device 1200 of FIGS. 12A-12D, or other rangefinder described herein. In a first step 1005, the method 1000 may include emitting one or more continuous wave lasers modulated at a known frequency or frequencies. One emitted laser may be a daylight visible laser in step 1005. In a step 1010, the emitted laser(s) may contact a target and reflect light generating “reflected light input(s).” In an optional step 1015, out of band light may be filtered out at the receiver element. In a step 1020, reflected light input(s) may be received at sensing element(s) in the receiver element(s) that may include one or more avalanche photodiodes, avalanche photodiode arrays, silicon photomultiplier (SiPM), and/or like photodetector sensors to appropriate levels. The SiPM may, in some embodiments, be or include the MICROFC-10010 SiPM publically available from ON Semiconductor®. In a step 1025, the gain of a sensing element may be adjusted to achieve appropriate amplitude levels. In a step 1030, input signal(s) corresponding to the reflected light input(s) may be generated. In a step 1035, the phase(s) of emitted laser(s) and input signal(s) may be measured. It should be noted that in some applications, a phase shift may occur associated one or more lasers. In an optional step 1037 a phase shift correction may be applied based on phase shift(s) associated with target attributes (e.g., target fluorescence via the method 1120 of FIG. 11B, target color via the method 1150 of FIG. 11C, target material via the method 1170 of FIG. 11D, or the like). In a step 1040, measured/corrected phases of each emitted laser and corresponding input signal may be compared. In a step 1045, the method 1000 may calculate distance measurement(s) based on differences in measured/corrected phases of each emitted laser and corresponding input signal. For instance, a distance measurement d_{target} may be calculated wherein

$${d}_{target} = \frac{∅}{2 π} * {t}_{period} * c$$

wherein

$$\frac{∅}{2 π}$$

is the phase normalized to one period of the modulation frequency, t_{period} is the time of one period of the modulation frequency, and c is the speed of light. In an optional step 1050, calculated distance measurements may be adjusted based on ambient light levels, signal noise, gain settings, waveform shape(s) and/or amplitude(s) of the input signal(s), temperature, or the like.

In an optional step 1055 wherein multiple distance measurements are calculated, the multiple distance measurements may be evaluated to optionally determine or select or otherwise determine a single calculated distance measurement as well as optionally determine additional information regarding the target/environment. For instance, such evaluation may, in some embodiments, sort distance measurements that are “valid” and “invalid” wherein additional target/environment information may be interpreted from the invalid distance measurement responses (e.g., detecting of fluorescence present on the ground surface for utility locating via range finding utility locator device of the present disclosure). Further, in some embodiments this evaluation may include an average or weighted average to be calculated. The weighted average may, for example, be based on potential error or other quality/confidence metric or based on other contributing information influencing the distance measurement. In some embodiments, a method, such as the method 1100 of FIG. 11A, may be used to evaluate distance measurements. In yet further embodiments, all distance measurements may be used. For instance, in applications further incorporating real-time or near real-time position, orientation, and/or pose information (e.g., that from positioning system 1260 of the range finding utility locator device 1200 of FIG. 12D), the target locations based on different distance measurements may be fully resolved.

Still referring to method 1000 of FIG. 10, in an optional step 1060 one or more images of the distance measurement target may be generated. In another optional step 1062, reflected light input(s) and/or associated input signal(s) may be compared to determine various target attributes. For instance, the optional step 1062 may be used to determine target fluorescence via the method 1120 of FIG. 11B, color via the method 1150 of FIG. 11C, target material via the method 1170 of FIG. 11D, or the like. In a step 1065 distance measurement(s) and/or associated information may be stored in a memory element having one or more non-transitory memories (e.g., memory element 252 of FIG. 2, memory element 352 of FIG. 3, memory element 652 of FIG. 6A or 6B, or memory element 752 of FIG. 7A or 7B). In an optional step 1070, distance measurement(s) and/or associated information may be communicated. For instance, distance measurement(s) and/or associated information may be displayed on a user interface (e.g., user interface 254 of FIG. 2, user interface 354 of FIG. 3, user interface 654 of FIGS. 6A and 6B, user interface 754 of FIGS. 7A and 7B, user interface 960 of FIG. 9D) and/or communicated to one or more other host devices (e.g., host device 258 of FIG. 2, host device 358 of FIG. 3, host device 658 of FIGS. 6A and 6B, or host device 758 of FIGS. 7A and 7B) or other communicatively coupled devices (e.g., smart phone, computer, tablet, other system device via Bluetooth, Wi-Fi, or the like). It should further be noted that the method 1000 of FIG. 10 may be a continually repeating method. In some method embodiments, the information of each cycle may be used to inform gain adjustments or the like in subsequent method cycle.

Turning to FIG. 11A, an exemplary method 1100 for evaluating multiple distance measurements is described. In the method 1100, a first step 1102 may include determining multiple distance measurements via a laser rangefinder of the present disclosure having a plurality of laser element/receiver element pairings to emit lasers at different wavelengths (e.g., the multi-spectral laser rangefinder module 500 of FIGS. 5A and 5B, the multi-spectral laser rangefinder 600a of FIG. 6A, the multi-spectral laser rangefinder 600b of FIG. 6B, the multi-spectral laser rangefinder 700a of FIG. 7A, or the multi-spectral laser rangefinder 700b of FIG. 7B). This may be achieved via method 1000 of FIG. 10 when carried out via a laser rangefinder embodiment having a plurality of laser element/receiver element pairings. Likewise, in some alternative method embodiments, such a method may instead or additionally compare subsequently produced distance measurements. In a step 1104, a decision may be made as to whether each individual distance measurement falls inside a predetermined variance threshold. As used herein, the term “variance threshold” may refer to a range of distance measurements wherein distance measurements that fall outside the acceptable range may indicate an invalid or incorrect distance measurement due to some error. The variance threshold may, for instance, be a percentage difference between distance measurements, a maximum or minimum in difference in total distance measurement, or other like metric. If the distance measurement falls inside the predetermined variance threshold, the method may proceed to step 1106 wherein the distance measurements are considered valid distance measurements and may be used for the intended purpose depending on the particular application. For instance, in some method embodiments, the valid distance measurements may be averaged or a weighted average may be applied. In other embodiments, all valid distance measurements may apply and be used. Turning to optional step 1108, valid distance measurements and/or associated information may be displayed on a user interface. In a step 1110, the valid distance measurements and/or associated information may be stored in a memory element having one or more non-transitory memories.

From decision step 1104, if one or more distance measurements fall outside the predetermined variance threshold the method may proceed to step 1112. In the step 1112, the one or more distance measurements may be considered invalid distance measurements and the invalid measurement(s) may be used to identify a potential problem with the distance measurement(s). For instance, the invalid distance measurement(s) may indicated a problematic target surface or malfunction with the corresponding laser element/receive element pairing or the like. In an optional step 1114, invalid distance measurement(s) may be used to interpret additional information regarding the target. For instance, the step 1114 may be or include the method 1120 for determining fluorescence described in FIG. 11B. In another optional step 1115, the target may be electronically tagged based on information from steps 1112 or step 1114. For instance, the target may be electronically tagged as being associated with invalid distance measurements or, in some embodiments, as having fluorescence or the like. The tag may include a geolocation or other position as well as user input and/or other data included in a data set associated with the tag. In an optional step 1116, the invalid distance measurement(s), additional interpreted information, electronic tag, and/or associated information may be displayed on a user interface. In another optional step 1118, the invalid distance measurement(s), additional interpreted information, electronic tag, and/or associated information may be stored in a memory element having one or more non-transitory memories.

Turning to FIG. 11B, a method 1120 for determining fluorescence in a target is described. In a step 1122, a multi-spectral laser rangefinder in keeping with the present disclosure (e.g., the multi-spectral laser rangefinder module 500 of FIGS. 5A and 5B, the multi-spectral laser rangefinder 600a of FIG. 6A, the multi-spectral laser rangefinder 600b of FIG. 6B, the multi-spectral laser rangefinder 700a of FIG. 7A, or the multi-spectral laser rangefinder 700b of FIG. 7B) having at least one laser element emitting a substantially fluorescent excitation wavelength laser (e.g., a green laser) and at least one laser element emitting a substantially non-fluorescent excitation wavelength laser (e.g., a red laser) may each determine a distance measurement to the same target. It should be noted that the method 1120 may require at least one laser (which may be a green laser) operating at a wavelength that may excite the fluorescent target (referred to herein as fluorescent excitation wavelength lasers). The excitation of the fluorescent target may cause a fluorescence delay wherein the reflected light returns at another, typically longer, wavelength. Because the fluorescence delay may cause a phase shift, the resulting distance measurement may be inaccurate. Likewise, one or more other lasers (which may be a red laser) may operate at wavelengths that do not excite the fluorescence of the target (referred to herein as substantially non-fluorescent excitation wavelength lasers) to determine the distance in such applications where the target is fluorescent. It should be noted that though a red laser is provided as a “non-fluorescent excitation wavelength laser,” in use a red laser may result in some fluorescent excitation though, in most applications, less so than the exemplary green laser.

In a decision step 1124, it may be determined whether the distance measurements agree to within a predetermined threshold. For instance, some small variance in distance measurements may be tolerated but larger differences in distance measurements may indicate a problem with one or more of the generated distance measurements. Such a threshold may account for small normally occurring variances in distance measurements but exclude larger variances that may indicate a problem. Turning to step 1126, if the distance measurements do agree to within the predetermined threshold, no fluorescence has been detected in the target and the distance measurement(s) may be used for the intended purpose. In a step 1128, the distance measurement(s) may optionally be displayed on a user interface. In a step 1130, distance measurement(s) may be stored on a memory element having one or more non-transitory memories.

From the decision step 1124, if distance measurements do not agree to within the predetermined threshold the method 1120 may proceed to another decision step 1132. In the decision step 1132, it may be determined if the error is from the fluorescent excitation wavelength laser (e.g., a green laser). For instance, such a determination may be based on an excessive change in measurement from prior measurements and/or based on the determined distance measurement falling outside a predetermined range of possible or probable distance measurements. In a step 1134, fluorescence may be detected in the target wherein the distance measurement of a substantially non-fluorescent excitation wavelength laser (e.g., a red laser) may be the valid distance measurement(s). If multiple distance measurements are valid, all valid distance measurements may apply and be used. In an optional step 1136, the fluorescent target may be electronically tagged. For instance, in locating and mapping utility lines it may be useful to detect fluorescent paint markings on the ground. The various range finding utility locator devices herein (e.g., range finding utility locator device 1200 of FIGS. 12A-12D, range finding utility locator device 1400 of FIG. 14, or range finding utility locator device 1500 of FIG. 15) may be configured to detect such fluorescent markings for purposes of utility line locating and mapping. Range finding utility locator devices of the present disclosure may electronically tag such targets to indicate the presence of possible fluorescent paint at the target's geolocation. In an optional step 1138, an indicator of detected fluorescence and/or tag and/or associated information may be displayed on a user interface. In a step 1140, the fluorescent designation of the target and/or tag and/or associated information may be stored in a memory element having one or more non-transitory memories.

From the decision step 1132, if the distance measurement error is not from the fluorescent excitation wavelength laser (e.g., green laser), the method 1120 may proceed to step 1142. In the step 1142, the distance measurement error may be determined to be caused by a different issue.

Turning to FIG. 11C, a method 1150 for determining target color is described. In a step 1152, two or more lasers at different known wavelengths are emitted at a target using a multi-spectral laser rangefinder of the present disclosure (e.g., the multi-spectral laser rangefinder module 500 of FIGS. 5A and 5B, the multi-spectral laser rangefinder 600a of FIG. 6A, the multi-spectral laser rangefinder 600b of FIG. 6B, the multi-spectral laser rangefinder 700a of FIG. 7A, or the multi-spectral laser rangefinder 700b of FIG. 7B). In a step 1154, the emitted lasers may contact a target and generate a corresponding reflected light input for each emitted laser. In a step 1156, the reflected light inputs may be received at the sensing elements of corresponding receiver elements wherein the gain to the sensing elements is controlled to compensate for attenuated amplitudes of the received reflected light inputs. In a step 1158, a “reflected values” data set may be determined for each reflected light input that may include various attributes of the reflected light input (e.g., a measure of phase, amplitude of the received reflected light input, gain level, frequency, or the like). In a step 1160, the color of the target may be determined based on reflected values via statistical modeling correlating color to particular reflected values data sets or ratios of reflected value data sets between reflected light inputs. In an optional step 1162, the color and/or associated information may be displayed via a user interface. In a step 1164, the color and/or associated information may be stored in a memory element having one or more non-transitory memories.

Turning to FIG. 11D, a method 1170 for determining the surface material via a multi-spectral laser rangefinder of the present disclosure (e.g., the multi-spectral laser rangefinder module 500 of FIGS. 5A and 5B, the multi-spectral laser rangefinder 600a of FIG. 6A, the multi-spectral laser rangefinder 600b of FIG. 6B, the multi-spectral laser rangefinder 700a of FIG. 7A, or the multi-spectral laser rangefinder 700b of FIG. 7B) is described. In a step 1172, the color of a plurality of targets and associated reflected value data sets may be determined via a multi-spectral laser rangefinder moved about an area. For instance, the step 1172 may include using the method 1150 of FIG. 11C on a plurality of targets along the ground or other surface. In a step 1174, the targets may be grouped based on the time in which the target is sampled, positional relationships between targets, and/or similarities in reflected value data sets. For instance, targets of one color may be grouped with other targets of the same color that occur in contiguous locations and/or sampled at subsequent times. In a step 1176, the average color for each group may be determined. In a step 1178, the surface material for groups may be determined. For instance, in the various range finding utility locator devices herein (e.g., range finding utility locator device 1200 of FIGS. 12A-12D, range finding utility locator device 1400 of FIG. 14, or range finding utility locator device 1500 of FIG. 15) a group having an average green color may be grass, a group having an average red color may be brick, and so on. In an optional step 1180, the surface material(s) and/or associated information may be displayed via a user interface. In an optional step 1182, the surface material(s) and/or associated information may be stored in a memory element having one or more non-transitory memory elements.

Turning to FIGS. 12A-12D, a range finding utility locator device 1200 is illustrated which may include a laser rangefinder, such as the laser rangefinder module 1210. The laser rangefinder module 1210 may be or include the daylight visible laser rangefinder 200 of FIG. 2, the daylight visible laser rangefinder 300 of FIG. 3, the multi-spectral laser rangefinder module 500 of FIGS. 5A and 5B, the multi-spectral laser rangefinder 600a of FIG. 6A, the multi-spectral laser rangefinder 600b of FIG. 6B, the multi-spectral laser rangefinder 700a of FIG. 7A, the multi-spectral laser rangefinder 700b of FIG. 7B, or other laser rangefinders described herein.

As further illustrated in FIG. 12D, the laser rangefinder of a range finding utility locator device in keeping with the present disclosure may include at least one daylight visible emitted laser. For instance, the laser rangefinder 1210 of the range finding utility locator device 1200 may emit a daylight visible emitted laser 1212. Further, the laser rangefinder 1210 of the range finding utility locator device 1200 may also emit a different wavelength emitted laser 1214.

Still referring to FIG. 12D, the laser range finding utility locator device 1200 may include a locator subsystem 1220 having one or more antennas 1222 and associated receiver circuitry 1224 to receive magnetic signals 1230 emitted from utility lines such as the utility line 1235 which may be in the ground. The locator subsystem 1220 having the receiver circuitry 1224 and one or more locator antennas 1222 (typically one or more antenna arrays) may be configured to determine positions and optionally map one or more utility lines such as the utility line 1235 based on received magnetic signals 1230. The locator antennas 1222 may typically be in the form of antenna coils having a wide bandwidth (e.g., from 10s of Hz to 500 kHz, or greater). Example antennas and associated locator elements and configurations that may be used in various embodiments are described in the incorporated applications. The receiver circuit 1224, may be or include various electronic circuit elements, such as amplifiers, buffers, impedance matching circuits, and/or filters or the like (not illustrated) which may be coupled to locator antennas 1222 to condition and amplify the output of locator antennas 1222. The receiver circuit 1224 may further include signal conditioners, analog-to-digital (A/D) converters, multiplexers for converting magnetic signals to corresponding electrical signals further provided to a processing element 1250 having one or more processors. Likewise, output from the laser rangefinder 1210, which may include distance measurement(s) and/or raw data for calculating distance measurement(s) may be provided to the processing element 1250. The distance measurement(s) that may result from emitted lasers 1212 and 1214 contacting a target 1240 may generate reflected light signals 1213 and 1215. In some embodiments, such as the range finding utility locator device 1200, a positioning system 1260 for determining geolocation, orientation, and/or pose may be included therein. For instance, the positioning system 1260 of the range finding utility locator device 1200 may include a global navigation satellite system (GNSS) 1262 (e.g., GPS, Beidou, GLONASS, QZSS, Galileo, or the like) and/or inertial navigation system (INS) 1264 (e.g., accelerometers, gyroscopic sensors, optical or mechanical ground tracking apparatuses, and/or stereo optical ground tracking apparatuses). The output from positioning system 1260 may further be provided to the processing element 1250. In application, the position, orientation, and pose output provided by the position system 1260 may be combined with distance measurements to targets acquired by the laser rangefinder 1210 to resolve locations of targets. Further, such locations may be correlated with utility locator information, including the positions and orientations of utility lines which may be in the ground, for purposes of mapping utility lines. In some embodiments, such as the range finding utility locator device 1200, one or more cameras 1270 may be included that may further capture one or more images of distance measurement targets, such as an image 1272 of target 1240. One or more images of distance measurement targets are further described via FIGS. 14 and 15 which may further be correlated with the position system information, laser rangefinder distance measurement(s), and utility locating information.

Still referring to FIG. 12D, the range finding utility locator device 1200 may further include a user interface and input element 1280 to receive input commands from a user and further communicate data relating to utility line positions, distance measurements, mapping information, and information related to distance measurements, utility line positions, and mapping information to a user (e.g., user 1402 of FIG. 14 or user 1502 of FIG. 15). For instance, the user interface and input element 1280 may be or include a graphical user interface, speakers for audio feedback, or the like for communicating utility locating and distance measurement information or related information to a user (e.g., user 1402 of FIG. 14 or user 1502 of FIG. 15). Likewise, the user interface and input element 1280 may be or include buttons, touch screens, or like controls providing the user (e.g., user 1402 of FIG. 14 or user 1502 of FIG. 15) the ability to input and control aspects of the range finding utility locator device 1200.

Still referring to FIG. 12D, the range finding utility locator device 1200 may include a memory element 1255 having one or more non-transitory memories to store instructions relating to determining positions and locations of the resulting positions as well as for storing instructions relating to calculating distance measurements and the resulting calculated distance measurements. A housing element 1290 (FIGS. 12A-12C) may encase electronics and other components associated with utility locating and included laser rangefinder 1210. A power element, such as battery 1295, may further be included for portioning of electrical power to the various powered elements of range finding utility locator device 1200.

In various embodiments, the laser range finding utility locator devices (e.g., laser range finding utility locator devices 1200) may be any of a variety of utility locator devices known or developed in the art including, for example, the various utility locator device embodiments disclosed in the incorporated applications for receiving magnetic field components of electromagnetic signals (e.g., the magnetic signals 1230 of FIG. 12D) emitted from flowing AC current in utility lines (e.g., the utility line 1235 FIG. 12D), and determining information about the associated utility. The laser rangefinder therein may further determine the distance to a target, generally along the ground surface such that, among other information, the laser range finding utility locator may determine a height above the ground relative to position and pose of utility line(s) in the ground.

From these multiple magnetic field sources, the laser range finding utility locator device may then determine, in multi-dimensional space (typically in three-dimensional space), the position and pose of each source. Examples of simultaneously receiving and processing multiple magnetic field signals from different sources are described in various of the incorporated applications. In an exemplary embodiment, the range finding utility locator devices may include a dodecahedral antenna array or other similar antenna arrays to receive and process multiple simultaneous signals and determine magnetic field tensor gradients associated with the source. Examples of signal processing circuitry and implementation details for determining positional information from received magnetic field signals in a range finding utility locator device, including with a dodecahedral antenna array or other similar antenna array configurations that provide multiple simultaneous signals usable to determine magnetic field tensor gradients associated with the source, are described in the various co-assigned incorporated patent and patent applications, including, for example, U.S. Pat. No. 10,031,253 issued Jul. 24, 2018 entitled GRADIENT ANTENNA COILS AND ARRAYS FOR USE IN LOCATING SYSTEMS as well as other of the incorporated applications.

In implementations with a dodecahedral antenna array or other similar or equivalent antenna array configurations (such as, for example, octahedral antenna arrays, multiple nested antenna arrays, and the like oriented to receive magnetic field signal information sufficient to calculate tensor data), the utility locator device may include hardware and software for determining magnetic field tensor values associated with the magnetic fields provided from the tracked distance measuring device and optionally one or more buried utilities or other conductors and may store this information in a non-transitory memory for subsequent processing or transmission to a post-processing computing device or system.

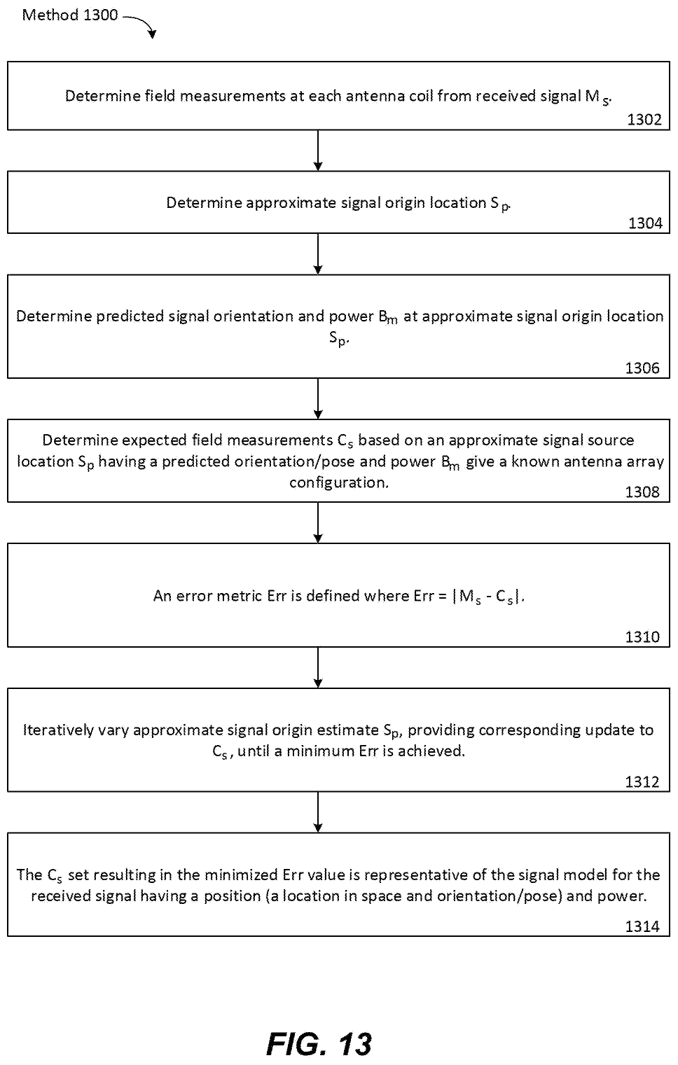

In some system embodiments, the range finding utility locator device may determine position data that includes a position and pose as well as a depth of a received signal associated with utility lines such as method embodiment 1300 as illustrated in FIG. 13. For example, at step 1302 of method 1300, magnetic field measurements of a received signal, which may be or may include voltage measurements, gradient tensor measurements, gradient vectors, b-field vectors and the like, may be determined from received signals at each antenna coil of the locator antenna array(s). In an exemplary embodiment, the antenna array(s) include a dodecahedral antenna array which includes twelve antenna coils mounted in a dodecahedral shape on a corresponding dodecahedral frame. This set of measurements by the antenna array is notated herein as Mₛ. In step 1304, an approximate signal origin location estimate in three dimensional space, notated herein as Sₚ may be determined using measurement set Mₛ from step 1302.

In some method embodiments, Mₛ values may be fit into or be used to determine values for a lookup table providing the approximate signal origin location Sₚ. The lookup table may, for example, be derived from inverse trigonometric relationships between measured b-field vectors with gradient vectors. In some embodiments, the angle between the magnetic field and the gradient of the magnitude may be calculated from measurement set Mₛ values. The resultant angle may be used with a lookup table to determine a magnetic latitude descriptive of the signal's source position relative to the utility locator. In other embodiments, rather than a lookup table, an approximate origin location estimate Sₚ may be calculated in step 1304. For example, Sₚ may be calculated from the inverse trigonometric relationship between measured b-field vectors with gradient vectors.

In step 1306, a predicted signal source orientation and power, notated herein as Bₘ, may be determined based on approximate origin location Sₚ, at step 1304, and b-field values may be determined from signals at one or more antenna arrays. For instance, b-field values may be b-field measurements from a tri-axial antenna array or b-field estimates from a dodecahedral antenna array given an origin location Sₚ. In step 1308, a set of expected field measurements defined as Cₛ may be determined from the magnetic field model of a dipole signal at approximate signal source location Sₚ having a predicted orientation and power B_{M} given a known antenna array configuration, such as a dodecahedral antenna array. In step 1310, an error metric Err may be determined, where Err=|Mₛ−Cₛ|. In step 1312, the approximate signal origin estimate Sₚ may be iteratively varied, providing a corresponding update to Cₛ, until a minimum Err is achieved. In step 1314, the Cₛ set resulting in the minimized Err value may be determined, representative of the signal model for the received signal having a position (a location in space and orientation) and power.

In alternate method embodiments for determining the position of received signals, data from accelerometers, magnetometers, gyroscopic sensors, other inertial sensors and/or other similar sensor types, as well as additional global navigation sensors within the tracked distance measurement device, may be used to determine or refine position, which may include location and pose/orientation data. Such method embodiments may be used in, for example, utility locator devices or other signal detection/tracking devices with antennas or antenna arrays and processing circuitry that is unable to calculate gradient tensors, as an addition to devices that are unable to calculate gradient tensors, or where gradient tensor calculations are not used for signal processing. Such methods may be used to determine the origin location of the received signal or signals using, for example, steps 1302 and 1304 of method 1300 described in FIG. 13. Pose/orientation information may be determined through accelerometers, magnetometers, gyroscopic, and/or like sensors such as those which may be present in an inertial navigation system (e.g., INS 1264 of FIG. 12D). Such methods, including method embodiment 1300 of FIG. 13, may be implemented in real-time or in post processing at the range finding utility locator device or other system device.

Turning to FIG. 14, a range finding utility locator device 1400 is illustrated held by a user 1402. The range finding utility locator device 1400 may be or share aspects with the range finding utility locator device 1200 of FIGS. 12A-12D that may include a laser rangefinder 1410. The laser rangefinder 1410 may be or share aspects with the daylight visible laser rangefinder 200 of FIG. 2, the daylight visible laser rangefinder 300 of FIG. 3, the multi-spectral laser rangefinder module 500 of FIGS. 5A and 5B, the multi-spectral laser rangefinder 600a of FIG. 6A, the multi-spectral laser rangefinder 600b of FIG. 6B, the multi-spectral laser rangefinder 700a of FIG. 7A, the multi-spectral laser rangefinder 700b of FIG. 7B or other rangefinder described herein). The laser rangefinder 1410 may emit one or more emitted lasers 1412 that, upon contacting a target 1420, may reflect light such that each emitted laser 1412 may generate a corresponding reflected light input 1414. A distance measurement may be calculated as described with the method 1000 of FIG. 10 as well as with the various laser rangefinder embodiments disclosed herein. The range finding utility locator device 1400, equipped with a camera (e.g., such as the cameras 1270 of FIG. 12D), may generate an image of the ground location 1430 or other surface that includes the target 1420. Simultaneously, positioning information (e.g., such as that provided by the positioning system 1260 of FIG. 12D) may include geolocation information provided by GNSS 1440 as well as inertial navigation information (e.g., such as that provided by the INS 1264 of FIG. 12D). Likewise, the range finding utility locator device 1400 may sense magnetic field 1450 emitted by a utility line 1460 (or multiple utility lines simultaneously in some embodiments), for the purpose of determining and mapping the positions of utility line 1460. The position, orientation, and pose information provided by a positioning system (positioning system 1260 of FIG. 12D) may be used to resolve the geolocation of the target 1420 and the image of the ground location 1430 thereof. The position and orientation of utility lines as determined via the range finding utility locator device 1400, such as the utility line 1460, may also be correlated to target locations and images of those targets (e.g., the image of the ground location 1430 of target 1420).

Some laser range finding utility locator device embodiments of the present disclosure may generate multiple images of the rangefinder target. In some such embodiments, the images may overlap and the rangefinder target may be present in the overlap area.

Turning to FIG. 15, a range finding utility locator device 1500 is illustrated held by a user 1502. The range finding utility locator device 1500 may be or share aspects with the range finding utility locator device 1200 of FIGS. 12A-12D and may include a laser rangefinder 1510. The laser rangefinder 1510 may be or share aspects with the daylight visible laser rangefinder 200 of FIG. 2, the daylight visible laser rangefinder 300 of FIG. 3, the multi-spectral laser rangefinder module 500 of FIGS. 5A and 5B, the multi-spectral laser rangefinder 600a of FIG. 6A, the multi-spectral laser rangefinder 600b of FIG. 6B, the multi-spectral laser rangefinder 700a of FIG. 7A, the multi-spectral laser rangefinder 700b of FIG. 7B, or other rangefinders described herein. The laser rangefinder 1510 may emit one or more emitted lasers 1512 that, upon contacting a target 1520, may reflect light such that each emitted laser 1512 may generate a corresponding reflected light input 1514. A distance measurement may be calculated as described with the method 1000 of FIG. 10 as well as with the various laser rangefinder embodiments disclosed herein. The range finding utility locator device 1500, equipped with a pair of cameras (e.g., such as the cameras 1270 of FIG. 12D), may generate a pair of images of the ground locations 1530a and 1530b or other surface that includes the target 1520. As illustrated, the images of the ground locations 1530a and 1530b may overlap and the overlap area may include the target 1520. For instance, the images may be from a stereo optical ground tracker further used in tracking movement across the ground surface as described in U.S. Pat. No. 9,928,613, issued Mar. 27, 2018, entitled GROUND TRACKING APPARATUS, SYSTEMS, AND METHODS of the incorporated applications. Simultaneously, positioning information (e.g., such as that provided by the positioning system 1260 of FIG. 12D) may include geolocation information provided by GNSS 1240 as well as inertial navigation information (e.g., such as that provided by the INS 1264 of FIG. 12D). Also simultaneously, the range finding utility locator device 1500 may sense magnetic field 1550 emitted by a utility line 1560 (or multiple utility lines simultaneously in some embodiments), for the purpose of determining and mapping the positions of utility line 1560. The position, orientation, and pose information provided by a positioning system (positioning system 1260 of FIG. 12D), which may include stereo optical tracking information provided by overlapping images of ground locations 1530a and 1530b, may be used to resolve the geolocation of the target 1520 and the images 1530a and 1530b thereof. The position and orientation of utility lines as determined via the range finding utility locator device 1500, such as the utility line 1560, may also be correlated to target locations and images of those targets (e.g., the images of ground locations 1530a and 1530b of target 1520).

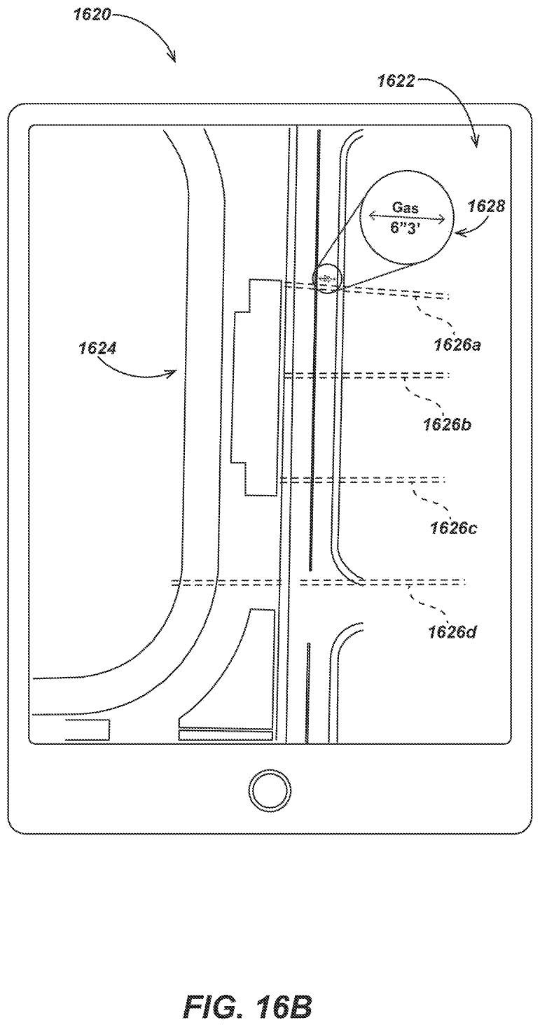

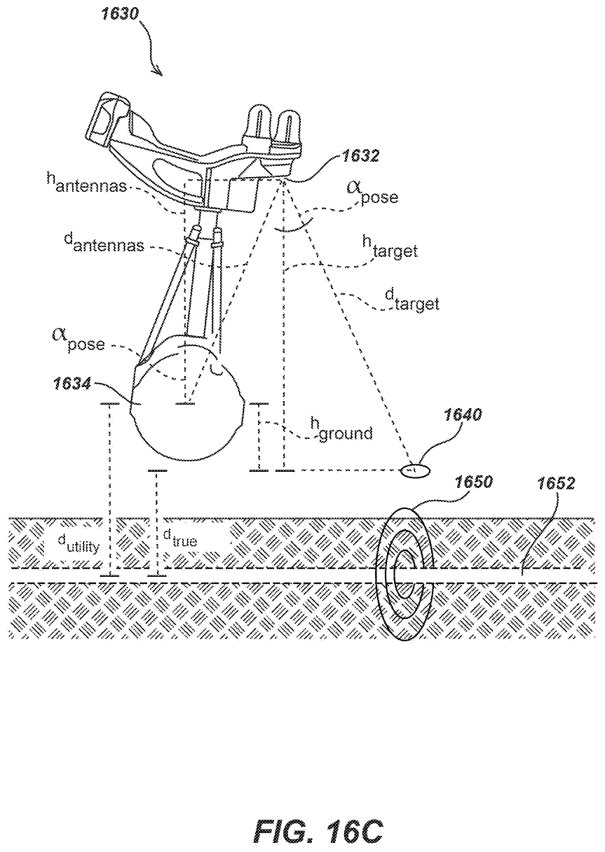

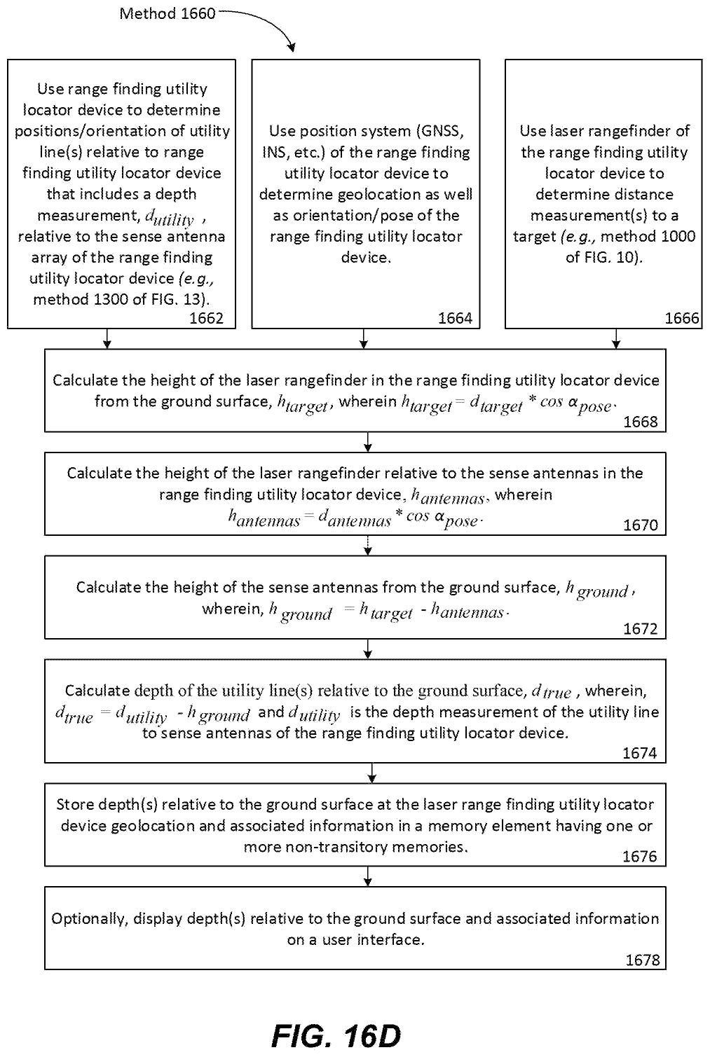

Turning to FIG. 16A, a method 1600 is described correlating data of range finding utility locator devices of the present disclosure (e.g., range finding utility locator device 1200 of FIGS. 12A-12D, range finding utility locator device 1400 of FIG. 14, or range finding utility locator device 1500 of FIG. 15). The method 1600 may include a series of simultaneously occurring steps 1602, 1604, 1606, and 1610. In the step 1602, a range finding utility locator device may determine positions/orientation of utility line(s) relative to range finding utility locator device. In the simultaneous step 1604, the position system (GNSS, INS, etc.) of the range finding utility locator device may determine geolocation/orientation/pose data for range finding utility locator device. In another simultaneous step 1606, the laser rangefinder of the range finding utility locator device may determine distance measurement to a target. In an optional step 1608 subsequent to step 1606, the laser rangefinder target may be electronically tagged. In some embodiments, tagging of the target may involve a user pressing a button, providing a verbal command, or other user input. In other embodiments, artificial intelligence or other automated image recognition may identify relevant objects and tag targets. For instance, fluorescent markings may be electronically tagged as described with method 1000 of FIG. 10 and method 1100 of FIG. 11. In yet further embodiments, all targets may automatically be tagged. In another optional step 1610 simultaneous to steps 1602, 1604, and 1606, camera(s) of the range finding utility locator device may generate image(s) that include the laser rangefinder target. In a step 1612 subsequent to steps 1602, 1604, 1606, 1608, and 1610, positions/orientations of utility line(s) relative to utility locator device, the geolocation/orientation/pose data for utility locator device, distance measurement to a target, and optional image(s) may be correlated to resolve positions of each in the world frame. This may further be referred to herein as the “correlated data.” In another optional step 1614, the correlated data from step 1612 may further be combined with an electronic map of the area. An exemplary electronic map 1624 is further illustrated in FIG. 16B. Referring back to a step 1616 in method 1600 of FIG. 16A, the correlated data and/or the related electronic map may be stored in a memory element having one or more non-transitory memories. In an optional step 1618, the correlated data from step 1612 and/or map from step 1614 may be displayed on an electronic display.

Turning to FIG. 16B, a smart phone 1620 or other device that may include an electronic display 1622 may display an electronic map 1624 having correlated utility locating data as described with the method 1600 of FIG. 16A. The electronic map 1624 may contain visual representations of mapped positions and orientations of buried utility lines, such as the utility lines 1626a, 1626b, 1626c, and 1626d relative to the mapped surface of the locate area. In other embodiments, utility line depth, type, and/or other attributes of the utility line may further be displayed. Likewise, tagged targets, such as the tagged fluorescent marking 1628, may be represented on the electronic map 1624. The tagged fluorescent marking 1628 may include a geolocation and indicator of the detected fluorescence. In some embodiments, image recognition, artificial intelligence, or the like technology may be used to interpret fluorescent markings meaning (e.g., presence of a gas or water or other utility line) which may further be stored in a memory element having one or more non-transitory memories and/or which may display such information on a user interface.

Turning to FIG. 16C, a range finding utility locator device 1630 is illustrated which may be or share aspects with the range finding utility locator device 1200 of FIGS. 12A-12D, range finding utility locator device 1400 of FIG. 14, or range finding utility locator device 1500 of FIG. 15. The variables described in FIG. 16C may be used to understand the method 1660 of FIG. 16D.

As shown in FIG. 16C, the range finding utility locator device 1630 may include a laser rangefinder 1632 in keeping with the present disclosure (e.g., the daylight visible laser rangefinder 200 of FIG. 2, the daylight visible laser rangefinder 300 of FIG. 3, the multi-spectral laser rangefinder module 500 of FIGS. 5A and 5B, the multi-spectral laser rangefinder 600a of FIG. 6A, the multi-spectral laser rangefinder 600b of FIG. 6B, the multi-spectral laser rangefinder 700a of FIG. 7A, the multi-spectral laser rangefinder 700b of FIG. 7B, the multi-spectral laser rangefinder 800a of FIG. 8A, or the laser rangefinder 800b of FIG. 8B) that may determine a distance d_{target} from the laser rangefinder 1632 to a target 1640. A height, notated as h_{target}, may describe the vertical distance of the laser rangefinder 1632 from the ground surface relative to the target 1640. An angle αₚₒₛₑ may describe the angle from the height h_{target} toward the target 1640 as determined via the orientation/pose of laser range finding utility locator device 1630 (e.g., via INS or like positioning system such as the INS 1264 in positioning system 1260 of the range finding utility locator device 1200 of FIG. 12D).

It should be noted that a distance dₐₙₜₑₙₙₐₛ between the laser rangefinder and sense antennas of the laser range finding utility locator device 1630 may be known as both exist in the same rigid body of the laser range finding utility locator device 1630. A height hₐₙₜₑₙₙₐₛ may describe the vertical distance from the laser rangefinder 1632 to a sense antenna array 1634.

The sense antenna array 1634 may sense magnetic fields 1650 from one or more utility lines in the ground, such as a utility line 1652, in determining the location and orientation/pose thereof (e.g., via the method 1300 of FIG. 13). Likewise, a depth measurement, notated herein as d_{utility}, may be determined measuring between the sense antenna array 1634 and the utility line 1652.

In use, a range finding utility locator device, such as the range finding utility locator device 1630, may be carried thus suspending the sense antennas 1634 above the ground. Whereas the depth measurement d_{utility} between the sense antennas 1634 and the utility line 1652 is valuable to locating and mapping utility lines, it may be more advantageous to know the depth of a utility line or lines, such as the utility line 1652, relative to the ground surface. This measurement of the depth of the utility line 1652 relative to the ground surface may be notated herein as dₜᵣᵤₑ and may be determined via method 1660 of FIG. 16D.

Turning to FIG. 16D, a method 1660 is described for calculating the depth of a utility line relative to the ground surface via a laser range finding utility locator device of the present disclosure (e.g., range finding utility locator device 1200 of FIGS. 12A-12D, range finding utility locator device 1400 of FIG. 14, or range finding utility locator device 1500 of FIG. 15). It should be noted that the method 1660 of FIG. 16D utilizes variables illustrated in FIG. 16C.

As shown in FIG. 16D, the method 1660 may include a series of simultaneous steps 1662, 1664, and 1666. In the simultaneous step 1662, a laser range finding utility locator device of the present disclosure may be used to determine position(s)/orientation(s) of utility line(s) relative to the range finding utility locator device that includes a depth measurement relative to the sense antennas of the range finding utility locator device notated herein as d_{utility} and further illustrated as such in FIG. 16C. The step 1662 may use the method 1300 of FIG. 13 to determine positions/orientations of the utility line(s) as well as the d_{utility} depth measurement of each utility line in the ground relative to the laser range finding utility locator device. In the simultaneous step 1664, the geolocation as well as orientation/pose of the range finding utility locator device may be determined. The step 1664 may use the positioning system of the laser range finding utility locator (e.g., the positioning system 1260 having the GNSS 1262 and INS 1264 of the range finding utility locator device 1200 of FIG. 12D). In the other simultaneous step 1666, the laser rangefinder of the range finding utility locator device may determine at least one distance measurement to a target (e.g., method 1000 of FIG. 10). This distance measurement may be referred to herein as d_{target} as further illustrated in FIG. 16D.

In a subsequent step 1668, the height of the laser rangefinder in the range finding utility locator device from the ground surface, notated herein as h_{target}, may be calculated. For instance, the height from the laser rangefinder of the laser range finding utility locator device to the ground, h_{target}, may be found where h_{target}=d_{target}*cos αₚₒₛₑ.

In another step 1670, the height of the laser rangefinder relative to the sense antennas in the range finding utility locator device, notated herein as hₐₙₜₑₙₙₐₛ, may be calculated. For instance, the height of the laser rangefinder relative to the sense antennas in the range finding utility locator device, hₐₙₜₑₙₙₐₛ, may be found wherein hₐₙₜₑₙₙₐ=dₐₙₜₑₙₙₐₛ*cos αₚₒₛₑ.

In a step 1672, the height of the sense antennas from the ground surface may be calculated. For instance, given the calculated height from the h_{target} relative to the laser range finder from step 1668 and the calculated height between the laser rangefinder and sense antennas hₐₙₜₑₙₙₐₛ, from step 1670, the height from the sense antennas of the laser range finding utility locator device to the ground surface h_{ground} may be found wherein h_{ground}=h_{target}−hₐₙₜₑₙₙₐₛ.

In a step 1674, a depth of the utility line(s) relative to the ground surface may be calculated. For instance, the depth of the utility line(s) relative to the ground surface, notated as dₜᵣᵤₑ, may be found wherein dₜᵣᵤₑ=d_{utility}−h_{ground} and d_{utility} is the depth measurement relative to the sense antennas of the range finding utility locator device from step 1662.

In a step 1676, the depth(s) relative to the ground surface at the laser range finding utility locator device geolocation and associated information may be stored in a memory element having one or more non-transitory memories. In an optional step 1678, the depth(s) relative to the ground surface and associated information may be displayed on a user interface.

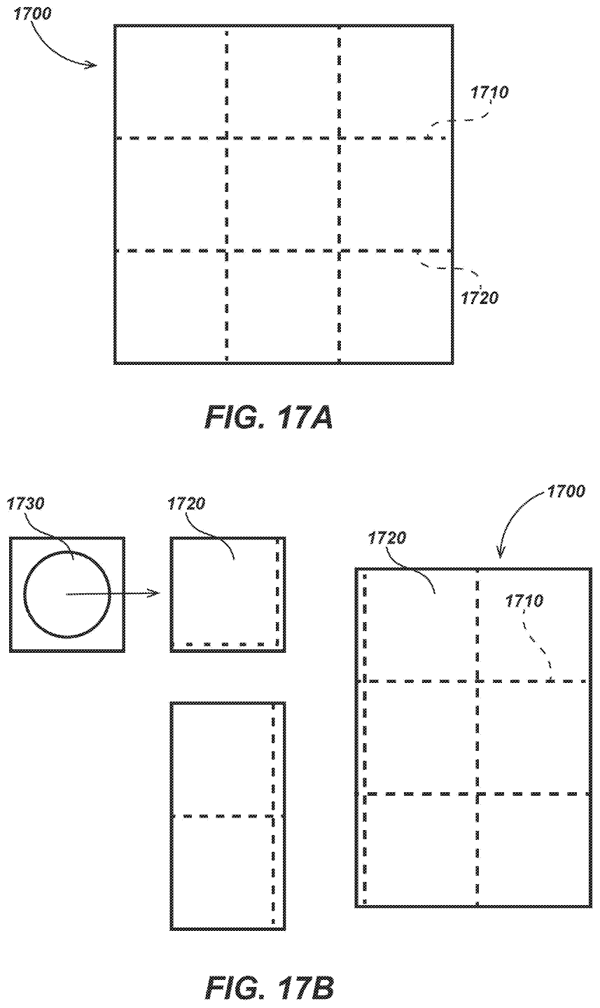

Turning to FIGS. 17A and 17B, a novel manufacturing method (further described in method 1800 of FIG. 18) of optical windows (e.g., windows 134 of FIG. 1C or windows 534 of FIG. 5C) is illustrated in keeping with laser rangefinders of the present disclosure. As shown, a sheet of optical material 1700 may be scored 1710 in squares or other polygonal shapes. The sheet of optical material 1700 may be or include alkali-aluminosilicate sheet glass such as the publically available Corning® Gorilla® glass. Each individual optical window 1720 may be separated from the sheet of optical material 1700 by breaking along the scored 1710 lines. The individual optical windows 1720 may have a filter coating (e.g., bandpass filter 222 of FIG. 2, bandpass filter 322 of FIG. 3, bandpass filter 622a or 622b of FIGS. 6A and 6B, or bandpass filter 722a or 722b of FIGS. 7A and 7B) applied thereto before or after each individual optical window 1720 may be separated from the sheet of optical material 1700. Likewise, the optical window 1720 may optionally be chemically strengthened. Optionally, the edges of each individual optical window 1720 may be smoothed/deburred. Adhesive 1730 (FIG. 17B) may be applied to each individual optical window 1720 such that the individual optical windows 1720 may be secured in place. For instance, each individual optical window 1720 may be secured to or in openings/ports of a laser rangefinder device in keeping with the present disclosure via adhesive 1730 (FIG. 17B). It should be noted that the adhesive 1730 (FIG. 17B) may be applied around the peripheral edges so as to not interfere with optics (e.g., emitted lasers and reflected light input of the laser rangefinder devices described in the present disclosure). In some embodiments, the adhesive may be 3M™ VHB™ tape or other very high or ultra-high bond tape.

Turning to FIG. 18, a method 1800 for manufacturing optical windows (e.g., windows 134 of FIG. 1C, windows 534 of FIG. 5C, optical windows 1720 of FIGS. 17A and 17B) in keeping with laser rangefinders of the present disclosure is described. In a step 1810, a sheet of optical window material (e.g., sheet of optical material 1700 of FIGS. 17A and 17B) may be procured. The sheet of optical material may be or include alkali-aluminosilicate sheet glass such as the publically available Corning® Gorilla® glass. In a step 1820, the sheet of optical window material (e.g., sheet of optical material 1700 of FIGS. 17A and 17B) may have squares or other polygonal shapes scored (e.g., scored 1710 of FIGS. 17A and 17B) into the surface thereof. In a step 1830, the individual optical windows (e.g., optical windows 1720 of FIGS. 17A and 17B) may be separated from the sheet of optical window material (e.g., sheet of optical material 1700 of FIGS. 17A and 17B). For instance, the sheet of optical window material (e.g., sheet of optical material 1700 of FIGS. 17A and 17B) may be broken along scored lines (e.g., scored lines 1710 of FIGS. 17A and 17B), by hand or by tool, to separate each optical window (e.g., optical windows 1720 of FIGS. 17A and 17B) from the sheet of optical window material (e.g., optical windows 1720 of FIGS. 17A and 17B). In an optional step 1840, the edges of each individual optical window may be smoothed and/or deburred. In another optional step 1850, the optical windows may be chemically strengthened. In another optional step 1860, a filter coating (e.g., bandpass filter 222 of FIG. 2, bandpass filter 322 of FIG. 3, bandpass filter 622a or 622b of FIGS. 6A and 6B, or bandpass filter 722a or 722b of FIGS. 7A and 7B) may be applied to individual optical windows. Alternatively, such a filter coating may be applied to the sheet of optical material prior to scoring. In another step 1870, adhesive may be applied to each individual optical window such that the individual optical windows (e.g., optical windows 1720 of FIGS. 17A and 17B) may be secured in place during assembly of an associated device. For instance, each individual optical window (e.g., optical windows 1720 of FIGS. 17A and 17B) may be secured to or in openings/ports of a laser rangefinder device in keeping with the present disclosure via adhesive (e.g., adhesive 1730 of FIG. 17B). It should be noted that the adhesive (e.g., adhesive 1730 of FIG. 17B) may be applied around the peripheral edges so as to not interfere with optics (e.g., emitted lasers and reflected light input of the laser rangefinder devices described in the present disclosure). In some embodiments, the adhesive may be 3M™ VHB™ tape or other very high or ultra-high bond tape.

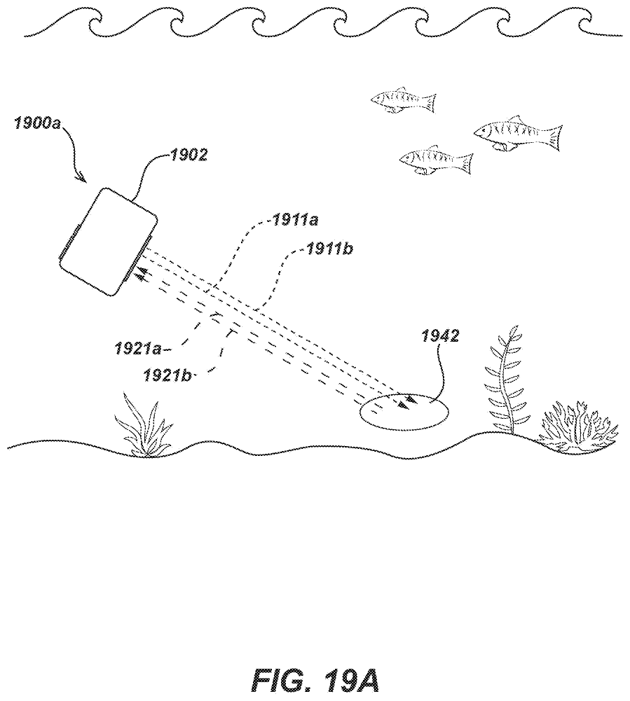

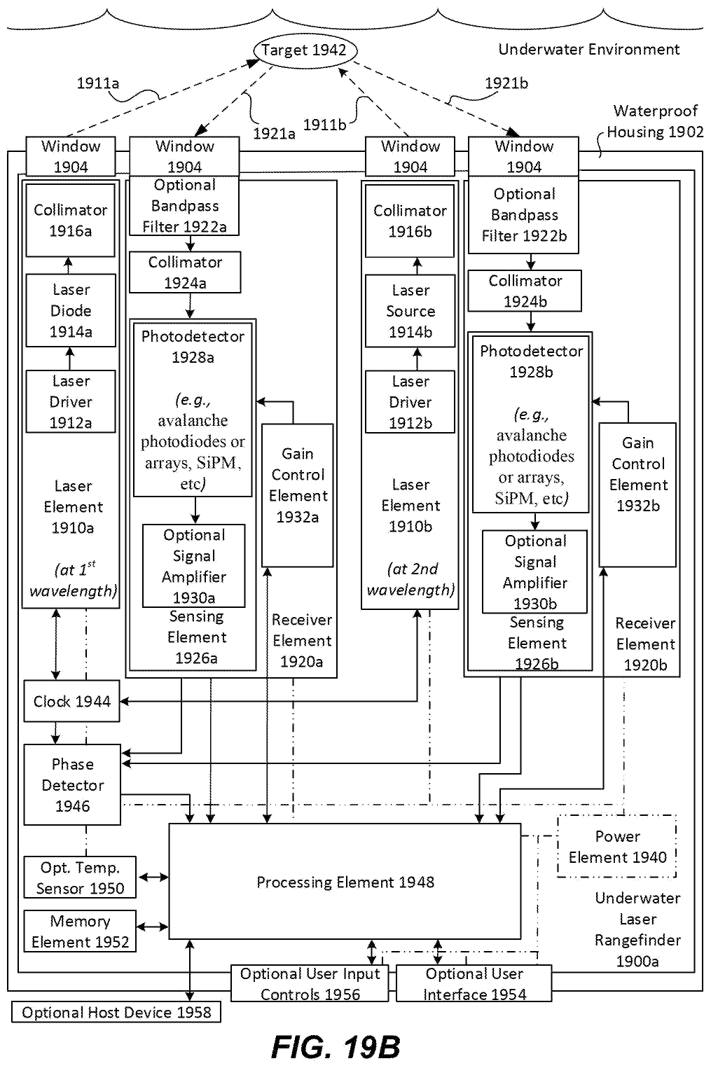

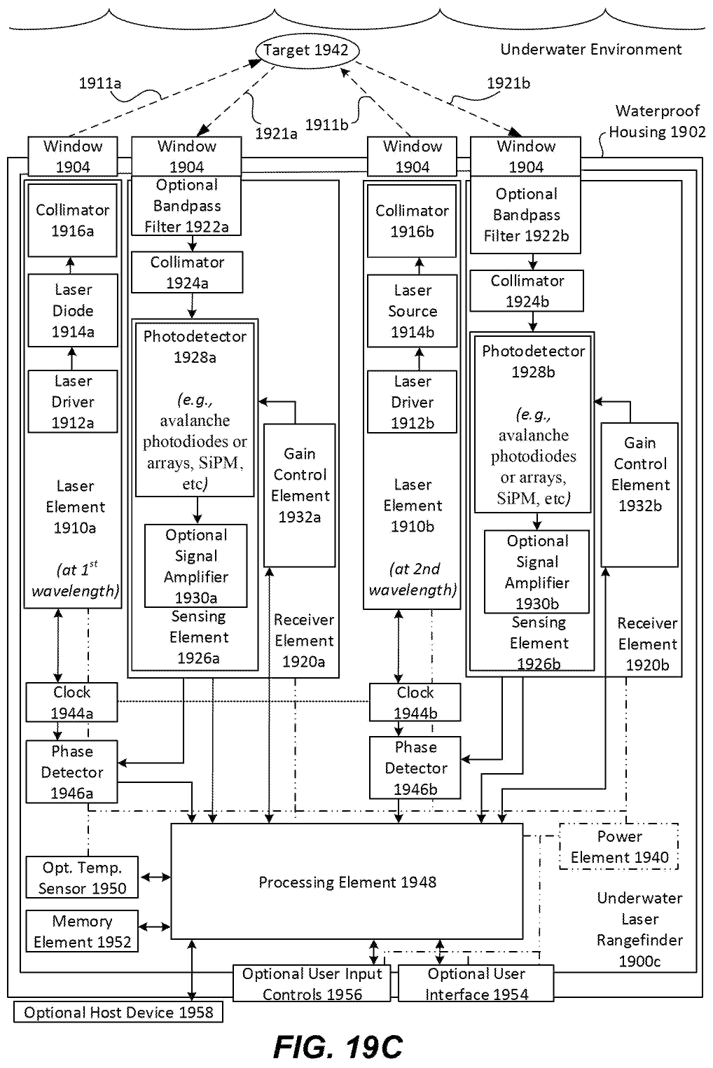

Turning to FIGS. 19A and 19B, an underwater laser rangefinder 1900a is illustrated which may include one of the various laser rangefinders described herein (e.g., the daylight visible laser rangefinder module 100 of FIGS. 1A and 1B, the daylight visible laser rangefinder 200 of FIG. 2, the daylight visible laser rangefinder 300 of FIG. 3, the multi-spectral laser rangefinder module 500 of FIGS. 5A and 5B, the multi-spectral laser rangefinder 600a of FIG. 6A, the multi-spectral laser rangefinder 600b of FIG. 6B, the multi-spectral laser rangefinder 700A of FIG. 7A, the multi-spectral laser rangefinder 700b of FIG. 7B, the laser rangefinder 800a of FIG. 8A, the laser rangefinder 800b of FIG. 8B, or the like) disposed in a waterproof housing 1902 for use in underwater environments.

Turning to the diagram of FIG. 19B, the underwater laser rangefinder 1900a may include a plurality of laser elements, such as laser element 1910a and 1910b, may each include a laser driver such as laser drivers 1912a and 1912b for supplying current at specific wavelengths and power output to a corresponding laser diode 1914a or 1914b or other laser source in each generating an emitted laser 1911a or 1911b modulated at different known frequencies. For instance, the emitted laser 1911a may be a green or other daylight visible laser or other wavelength laser for use underwater while the emitted laser 1911b may be an infrared, near-infrared, or other wavelength laser. In alternative embodiments, an underwater laser rangefinder embodiment in keeping with the present disclosure may include other numbers of laser element/receiver element pairings (e.g., the single laser element/receiver element pairings of FIG. 2 or FIG. 3 or the greater than two laser element/receiver element pairings of FIG. 8). The emitted lasers 1911a/1911b may pass through a window 1904 to the external underwater environment. The windows 1904 may be or share aspects with the optical windows 1720 of FIGS. 17A and 17B and/or described via the method 1800 of FIG. 18. It should be noted that electrical power may be supplied to the laser drivers 1912a and 1912b via a power element 1940 (e.g., battery, grid-tied electrical power, or the like). A collimator 1916a or 1916b may be included for focusing light from the laser diodes 1914a or 1914b respectively in generating narrow beams of the emitted lasers 1911a and 1911b. The emitted lasers 1911a and 1911b may be directed at a target 1942 each generating a corresponding reflected light input 1921a or 1921b directed back toward a corresponding receiver element 1920a or 1920b.

The reflected light inputs 1921a and 1921b may each pass through one of the windows 1904 on the corresponding receiver element 1920a or 1920b and optionally through a bandpass filter 1922a and 1922b to filter out noise influences at out of band frequencies but allow in band reflected light inputs 1921a and 1921b through. The bandpass filter 1922a and 1922b may be calibrated to account for phase shifts. It should be noted that the bandpass filters 1922a and 1922b may be configured for the different wavelengths of reflected light inputs such as the reflected light inputs 1921a and 1921b. Further in the receive elements 1920a and 1920b, a collimator 1924a or 1924b may focus the reflected light inputs 1921a or 1921b to the corresponding sensing element 1926a or 1926b. The sensing elements 1926a and 1926b may receive the reflected light inputs 1921a and 1921b and convert the light to corresponding electrical input signals. The sensing elements 1926a and 1926b may each further be or include a photodetector 1928a or 1928b (e.g., one or more avalanche photodiodes, avalanche photodiode arrays, silicon photomultipliers (SiPM), and/or other like photodetector sensors for sensing the reflected light inputs 1921a or 1921b). The SiPM may, in some embodiments, be or include the MICROFC-10010 SiPM publically available from ON Semiconductor®. In some embodiments, the sensing elements 1926a or 1926b may likewise include a signal amplifier 1930a or 1930b (e.g., a transimpedance amplifier or the like) to amplify the input signals.

The receiver elements 1920a and 1920b may further include a gain control element 1932a or 1932b for varying the gain of the sensing element 1926a or 1926b to appropriate levels in receiving reflected light inputs 1921a and 1921b and compensating for the change in amplitude due to the attenuation of light signals of the modulated emitted lasers 1911a and 1911b and the resulting reflected light inputs 1921a and 1921b. It should be noted that the varying of gain to the sensing elements 1926a and 1926b may achieved in different ways. For instance, in some embodiments, the gain control elements 1932a and 1932b may vary the gain to the sensing elements 1926a and 1926b by controlling the bias voltage to the photodetectors 1928a or 1928b. For instance, wherein the photodetectors 1928a and 1928b may be a silicon photomultiplier (SiPM) the operating voltage may have a range of 24-32 volts DC. The SiPM may, in some embodiments, be or include the MICROFC-10010 SiPM publically available from ON Semiconductor®. Adjusting the bias voltage may adjust the sensitivity of the SiPM (or other photodetectors 1928a or 1928b) and thereby compensate for attenuated amplitudes of the received corresponding reflected light inputs 1921a and 1921b and corresponding input signals. In other embodiments, the gain to the sensing element may be adjusted by the introduction of a programmable gain amplifier (PGA) coupled to a transimpedance amplifier or like signal amplifier.

Referring to FIG. 19B, a clock 1944 may couple to the laser elements 1910a and 1910b and a phase detector 1946 such that timing of the detected phase corresponding to each emitted laser 1911a and 1911b may be known. Likewise, the input signals from the receiver elements 1920a and 1920b may be communicated with the phase detector 1946. Phase data corresponding to the emitted lasers 1911a and 1911b and corresponding input signals may further be communicated with a processing element 1948. The processing element 1948, having one or more processors, may determine differences in phases and thereby calculate distance measurements (e.g., via method 1000 of FIG. 10).

Turning to FIG. 19C, a diagram of an underwater laser rangefinder 1900c is illustrated which is the same as the underwater laser rangefinder 1900a of FIGS. 19A and 19B with the exception of having a separate clock 1944 coupled with each respective one of the laser elements 1910a and 1910b. Each clock 1944 may further couple with a separate phase detector 1946. In such embodiments, the clocks 1944 may be synchronous in determining the timing associated with the detected phase of each emitted laser 1911a and 1911b. The input signals from the receiver elements 1920a and 1920b may be communicated with the respective one of the phase detector 1946 associated with the receiver element 1920a or 1920b. Phase data corresponding to the emitted lasers 1911a and 1911b and corresponding input signals may further be communicated with a processing element 1948. The processing element 1948, having one or more processors, may determine differences in phases and thereby calculate distance measurements (e.g., via method 1000 of FIG. 10).

Referring to both FIGS. 19B and 19C, adjustments to the calculation of distance measurements may be made based on other available data. For instance, the ambient light data and waveform data (e.g., data relating to the waveform shape and amplitude of the input signal) from the sensing elements 1926a and 1926b may be communicated to the processing element 1948 and may be compensated for in the calculation of distance measurements. Likewise, a temperature sensor 1950 may optionally be included to supply the processing element 1948 with temperature data allowing for measured temperature (e.g., environment, lasers, and/or associated circuitry temperatures) to be compensated for in the calculation of distance measurements. In some embodiments, the gain levels may be considered in calculations of distance measurements.

Referring back to FIG. 19B, the processing element 1948 may connect to a memory element 1952 having one or more non-transitory memories. The memory element 1952 may store distance measurements as well as instructions relating to calculating such distance measurements.

Still referring to FIG. 19B, the underwater laser rangefinder 1900a may, in some embodiments, optionally include a user interface 1954 (e.g., a graphical user interface, speakers for audio feedback, or the like) for communicating distance measurements and/or other data to a user. Likewise, the underwater laser rangefinder 1900a may optionally include a set of user input controls 1956 (e.g., buttons or like controls) providing the user the ability to control aspects of the underwater laser rangefinder 1900a. For instance, the user input controls 1956 may allow input from a user to turn the underwater laser rangefinder 1900a on or off, select from menus, or the like.

Still referring to FIG. 19B, the underwater laser rangefinder 1900a may, in other embodiments, optionally be included as a module in a host device 1958. For instance, the underwater laser rangefinder 1900a may be built into an autonomous underwater vehicle (AUV), remotely operated underwater vehicle (ROV), underwater camera or other image system, or the like. In some such embodiments, various resources may be shared between the host device and underwater laser rangefinder embodiment. For instance, some such shared resources may include, but should not be limited to, those elements responsible for processing of data, storage of data and instructions for generating distance measurements and the related data, portioning of electrical power from a power element, as well as user input controls and/or user interfaces for displaying distance measurements and/or other data.

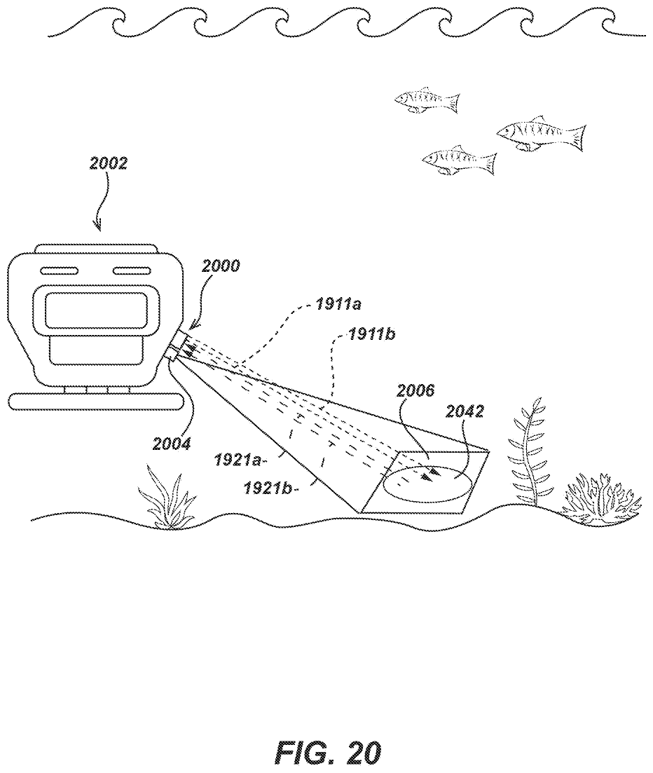

Turning to FIG. 20, an underwater laser rangefinder 2000 is illustrated, which may be or share aspects with the underwater laser rangefinder 1900a of FIGS. 19A and 19B, further deployed in an underwater vehicle 2002 or like host device that may further have one or more cameras, such as a camera 2004, for generating one or more images of an image area 2006 that includes a target 2042. The underwater vehicle 2002 may be an autonomous unmanned vehicle (AUV), remote operated underwater vehicle (ROV), unmanned autonomous vehicle (UAV), or other vehicle. Likewise, the underwater laser rangefinder 2000 may emit one or more lasers, such as emitted lasers 2011a and 2011b that may reflect light, such as reflected light inputs 2021a and 2021b, in determining distance measurements. The underwater laser rangefinder 2000 may be or share aspects with the daylight visible laser rangefinder module 100 of FIGS. 1A and 1B, the daylight visible laser rangefinder 200 of FIG. 2, the daylight visible laser rangefinder 300 of FIG. 3, the multi-spectral laser rangefinder module 500 of FIGS. 5A and 5B, the multi-spectral laser rangefinder 600a of FIG. 6A, the multi-spectral laser rangefinder 600b of FIG. 6B, the multi-spectral laser rangefinder 700a of FIG. 7A, the multi-spectral laser rangefinder 700b of FIG. 7B, the laser rangefinder 800a of FIG. 8A, the laser rangefinder 800b of FIG. 8B, the underwater laser rangefinder 1900a of FIG. 19B, or the like.

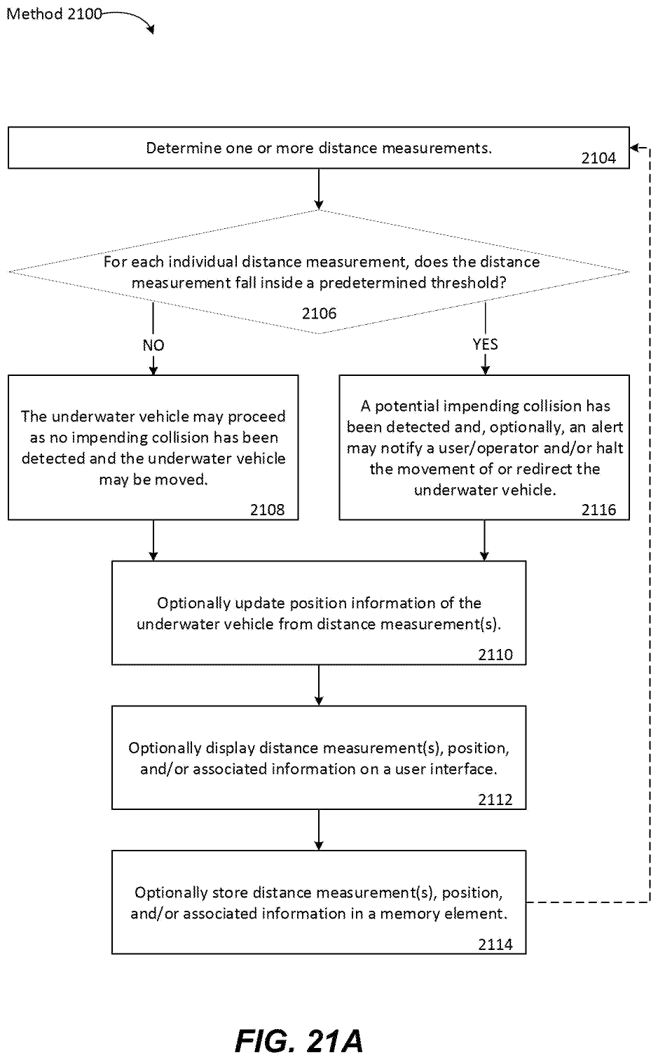

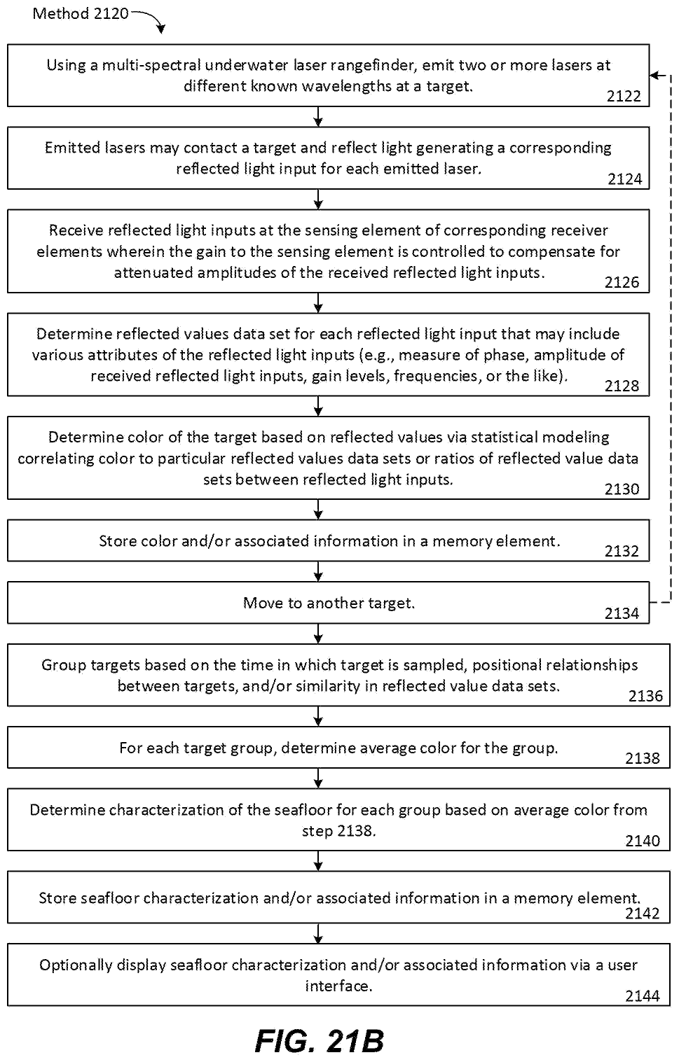

In some embodiments, the underwater vehicle 2002 (or, in alternative embodiments, other terrestrial or aerial vehicle) may utilize a laser rangefinder of the present disclosure, such as the underwater laser rangefinder 2000, for navigation (e.g., using the method 2100 of FIG. 21A). For instance, underwater vehicles known in the art may often include one or more acoustic altimeters for navigation that may be known to experience multipath and refresh rate problems in use. Such problems may be overcome with a vehicle sensing positions relative to a surface or other objects in the environment via one or more laser rangefinders of the present disclosure. For instance, the underwater vehicle 2002 may measure a distance from the seafloor via the underwater laser rangefinders 2000 to aid in navigation and prevent collisions.

Turning to FIG. 21A, a method 2100 for underwater navigation for an underwater vehicle having one or more underwater laser rangefinders of the present disclosure is described. In a step 2104, one or more distance measurements may be generated from an underwater laser rangefinder (e.g., the underwater laser rangefinder 1900a of FIG. 19A or 19B, the underwater laser rangefinder 2000 of FIG. 20, or the like). In a decision step 2106, it may be decided whether the distance is within a predetermined threshold. For instance, such a value outside the predetermined threshold may be considered safe distances that may prevent collision of the underwater vehicle with the seafloor or other object. If the distance does not fall within the predetermined threshold, in a step 2108 there is no impending collision and the underwater vehicle may be moved. In an optional step 2110, the distance measurement(s) may be used to update positioning information of the underwater vehicle. For instance, the positioning information may be or include coordinates or other representation of the underwater vehicles position/orientation/pose in three dimensions relative to the seafloor and/or the world frame. In an optional step 2112, the distance measurement(s), position information, and/or other associated information may be displayed on a user interface. In an optional step 2114, the distance measurement(s), position information, and/or other associated information may be stored in a memory element having one or more non-transitory memories. After the optional step 2114, the method 2100 may optionally repeat.

If the distance does fall in the predetermined threshold, in a step 2116 a potential impending collision may be detected and, optionally, an alert may notify a user/operator and/or the movement of the underwater vehicle may be halted or redirected. The method 2100 may continue on to the step 2110, wherein the distance measurement(s) may be used to update positioning information of the underwater vehicle. In an optional step 2112, the distance measurement(s), position information, and/or other associated information may be displayed on a user interface. In an optional step 2114, the distance measurement(s), position information, and/or other associated information may be stored in a memory element having one or more non-transitory memories. The method 2100 may optionally repeat after the optional step 2114.

In some embodiments, an underwater laser rangefinder in keeping with the present disclosure (e.g., the underwater laser rangefinder 1900a of FIG. 19A or 19B, the underwater laser rangefinder 2000 of FIG. 20, or the like) may be used to characterize conditions of the seafloor. For instance, colors may be detected to determine geological feature such as those that may be avoided or targeted in underwater pipeline or cable applications. Turning to FIG. 21B, a method 2120 is illustrated for characterizing the seafloor via a laser rangefinder of the present disclosure (e.g., the multi-spectral laser rangefinder module 500 of FIGS. 5A and 5B, the multi-spectral laser rangefinder 600a of FIG. 6A, the multi-spectral laser rangefinder 600b of FIG. 6B, the multi-spectral laser rangefinder 700a of FIG. 7A, the multi-spectral laser rangefinder 700b of FIG. 7B, the laser rangefinder 800a of FIG. 8A, the laser rangefinder 800b of FIG. 8B, the underwater laser rangefinder 1900a of FIG. 19B, the underwater laser rangefinder 1900c of FIG. 19C or the like). In a step 2122, a multi-spectral underwater laser rangefinder of the present disclosure (e.g., the underwater laser rangefinder 1900a of FIGS. 19A-19B, the underwater laser rangefinder 1900c of FIG. 19C, or the underwater laser rangefinder 2000 of FIG. 20) may emit two or more lasers at different known wavelengths at a target. In a step 2124, the emitted lasers may contact a target and reflect light generating a corresponding reflected light input for each emitted laser. In a step 2126, reflected light inputs may be received at the sensing element of corresponding receiver elements wherein the gain to the sensing element is controlled to compensate for attenuated amplitudes of the received reflected light inputs. In a step 2128, a reflected values data set may be determined for each reflected light input that may include various attributes of the reflected light input (e.g., measure of phase, amplitude of received reflected light input, gain level, frequency, or the like). In a step 2130 the color of the target may be determined based on reflected values data via statistical modeling correlating color to particular reflected values data sets or ratios of reflected value data sets between reflected light inputs. In a step 2132, the determined color and/or associated information may be stored in a memory element having one or more non-transitory memory elements. In a step 2134, the multi-spectral underwater laser rangefinder may be moved to another target. The steps 2122-2134 of method 2120 may repeat collecting color and associated reflected values data sets for numerous targets throughout an area. In a step 2136, targets may be grouped based on the time in which a target is sampled, positional relationships between targets, and/or similarities in reflected value data sets. In a step 2138, an average color may be determined for each target group. In a step 2140, characterization of the seafloor may be determined for each group based on the previously calculated average. In a step 2142, the seafloor characterization(s) and/or associated information may be stored in a memory element having one or more non-transitory memories. In an optional step 2144, the seafloor characterization(s) and/or associated information may be displayed on a user interface.

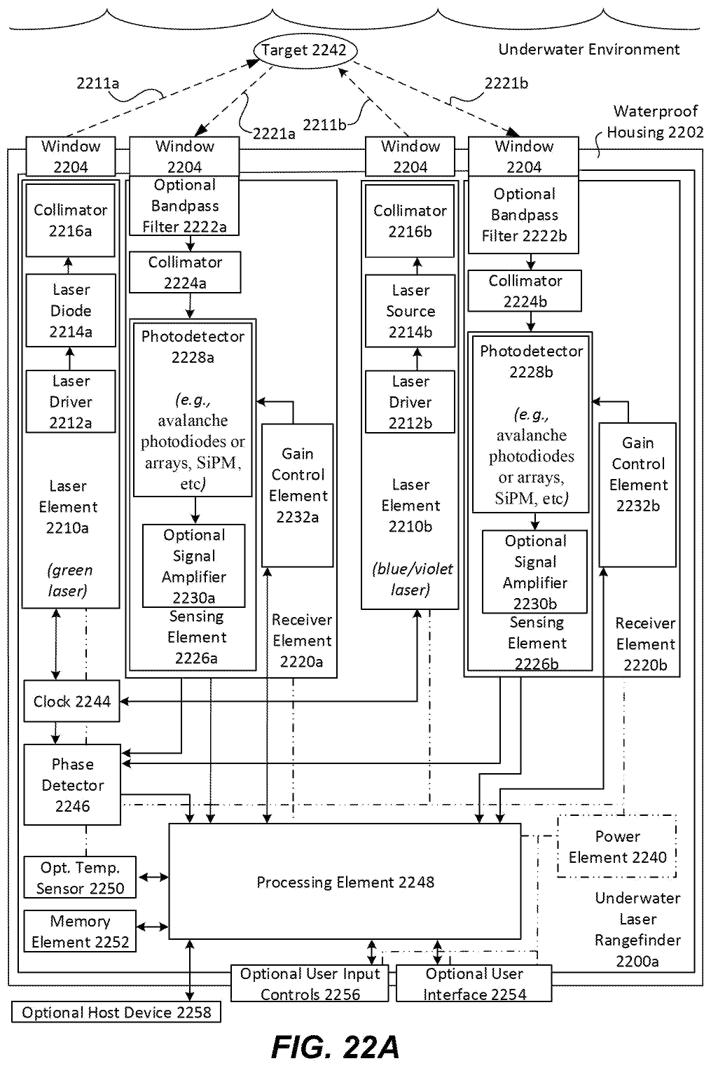

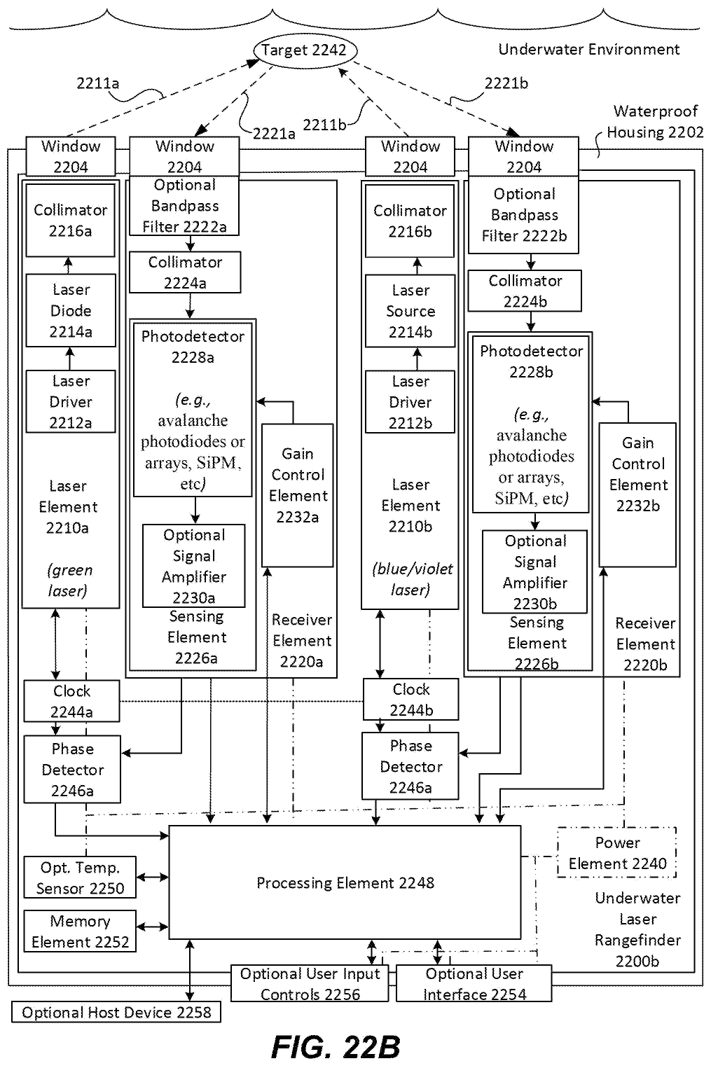

Turning to FIG. 22A, an underwater laser rangefinder 2200a may include a plurality of laser elements, such as laser element 2210a and 2210b, that may each include a laser driver, such as laser drivers 2212a and 2212b, for supplying current at specific wavelengths and power output to a corresponding laser diode 2214a or 2214b or other laser source in each generating an emitted laser 2211a or 2211b modulated at different known frequencies. For instance, the emitted laser 2211a may be a green laser which, in some underwater applications, may be used to detect rhodamine based dyes as used in detecting leaks in underwater pipes. Likewise, the emitted laser 2211b may be a blue or violet laser for detecting other common dyes used in detecting leaks in underwater pipes. In alternative embodiments, an underwater laser rangefinder embodiment in keeping with the present disclosure may include other numbers of laser element/receiver element pairings (e.g., the single laser element/receiver element pairings of FIG. 2 or FIG. 3 or the greater than two laser element/receiver element pairings of FIG. 8) that may emit lasers at other wavelengths. The emitted lasers 2211a/2211b may each pass through a window 2204 to the external underwater environment. The windows 2204 may be or share aspects with the optical windows 1720 of FIGS. 17A and 17B and/or those described via the method 1800 of FIG. 18. It should be noted that electrical power may be supplied to the laser drivers 2212a and 2212b via a power element 2240 (e.g., battery, grid-tied electrical power, or the like). A collimator 2216a or 2216b may be included for focusing light from the laser diodes 2214a or 2214b respectively in generating narrow beams of the emitted lasers 2211a and 2211b. The emitted lasers 2211a and 2211b may be directed at a target 2242 each generating a corresponding reflected light input 2221a or 2221b directed back toward a corresponding receiver element 2220a or 2220b.

The reflected light inputs 2221a and 2221b may each pass through one of the windows 2204 on the corresponding receiver element 2220a or 2220b and optionally a bandpass filter 2222a and 2222b to filter out noise influences at out of band frequencies but allow in band reflected light inputs 2221a and 2221b. The bandpass filter 2222a and 2222b may be calibrated to account for phase shifts. It should be noted that the bandpass filters 2222a and 2222b may be configured for the different wavelengths of reflected light inputs such as the reflected light inputs 2221a and 2221b. Further in the receiver elements 2220a and 2220b, a collimator 2224a or 2224b may focus the reflected light inputs 2221a or 2221b to the corresponding sensing element 2226a or 2226b. The sensing elements 2226a and 2226b may receive the reflected light inputs 2221a and 2221b and convert the light to corresponding electrical input signals. The sensing elements 2226a and 2226b may each further be or include a photodetector 2228a or 2228b (e.g., one or more avalanche photodiodes, avalanche photodiode arrays, silicon photomultipliers (SiPM), and/or other like photodetector sensors for sensing the reflected light inputs 2221a or 2221b). The SiPM may, in some embodiments, be or include the MICROFC-10010 SiPM publically available from ON Semiconductor®. In some embodiments, the sensing elements 2220a or 2220b may likewise include a signal amplifier 2230a or 2230b (e.g., a transimpedance amplifier or the like) to amplify the input signals.

The receiver elements 2220a and 2220b may further include a gain control element 2232a or 2232b for varying the gain of the sensing elements 2226a or 2226b to appropriate levels for receiving reflected light inputs 2221a and 2221b and compensating for the change in amplitude due to the attenuation of light signals of the modulated emitted lasers 2211a and 2211b and the resulting reflected light inputs 2221a and 2221b. It should be noted that the varying of gain to the sensing elements 2226a and 2226b may be achieved in different ways. For instance, in some embodiments, the gain control elements 2232a and 2232b may vary the gain to the sensing elements 2220a and 2220b by controlling the bias voltage to the photodetectors 2228a or 2228b. For instance, wherein the photodetectors 2228a and 2228b may be a silicon photomultipliers (SiPM), the operating voltage may have a range of 24-32 volts DC. The SiPM may, in some embodiments, be or include the MICROFC-10010 SiPM publically available from ON Semiconductor®. Adjusting the bias voltage may adjust the sensitivity of the SiPM (or other photodetectors 2228a or 2228b) and thereby compensate for attenuated amplitudes of the received corresponding reflected light inputs 2221a and 2221b and corresponding input signals. In other embodiments, the gain to the sensing element may be adjusted by the introduction of a programmable gain amplifier (PGA) coupled to a transimpedance amplifier or like signal amplifier.

Referring to FIG. 22A, a clock 2244 may couple to the laser elements 2210a and 2210b and a phase detector 2246 such that timing of the detected phase corresponding to the each emitted laser 2211a and 2211b may be known. Likewise, the input signals from the receiver elements 2220a and 2220b may be communicated with the phase detector 2246. Phase data corresponding to emitted lasers 2211a and 2211b and corresponding input signals may further be communicated with a processing element 2248. The processing element 2248, having one or more processors, may determine differences in phases and thereby calculate distance measurements (e.g., via method 1000 of FIG. 10).

In some embodiments, such as with the multi-spectral laser rangefinder 2200b illustrated in FIG. 22B, a clock 2244 may couple with each respective one of the laser elements 2210a and 2210b which may further couple with a phase detector 2246. In such embodiments, the clocks 2244 may be synchronous in determining the timing associated with the detected phase of each emitted laser 2211a and 2211b. The input signals from the receiver elements 2220a and 2220b may be communicated with the respective one of the phase detector 2246 associated with the receiver element 2220a or 2220b. Phase data corresponding to the emitted lasers 2211a and 2211b and corresponding input signals may further be communicated with a processing element 2248. The processing element 2248, having one or more processors, may determine differences in phases and thereby calculate distance measurements (e.g., via method 1000 of FIG. 10).

Referring to both FIGS. 22A and 22B, adjustments to the calculation of distance measurement may be made based on other available data. For instance, the ambient light data and waveform data (e.g., data relating to the waveform shape and amplitude of the input signal) from the sensing elements 2226a and 2226b may be communicated to the processing element 2248 and may be compensated for in the calculation of distance measurements. Likewise, a temperature sensor 2250 may optionally be include to supply the processing element 2248 with temperature data allowing for temperature (e.g., environment, lasers, and/or associated circuitry temperatures) to be compensated for in the calculation of distance measurements. In some embodiments, the gain levels may be considered in calculations of distance measurements.

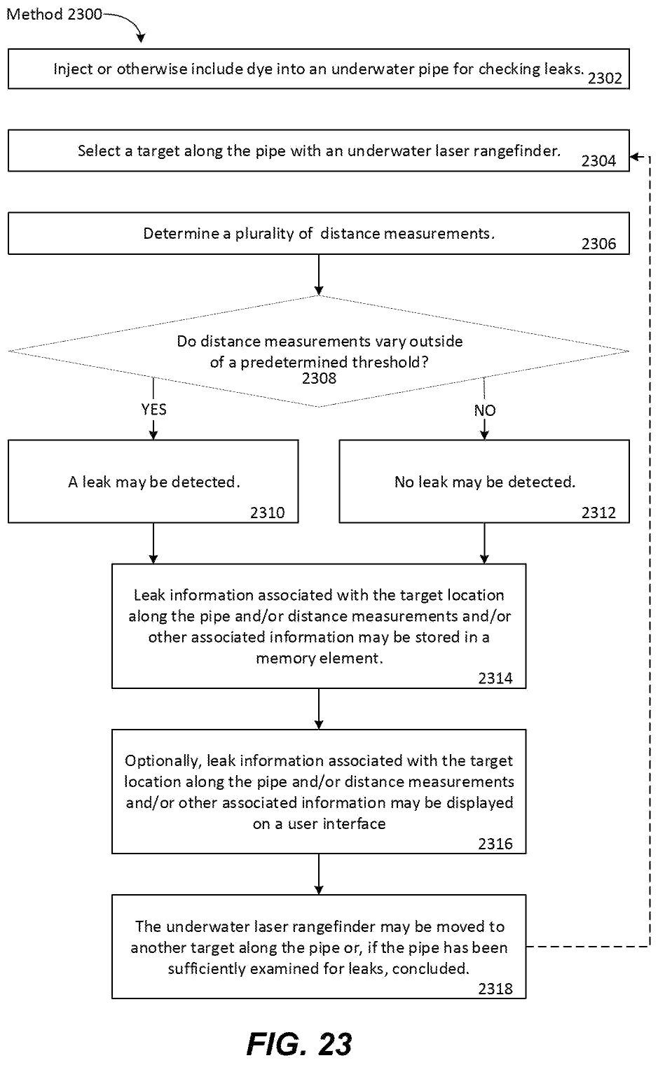

Referring to FIG. 22A, the processing element 2248 may connect to a memory element 2252 having one or more non-transitory memories. The memory element 2252 may store distance measurements as well as instructions relating to calculating such distance measurements. In embodiments configured for detecting underwater leaks, the memory element 2252 may also store detected leaks and/or associated dye type as described with the method 2300 of FIG. 23.

Still referring to FIG. 22A, the underwater laser rangefinder 2200a may, in some embodiments, optionally include a user interface 2254 (e.g., a graphical user interface, speakers for audio feedback, or the like) for communicating distance measurements and/or other data to a user (e.g., detected leaks and/or associated dye type as described with the method 2300 of FIG. 23). Likewise, the underwater laser rangefinder 2200a may optionally include a set of user input controls 2256 (e.g., buttons or like controls) providing the user the ability to control aspects of the underwater laser rangefinder 2200a. For instance, the user input controls 2256 may allow input from a user to turn the underwater laser rangefinder 2200a on or off, select from menus, or the like.

Still referring to FIG. 22A, the underwater laser rangefinder 2200a may, in other embodiments, optionally be included as a module in a host device 2258. For instance, the underwater laser rangefinder 2200a may be built into an autonomous underwater vehicle (AUV), remotely operated underwater vehicle (ROV), underwater camera or other image system, or the like as shown in FIG. 20. In some such embodiments, various resources may be shared between the host device and underwater laser rangefinder embodiment. For instance, sharing of resources may include, but not be limited to, elements responsible for processing of data, storage of data and instructions for generating distance measurements and the related data, portioning of electrical power from a power element, as well as user input controls and/or user interfaces for displaying distance measurements and/or other data.

Turning to FIG. 23, a fluorescent dye detection method 2300 for detecting leaks in underwater pipes via a multi-spectral underwater laser rangefinder of the present disclosure is described. The laser rangefinders and associated methods of the present disclosure may be advantageous over conventional leak detection tools and methods in the ability to detect leaked dyes in smaller concentrations. In the method 2300, in a step 2302 dye may be injected or otherwise included in a pipe that may run underwater. In a step 2304, an underwater laser rangefinder of the present disclosure equipped with a multi-spectral laser rangefinder and at least one laser element may operate at wavelengths that may excite the dye type. The underwater laser rangefinder may, for instance, be or share aspects with the underwater laser rangefinder 2200a of FIG. 22A or the underwater laser rangefinder 2200b of FIG. 22B emitting both a green laser 2211a to excite rhodamine based dyes and a blue/violet laser 2211b to excite other commonly used underwater leak detection dyes and may target the pipe. In a step 2306, distance measurements to a target along the pipe may be calculated by each laser element/receiver element pairing (e.g., using the method 1000 of FIG. 10). In a decision step 2308, it may be determined if the distance measurements vary outside of a predetermined threshold. The predetermined threshold may, for instance, account for small distance measurement variations that would not generally occur due to reactance of one of the emitted lasers with leaked dye. In a step 2310, if the distance measurements do vary beyond the predetermined threshold, a leak may be detected. For instance, the reactance of one of the emitted lasers with dye leaking from the pipe may cause a difference in distance measurements between laser element/receiver element pairings. In a step 2312, if the distance measurements do not vary beyond the predetermined threshold, no leak may be detected. Proceeding to a step 2314 from steps 2310 and 2312, leak information associated with the target location along the pipe and/or distance measurements and/or other associated information may be stored in a memory element having one or more non-transitory memories. In an optional step 2316, leak information associated with the target location along the pipe and/or distance measurements and/or other associated information may be displayed on a user interface. In a step 2318, the underwater laser rangefinder may be moved to another target along the pipe or, if the pipe has been sufficiently examined for leaks, concluded. The method 2300 may optionally repeat back at step 2304 until the pipe examination has concluded.

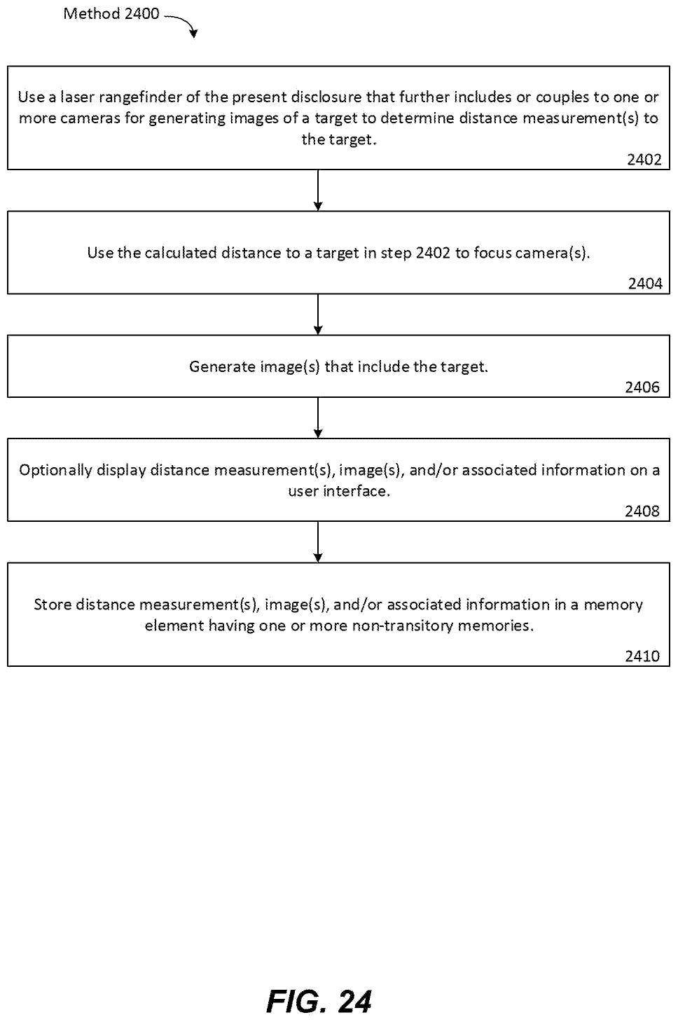

Turning to FIG. 24, a method 2400 for focusing a camera which may be used in underwater environments is described. In a step 2402, a laser rangefinder of the present disclosure that may include or couple to one or more cameras for generating images of a target may determine distance measurement(s) to a target. The laser rangefinder may be or share aspects with the daylight visible laser rangefinder module 100 of FIGS. 1A and 1B, the daylight visible laser rangefinder 200 of FIG. 2, the daylight visible laser rangefinder 300 of FIG. 3, the multi-spectral laser rangefinder module 500 of FIGS. 5A and 5B, the multi-spectral laser rangefinder 600a of FIG. 6A, the multi-spectral laser rangefinder 600b of FIG. 6B, the multi-spectral laser rangefinder 700a of FIG. 7A, the multi-spectral laser rangefinder 700b of FIG. 7B, the laser rangefinder 800a of FIG. 8A, the laser rangefinder 800b of FIG. 8B, range finding utility locator device 1200 of FIGS. 12A-12D, range finding utility locator device 1400 of FIG. 14, or range finding utility locator device 1500 of FIG. 15 which may be an underwater laser rangefinder, such as the underwater laser rangefinder 1900a of FIGS. 19A and 19B, the underwater laser rangefinder 1900c of FIG. 19C, or underwater laser rangefinder 2000 of FIG. 20. The step 2402 may, for instance, use the method 1000 of FIG. 10 to determine one or more distance measurements as well as the method 1100 of FIG. 11A for evaluating the multiple distance measurements. In another step 2404, the method 2400 of FIG. 24 may include using the calculated distance to a target in step 2402 to focus a camera (e.g., focusing the camera(s) at the determined distance). In a step 2406, one or more images that includes the target may be generated via the camera(s). In an optional step 2408, the image(s) may be displayed on a user interface. In a step 2410, the distance measurement(s), image(s), and associated information may be stored in a memory element having one or more non-transitory memories.

In some known underwater applications, the scaling of an object may be achieved by pairs of lasers (referred to herein as “scaling lasers”) at known distances apart that emit highly parallel lasers. The laser rangefinders of the present disclosure may further be coupled to or included in such scaling laser devices so as to further provide distance measurements.

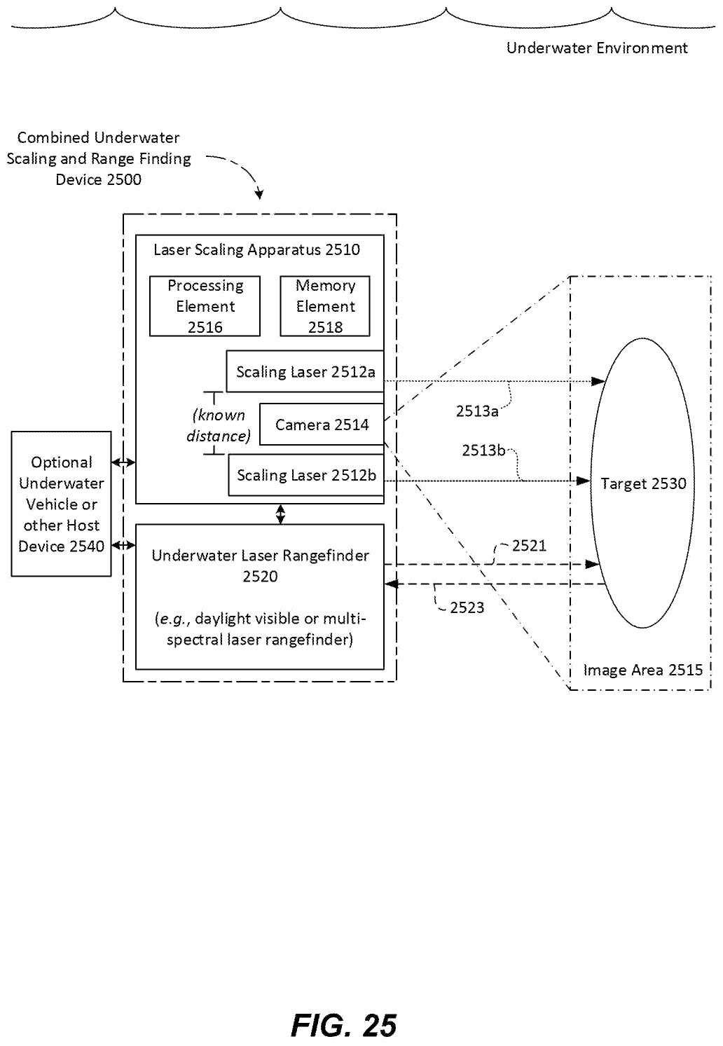

Turning to FIG. 25, a combined underwater scaling and range finding device 2500 is illustrated having a laser scaling apparatus 2510 and an underwater laser rangefinder 2520. In some embodiments, the laser scaling apparatus 2510 may be or share aspects with the Sea Laser® publically available from DeepSea Power & Light, Inc. The laser scaling apparatus 2510 may include a pair of scaling lasers 2512a and 2512b at a known distance parallel to one another. The scaling lasers may emit lasers 2513a and 2513b towards a target 2530 at a target 2530. One or more images of the target 2530 (e.g., image area 2515) that include the contact points of the emitted lasers 2513a/2513b may be generated by a camera 2514. A processing element 2516 may utilize the image(s) of image area 2515 that includes the contact points of the emitted lasers 2513a/2513b in determining the scale of the target 2530. Such scale measurements may be stored in a memory element 2518 having one or more non-transitory memories. In some embodiments, the processing and/or storage may instead be in or shared by the underwater laser rangefinder 2520 or an underwater vehicle or other host device 2540.

The underwater laser rangefinder 2520 may generate one or more emitted lasers, such as an emitted laser 2521, that may contact the target 2530 and reflect light, such as a reflected light input 2523, back to the underwater laser rangefinder 2520 in determining a distance measurement to the target 2530. As such, the combined underwater scaling and range finding device 2500 may generate a measurement of the scale of the target 2530 as well as a distance to the target 2530. The distance measurement, in some embodiments, may further be used to refine the scale measurement. The underwater laser rangefinder 2520 is illustrated in FIG. 25 as having a single emitted laser 2521 and reflected light input 2523 pairing such that the underwater laser rangefinder 2520 may be or share aspects with the daylight visible laser rangefinders of the present disclosure (e.g., with the daylight visible laser rangefinder module 100 of FIGS. 1A and 1B, the daylight visible laser rangefinder 200 of FIG. 2, and/or the daylight visible laser rangefinder 300 of FIG. 3). In other combined underwater scaling and range finding device embodiments, the underwater laser rangefinder may instead be a multi-spectral laser rangefinder of the present disclosure (e.g., the daylight visible laser rangefinder 200 of FIG. 2, the daylight visible laser rangefinder 300 of FIG. 3, the multi-spectral laser rangefinder module 500 of FIGS. 5A and 5B, the multi-spectral laser rangefinder 600a of FIG. 6A, the multi-spectral laser rangefinder 600b of FIG. 6B, the multi-spectral laser rangefinder 700a of FIG. 7A, the multi-spectral laser rangefinder 700b of FIG. 7B, the laser rangefinder 800a of FIG. 8A, the laser rangefinder 800b of FIG. 8B, the underwater laser rangefinder 1900a of FIGS. 19A and 19B, the underwater laser rangefinder 1900c of FIG. 19C, the underwater laser rangefinder 2000 of FIG. 20, the underwater laser rangefinder 2200a of FIG. 22A, the underwater laser rangefinder 2200b of FIG. 22B, or the like). The combined underwater scaling and range finding device 2500 may optionally couple to or be included in the underwater vehicle or other host device 2540. In some alternative embodiments, the scaling lasers (e.g., the scaling lasers 2512a and 2512b) may instead be replaced with laser rangefinders in keeping with the present disclosure.

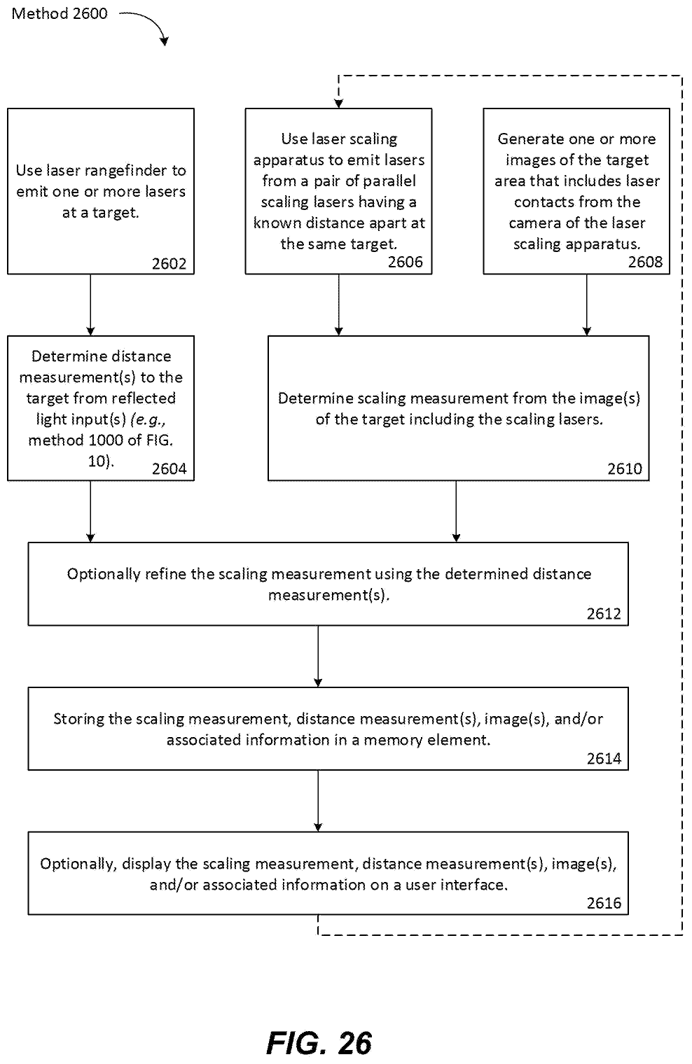

Turning to FIG. 26, a method 2600 for determining scaling and distance measurements via a combined underwater scaling and range finding device of the present disclosure, such as the combined underwater scaling and range finding device 2500 of FIG. 25, is described. In a step 2602, a laser rangefinder in keeping with the present disclosure may emit one or more lasers at a target. In a step 2604, one or more distance measurements may be determined (e.g., via method 1000 of FIG. 10). In a step 2606, a laser scaling apparatus may direct a pair of parallel scaling lasers having a known distance apart at the same target. In a step 2608, one or more images of the target area that includes laser contacts may be generated. In a step 2610, a scaling measurement may be determined from the image of the scaling lasers contacting the target. In an optional step 2612, the scaling measurement may be refined via the distance measurement(s). In a step 2614, the scaling measurement, distance measurement(s), image(s), and/or associated information may be stored in a memory element having one or more non-transitory memories. In an optional step 2616, the scaling measurement, distance measurement(s), image(s), and/or associated information may be displayed on a user interface. The method 2600 may optionally repeat at other targets.

The various illustrative logical blocks, modules, functions, and circuits described in connection with the embodiments disclosed herein and, for example, in a processor or processing element as described herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, firmware, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. A processing element may further include or be coupled to one or more non-transitory memory storage elements such as ROM, RAM, SRAM, or other memory elements for storing instructions, data, and/or other information in a digital storage format.

In one or more exemplary embodiments, the functions, methods and processes described may be implemented in whole or in part in hardware, software, firmware, or any combination thereof. If implemented in software, the functions may be stored on or encoded as one or more instructions or code on a non-transitory processor-readable medium and may be executed in one or more processing elements. Processor-readable media includes computer storage media. Storage media may be any available non-transitory media that can be accessed by a computer, processor, or other programmable digital device.

By way of example, and not limitation, such computer-readable media can include RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

It is understood that the specific order or hierarchy of steps or stages in the processes and methods disclosed are examples of exemplary approaches. Based upon design preferences, it is understood that the specific order or hierarchy of steps in the processes may be rearranged while remaining within the scope of the present disclosure. Any method claims may present elements of the various steps in a sample order, and are not meant to be limited to the specific order or hierarchy presented or inclusion of all steps or inclusion of alternate or equivalent steps unless explicitly noted.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill would further appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps may have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the disclosure.

The various illustrative logical blocks, modules, processes, methods, and/or circuits described in connection with the embodiments disclosed herein may be implemented or performed in a processing element with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps or stages of a method, process or algorithm described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium such as a non-transitory memory may be externally coupled to the processor such that the processor can read information from, and write information to, the storage medium and/or read and execute instructions from the storage medium. In the alternative, the storage medium may be integral to the processor. The processor and the storage medium may reside in an ASIC. The ASIC may reside in a device such as described herein another device. In the alternative, the processor and the storage medium may reside as discrete components. Instructions to be read and executed by a processing element to implement the various methods, processes, and algorithms disclosed herein may be stored in a non-transitory memory or memories of the devices disclosed herein.

It is noted that as used herein that the terms “component,” “target,” “element,” or other singular terms may refer to two or more of those things. For example, a “component” may comprise multiple components. Moreover, the terms “component,” “element,” or other descriptive terms may be used to describe a general feature or function of a group of components, elements, or other items.

The presently claimed invention is not intended to be limited to the aspects shown herein, but is to be accorded the full scope consistent with the disclosures herein and their equivalents as reflected by the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c.

The previous description of the disclosed aspects is provided to enable any person skilled in the art to make or use embodiments of the presently claimed invention. Various modifications to these aspects will be readily apparent to those skilled in the art, and the generic principles defined herein may be applied to other aspects without departing from the spirit or scope of the invention. Thus, the invention is not intended to be limited to the aspects shown herein but is to be accorded the widest scope consistent with the following claims and their equivalents.

1. A daylight visible laser rangefinder, comprising:
a laser element emitting a daylight visible laser output at one or more predefined frequency or frequencies;
a receiver element to receive reflected light input generated by reflection of the daylight visible laser output off a target, the receiver comprising;
a sensing element having one or more avalanche photodiodes, avalanche photodiode arrays, silicon photomultipliers (SiPM), and/or other photodetector sensors for receiving the reflected light input and outputting corresponding input signals; and
a gain control element to vary the gain of the sensing element;
a phase detector to measure the phase of emitted lasers and reflected light inputs;
a processing element having one or more processors to calculate phase differences between the emitted laser and reflected light input received by the receiver element in determining distance measurements;
a memory element having one or more non-transitory memories for storing instructions relating to calculating of distance measurements and the resulting calculated distance measurements;
a housing element to encapsulate or partially encapsulate the laser rangefinder elements, isolate the receiver element from light sources other than the reflected light input, and further having one or more windows or other openings such that the emitted laser and reflected light input may travel between rangefinder laser elements/receiver elements and the external environment; and
a power element for providing electrical power to powered elements of the receiver element.

2. The daylight visible laser rangefinder of claim 1, wherein the receiver element further includes one or more bandpass filters.

3. The daylight visible laser rangefinder of claim 2, wherein the one or more bandpass filters are calibrated so as to account for phase shifts.

4. The daylight visible laser rangefinder of claim 1, wherein the housing element is made of or includes carbon-fiber filled injection moldable plastic.

5. The daylight visible laser rangefinder of claim 1, wherein the windows are square and adhered or otherwise secured to the inside or outside of the housing element.

6. The daylight visible laser rangefinder of claim 1, wherein the windows are alkali-aluminosilicate sheet glass.

7. The daylight visible laser rangefinder of claim 1, wherein the laser element is a green or other daylight visible laser.

8. The daylight visible laser rangefinder of claim 1, including one or more additional laser elements each having a corresponding receiver element.

9. The daylight visible laser rangefinder of claim 8, wherein each of the laser elements operates at a different wavelength from others of the laser elements and at least one laser element operates in a daylight visible wavelength.

10. The daylight visible laser rangefinder of claim 1, incorporated in a buried utility locator device configured to determine and/or map utility line positions.

11. The daylight visible laser rangefinder of claim 10, wherein the buried utility locator device further includes one or more cameras to generate images of the ground surface or other distance measurement target(s) of the laser rangefinder.

12. The daylight visible laser rangefinder of claim 1, further including one or more user input controls.

13. The daylight visible laser rangefinder of claim 1, further including a user interface to communicate measured distance.

14. The daylight visible laser rangefinder of claim 1, further including a temperature sensor, and wherein the calculated distance measurement is adjusted based on the ambient temperature of the environment, lasers, or associated circuitry.

15. The daylight visible laser rangefinder of claim 1, wherein the calculated distance measurement is adjusted based on ambient light levels.

16. The daylight visible laser rangefinder of claim 1, wherein the calculated distance measurement is adjusted based on signal noise.

17. The daylight visible laser rangefinder of claim 1, wherein the calculated distance measurement is adjusted based on the amplitude of the reflected light input waveform at the sensing element.

18. The daylight visible laser rangefinder of claim 1, wherein the calculated distance measurement is adjusted based on the waveform shape of the reflected light input at the sensing element.

19. The daylight visible laser rangefinder of claim 1, wherein the calculated distance measurement is adjusted based on gain levels.

20. The daylight visible laser rangefinder of claim 1, wherein the calculated distance measurement is adjusted based on target fluorescence, target color, target material, or other target attribute.

21. The daylight visible laser rangefinder of claim 1, wherein the gain control element adjusts the bias voltage to the sensing element to control the gain of the sensing element.

22. The daylight visible laser rangefinder of claim 1, wherein the sensing element further includes a signal amplifier for amplifying input signals.

23. The daylight visible laser rangefinder of claim 21, wherein the gain control element varies gain of the signal amplifier to control the gain of the sensing element.

24. The daylight visible laser rangefinder of claim 1, further having a waterproof housing for use in underwater environments.

25. The underwater daylight visible laser rangefinder of claim 24, wherein the laser element includes a blue or violet or green laser.

26-113. (canceled)
